(19) United States
(12) Patent Application Publication
(10) Pub. No.: US 2025/0023964 A1
(43) Pub. Date: Jan. 16, 2025

(54) METHOD FOR PROCESSING DATA, COMMUNICATION DEVICE AND CHIP

(71) Applicant: GUANGDONG OPPO MOBILE TELECOMMUNICATIONS CORP., LTD., Dongguan (CN)

(72) Inventors: Zhe FU, Dongguan (CN); Shukun WANG, Dongguan (CN); Cong SHI, Dongguan (CN)

(21) Appl. No.: 18/903,963

(22) Filed: Oct. 1, 2024

Related U.S. Application Data
(63) Continuation of application No. PCT/CN2022/085966, filed on Apr. 8, 2022.

(51) Int. Cl. H04L 69/322

(52) U.S. Cl. CPC H04L 69/322

(57) ABSTRACT

Provided is a method for processing data. The method includes: performing an integration process or a differentiation process based on first data. The integration process refers to processing data in the case that the association relationship, the priority relationship, or the integration process relationship is present between at least two different pieces of data in the first data. The differentiation process refers to a mode for processing data in the case that the dependency relationship (or dependence relationship), the priority relationship, or the differentiation process relationship is present between the at least two different pieces of data in the first data.

### CROSS-REFERENCE TO RELATED APPLICATION

This application is a continuation application of international application No. PCT/CN2022/085966, filed on Apr. 8, 2022, the disclosure of which is incorporated herein by reference in its entirety.

### TECHNICAL FIELD

The present disclosure relates to the field of communications technologies, and in particular, relates to a method for processing data, a communication device, and a chip.

### BACKGROUND

In a related art, a protocol data unit (PDU) set includes at least one PDU, and an association or dependency relationship may be present between PDUs. For example, a PDU set represents a video frame, and compression decoding of the video frame may only be implemented in the case that all PDUs associated in the PDU set are received, or may only be implemented in the case that an indication of a portion of the PDUs is received. In addition, an association or dependency relationship may be present between different PDU sets. For example, a dependency relationship is present between a PDU set representing an I-frame and a PDU set representing a P-frame, wherein compression decoding of the P-frame depends on the I-frame.

### SUMMARY

Embodiments of the present disclosure provide a method for processing data, a communication device, and a chip. The technical solutions are as follows.

According to some embodiments of the present disclosure, a method for processing data is provided. The method includes: performing an integration process or a differentiation process based on first data, wherein the first data is a PDU set.

According to some embodiments of the present disclosure, a communication device is provided. The communication device includes: a processor; a transceiver connected to the processor; and a memory, configured to store one or more executable instructions of the processor, wherein the processor is configured to load and execute the one or more executable instructions to perform the method for processing data as described above.

According to some embodiments of the present disclosure, a chip is provided. The chip includes one or more programmable logic circuits and/or one or more program instructions. The chip, when running the one or more programmable logic circuits and/or executing the one or more program instructions, is caused to perform the method for processing data as described above.

### BRIEF DESCRIPTION OF THE DRAWINGS

For clearer descriptions of the technical solutions according to the embodiments of the present disclosure, the following briefly describes accompanying drawings required for describing the embodiments. Apparently, the accompanying drawings in the following description illustrate merely some embodiments of the present disclosure, and those of ordinary skill in the art can still derive other accompanying drawings from these accompanying drawings without creative efforts.

FIG. 1 is a schematic diagram of a 5G network architecture according to some embodiments of the present disclosure;

FIG. 2 is a schematic diagram illustrating data interaction based on a quality of service (QoS) flow according to some embodiments of the present disclosure;

FIG. 3 is a schematic diagram of a radio protocol architecture in the related art;

FIG. 4 is a schematic diagram illustrating introduction of a target protocol layer into an access stratum (AS) layer according to some embodiments of the present disclosure;

FIG. 5 is a flowchart of a method for processing data according to some embodiments of the present disclosure;

FIG. 6 is a flowchart of a method for processing data according to other embodiments of the present disclosure;

FIG. 7 is a schematic diagram illustrating data processing based on a target protocol layer according to some embodiments of the present disclosure;

FIG. 8 is a schematic diagram illustrating data processing based on a target protocol layer according to other embodiments of the present disclosure;

FIG. 9 is a schematic diagram illustrating data processing based on a target protocol layer according to other embodiments of the present disclosure;

FIG. 10 is a schematic diagram illustrating data processing based on a target protocol layer according to other embodiments of the present disclosure;

FIG. 11 is a schematic diagram illustrating data processing based on a new target function of an AS protocol layer according to some embodiments of the present disclosure;

FIG. 12 is a schematic diagram illustrating data processing based on a new target function of an AS protocol layer according to some embodiments of the present disclosure;

FIG. 13 is a schematic diagram illustrating data processing based on a new target function of an AS protocol layer according to some embodiments of the present disclosure;

FIG. 14 is a schematic diagram illustrating data processing based on a new target function of an AS protocol layer according to some embodiments of the present disclosure;

FIG. 15 is a schematic diagram illustrating data processing based on a new target function of an AS protocol layer according to some embodiments of the present disclosure;

FIG. 16 is a schematic diagram illustrating data processing based on a new target function of an AS protocol layer according to some embodiments of the present disclosure;

FIG. 17 is a schematic diagram illustrating addition of a target function in a Service Data Adaptation Protocol (SDAP) layer and a Packet Data Convergence Protocol (PDCP) layer according to some embodiments of the present disclosure;

FIG. 18 is a schematic diagram illustrating addition of a target function in an SDAP layer according to some embodiments of the present disclosure;

FIG. 19 is a schematic diagram illustrating addition of a target function in a PDCP layer according to some embodiments of the present disclosure;

FIG. 20 is a schematic diagram illustrating routing of different types of PDU sets to different output channels according to some embodiments of the present disclosure;

FIG. 21 is a schematic diagram illustrating addition of a target function in an SDAP layer according to some embodiments of the present disclosure;

FIG. 22 is a schematic diagram illustrating addition of a target function in an SDAP layer according to some embodiments of the present disclosure;

FIG. 23 is a schematic diagram illustrating addition of a target function in an SDAP layer according to some embodiments of the present disclosure;

FIG. 24 is a schematic diagram illustrating addition of a target function in an SDAP layer according to some embodiments of the present disclosure;

FIG. 25 is a schematic diagram illustrating addition of a target function in an SDAP layer according to some embodiments of the present disclosure;

FIG. 26 is a schematic diagram illustrating addition of a target function in an SDAP layer according to some embodiments of the present disclosure;

FIG. 27 is a schematic diagram illustrating addition of a target function in an SDAP layer according to some embodiments of the present disclosure;

FIG. 28 is a schematic diagram illustrating addition of a target function in an SDAP layer according to some embodiments of the present disclosure;

FIG. 29 is a schematic diagram illustrating addition of a target function in an SDAP layer according to some embodiments of the present disclosure;

FIG. 30 is a schematic diagram illustrating addition of a target function in an SDAP layer according to some embodiments of the present disclosure;

FIG. 31 is a schematic diagram illustrating addition of a target function in an SDAP layer according to some embodiments of the present disclosure;

FIG. 32 is a schematic diagram illustrating addition of a target function in an SDAP layer according to some embodiments of the present disclosure;

FIG. 33 is a schematic diagram illustrating addition of a target function in an SDAP layer according to some embodiments of the present disclosure;

FIG. 34 is a schematic diagram illustrating addition of a target function in an SDAP layer according to some embodiments of the present disclosure;

FIG. 35 is a schematic diagram illustrating packet delivery from an SDAP layer to a PDCP layer according to some embodiments of the present disclosure;

FIG. 36 is a schematic diagram illustrating packet delivery from an SDAP layer to a PDCP layer according to some embodiments of the present disclosure;

FIG. 37 is a schematic diagram illustrating packet delivery from an SDAP layer to a PDCP layer according to some embodiments of the present disclosure;

FIG. 38 is a structural block diagram of an apparatus for processing data according to some embodiments of the present disclosure; and

FIG. 39 is a schematic structural diagram of a communication device according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

First, terms involved in the embodiments of the present disclosure are briefly described hereinafter.

A PDU set is composed of one or more PDUs, wherein the one or more PDUs carry a payload of one information unit generated in an application layer. For example, the information unit is a frame or a video slice of extended reality and media services (XRMs). The one or more PDUs are of same importance requirements in the application layer. In the application layer, all PDUs in the PDU are required to use the corresponding information unit. In some cases, the application layer can still recover parts of the information unit in the case that some of the PDUs are missing. It should be noted that an I-frame, a P-frame, and the like, which are mentioned hereinafter, represent only a form of PDU set.

An I-frame is an intra-coded picture, and is a complete picture that can be independently encoded and decoded like a JPG image file.

A P-frame is a predicted picture, but is not a complete frame. The P-frame only contains image changes compared to a previous frame. In the case that a reference frame is lost, the P-frame cannot be decoded or displayed.

A B-frame is a bi-directional predicted picture, and contains changes between a previous reference frame and a next reference frame. More reference frames may result in a higher compression ratio. However, the B-frame is dedodable only in the case that the previous reference frame and the next reference frame are available.

A group of pictures (GOP) includes a collection of successive video frames. A first frame in the GOP is the I-frame and a subsequent frame is a P-frame or a B-frame.

With respect to architecture of a 5G network system architecture, referring to FIG. 1, the 5G network system includes: a user equipment (UE, which is a mobile terminal defined in the 3GPP), a (radio) access network ((R)AN), a user plane function (UPF), a data network (DN), and control plane functions.

The control plane functions include: an access and mobility management function (AMF), a session management function (SMF), a policy control function (PCF), unified data management (UDM) function, an application function (AF), a network slice selection function (NSSF), and an authentication server function (AUSF).

The UE performs an access stratum connection to the AN, exchanges access stratum messages, and performs wireless data transmission over a Uu air interface; and performs a non-access stratum (NAS) connection to the AMF, and exchanges NAS messages over an N1 interface. The AMF is a mobility management function in a core network, the SMF is a session management function in the core network, and the AMF is responsible for forwarding messages related to session management between the UE and the SMF in addition to performing mobility management on the UE. The PCF is a policy management function in the core network, and is responsible for formulating policies related to mobility management, session management, billing, and the like, on the UE. The UPF is a user plane function in the core network, and performs data transmission with an external data network over an N6 interface and data transmission with the AN over an N3 interface.

The concept of quality of service flow (QoS flow) is introduced into the 5G network. Upon accessing the 5G network over the Uu air interface, the UE establishes QoS flows for data transmission under the control of the SMF. The SMF provides QoS flow configuration information of each QoS flow to a base station, wherein the QoS flow configuration information includes a bit rate requirement, a delay requirement, a bit error rate requirement, and the like. For each QoS flow, the base station ensures a QoS requirement of the QoS flow by scheduling wireless resources based on the QoS flow configuration information received from the SMF.

In a QoS flow in the 5G network, an uplink data flow (a data flow transmitted by the UE to a peer device over the 5G network) may be transmitted, or a downlink data flow (a data flow transmitted by the peer device to the UE over the 5G network) may be transmitted, wherein the peer device refers to a peer application server or a peer UE. Delay requirements of the uplink data flow and the downlink data flow in a QoS flow are the same. In the case that the delay requirements of the uplink data flow and the downlink data flow of a service are different, the data flows are transmitted in different QoS flows. The delay herein refers to a data transmission delay between the UE and the UPF.

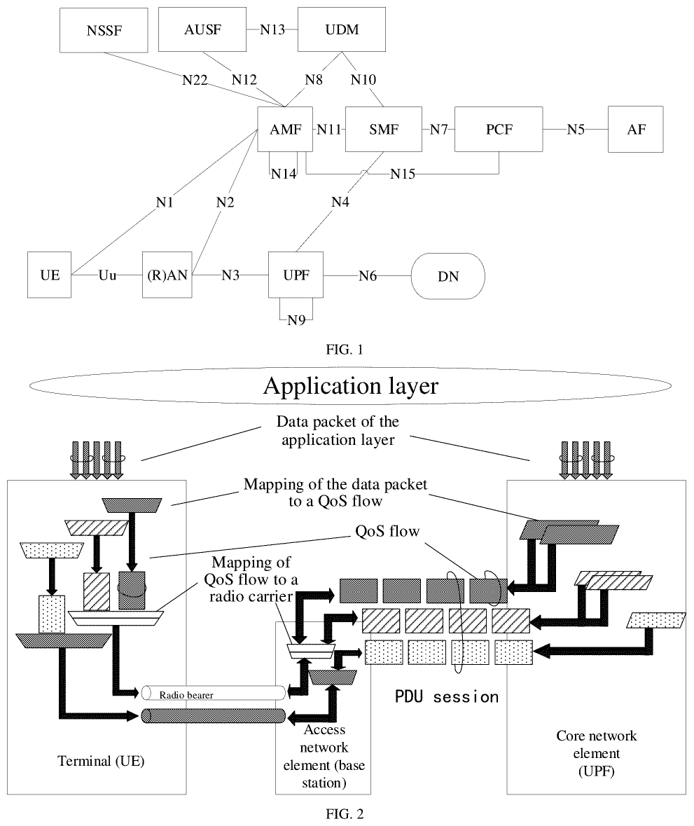

Referring to FIG. 2, one or more QoS flows are required to be established for transmitting user plane data in a mobile communication network, and different data flows correspond to different QoS parameters. As an important metric for communication quality, characteristics of the QoS flow are generally indicated by the QoS parameters. The QoS parameters include, but are not limited to: a 5QI, an allocation and retention priority (ARP), a guaranteed flow bit rate (GFBR), maximum flow bit rate (MFBR), a maximum packet loss rate (UL, DL), a end-to-end packet delay budget (PDB), an access network-packet delay budget (AN-PDB), a packet error rate, a priority level, an averaging window, a resource type, a maximum data burst volume, a UE aggregate maximum bit rate (UE-AMBR), a session aggregate maximum bit rate (Session-AMBR), and the like.

A filter (or referred to as a service data flow, SDF, template) contains parameters for characterizing data packets, and the filter is configured to filter out a specific data packet to a specific QoS flow (i.e., mapping of the data packet to the QoS flow in FIG. 2). The most commonly used filter is an IP five-tuple, i.e., a source IP address, a destination IP addresses, a source port number, a destination port number, and a protocol type.

A user plane network element (a UPF in FIG. 2) and the terminal (a UE in FIG. 2) at a network side form a filter (such as the leftmost trapezoid and the rightmost parallelogram) based on a combination of data packet characteristic parameters, wherein the filter is configured to filter an uplink data packet or a downlink data packet that is transmitted in the user plane and conforms to the data packet characteristics, and binds the uplink data packet or the downlink data packet to a specific data flow.

FIG. 3 illustrates a schematic diagram of a radio protocol architecture in the related art.

A Service Data Adaptation Protocol (SDAP) layer is responsible for mapping QoS bearers to data radio bearers (DRBs) based on QoS requirements.

A Packet Data Convergence Protocol (PDCP) layer is responsible for performing IP header compression, encryption, and integrity protection. At handover, the PDCP layer is further configured to perform retransmission, in-order delivery, and deduplication. With respect to dual connectivity with bearers separated, the PDCP layer may provide routing and replication, i.e., configuring one PDCP entity for each radio bearer of the terminal.

A radio link control (RLC) layer is responsible for data segmentation and retransmission. The RLC layer provides services to the PDCP layer in the form of RLC channels. One RLC entity is configured for one terminal per RLC channel (corresponding to each radio bearer).

A medium access control (MAC) layer is responsible for multiplexing of logical channels, hybrid automatic repeat request (HA ARQ) retransmission, scheduling, and scheduling related functions. The scheduling functions for uplink and downlink reside in gNBs. The MAC layer provides services to the RLC layer in the form of logical channels (LCHs). New radio (NR) changes a header structure of the MAC layer.

A physical layer (PHY) is responsible for encoding and decoding, modulation, demodulation, multi-antenna mapping, and other typical physical layer functions. The physical layer provides services to the MAC layer in the form of transport channels.

In the related art, data processing is performed independently for different PDUs and different PDU sets. Apparently, the independent data processing results in a low data processing efficiency.

In some embodiments, the method for processing data according to the present disclosure is implemented by introducing a target protocol layer into the access stratum (AS) layer. Referring to FIG. 4, a schematic diagram illustrating the introduction of a target protocol layer into an AS layer is illustrated. The target protocol layer supports an integration process or a differentiation process based on first data.

As seen from part (a) of FIG. 4, the target protocol layer is located above the SDAP layer. Alternatively, as seen from part (b) of FIG. 4, the target protocol layer is located between the SDAP layer and the PDCP layer. Alternatively, as seen from part (c) of FIG. 4, the target protocol layer is located between the PDCP layer and the RLC layer. Alternatively, as seen from part (d) of FIG. 4, the target protocol layer is located below the RLC layer.

In some embodiments, the target protocol layer is referred to as: a media data adaptation control (MDAC) layer, an application adaptation control (AAC) layer, an application and media translator (AMT), an adaptive media control (AMC) layer, an adaptive layer, or a Media Data Adaptation Protocol (MDAP) layer. Other names may also be used.

In other embodiments, the integration process or the differentiation process is implemented by addition of a target function in the AS protocol layer, wherein the target function supports the integration process or the differentiation process based on the first data.

In some embodiments, the AS protocol layer is the SDAP layer. Alternatively, the AS protocol layer is the PDCP layer. Alternatively, the AS protocol layer is the RLC layer. Alternatively, the AS protocol layer is the MAC layer.

In summary, two protocol layer architectures are provided, such that the target protocol layer or the target function supports the integration process or the differentiation process based on the first data.

The method for processing data is first described hereinafter.

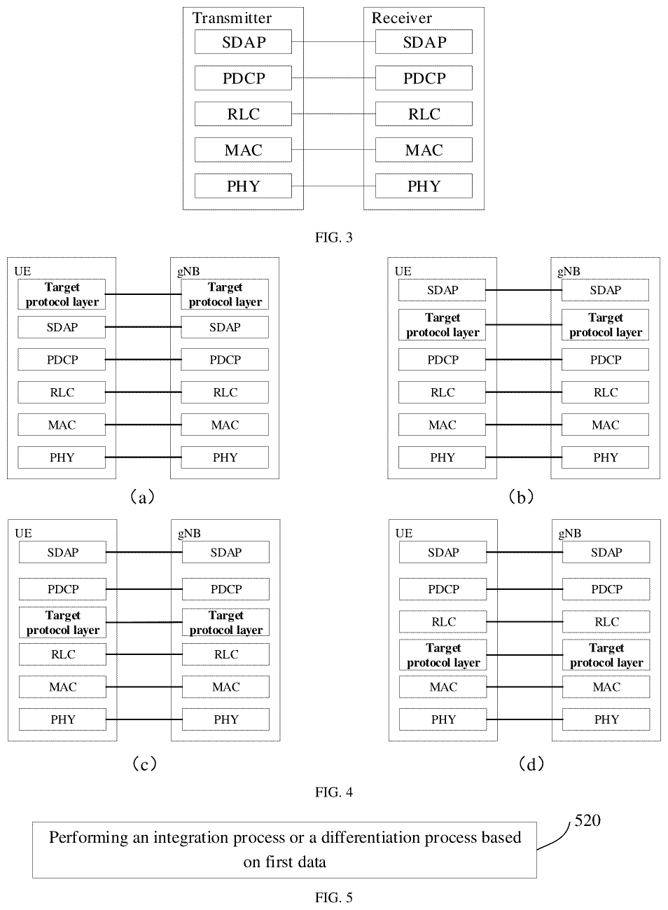

FIG. 5 illustrates a flowchart of a method for processing data according to some embodiments of the present disclosure. The method includes the following process.

In 520, an integration process or a differentiation process is performed based on first data.

In some embodiments, the integration process or the differentiation process includes at least one of:
identifying at least two different pieces of data in the first data;
identifying different pieces of first data;
rearranging a transmission order of at least two different pieces of data in the first data;
rearranging a transmission order of different pieces of first data;
reordering at least two different pieces of data in the first data from at least one input channel;
reordering different pieces of first data from at least one input channel;
adding SNs to at least two different pieces of data in the first data;
adding SNs to different pieces of first data;
adding or removing packet headers of at least two different pieces of data in the first data;
adding or removing packet headers of different pieces of first data;
routing at least two different pieces of data in the first data to at least two output channels;
routing different pieces of first data to at least two output channels;
routing at least two PDUs in a first PDU set from at least two input channels to one output channel;
routing at least one second PDU set and at least one third PDU set from at least two input channels to one output channel;
deleting or feeding back deletion of at least one of at least two different pieces of data in the first data;
deleting or feeding back deletion of at least one of different pieces of first data;
retransmitting or feeding back retransmission of at least one of at least two different pieces of data in the first data;
retransmitting or feeding back retransmission of at least one of different pieces of first data;
feeding back a transmission state of the first data or transmission states of at least two different pieces of data in the first data;
feeding back transmission states of different pieces of first data; or
generating a data packet for the first data and transmitting the data packet to a lower layer.

In some embodiments, the first data is a PDU set.

The at least two different pieces of data in the first data includes the following scenario: at least two PDUs having a first relationship are present in a first PDU set. The different pieces of first data include: at least one second PDU set and at least one third PDU set, wherein a first relationship is present between the second PDU set and the third PDU set. The first relationship includes at least one of: an association relationship, a dependency/dependence relationship, a priority relationship, an integration process relationship, or a differentiation process relationship.

The integration process refers to processing data in the case that the association relationship, the priority relationship, or the integration process relationship is present between the at least two different pieces of data in the first data.

The differentiation process refers to a mode for processing data in the case that the dependency relationship (or dependence relationship), the priority relationship, or the differentiation process relationship is present between the at least two different pieces of data in the first data.

The integration process or the differentiation process is performed based on a PDU set, such that at least two PDUs in a first PDU set (or at least one second PDU set and at least one third PDU set) are prevented from being processed independently, thereby improving the data processing efficiency.

The following embodiments describe in detail using the first data being the PDU set as an example.

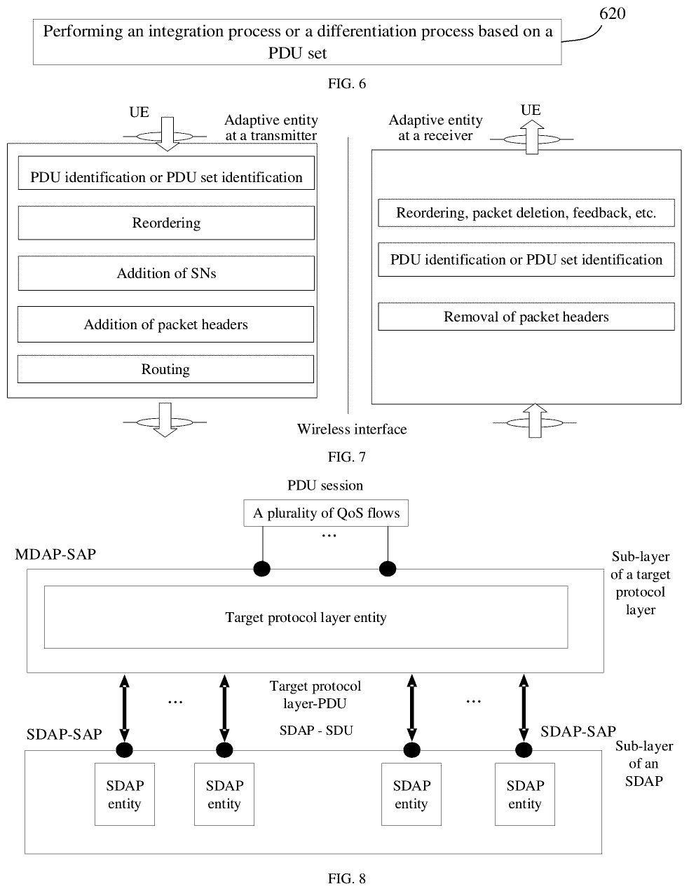

Based on the radio protocol architecture illustrated in FIG. 3, referring to FIG. 6, a method for processing data according to some embodiments of the present disclosure is illustrated. The method is applicable to a new protocol layer introduced based on the radio protocol architecture illustrated in FIG. 3, or any one of the protocol layers illustrated in FIG. 3. The method includes the following process.

In 620, an integration process or a differentiation process is performed based on a PDU set.

In some embodiments, the PDU set includes a frame, a coded slice, or a plurality of PDUs.

In some embodiments, the PDU set includes one or more frames, or one or more coded slices.

In some embodiments, the PDU set includes one or more PDUs of one frame, or one or more PDUs of one coded slice.

In some embodiments, the PDU set includes: a first PDU set including at least two PDUs having a first relationship; and/or, at least one second PDU set and at least one third PDU set having a first relationship.

The first relationship includes at least one of an association relationship, a dependency/dependence relationship, a priority relationship, an integration process relationship, or a differentiation process relationship.

The association relationship indicates that at least two PDUs in the first PDU set (or the second PDU set and the third PDU set) function individually, but function together as a whole. The dependency/dependence relationship indicates that one of at least two PDUs in the first PDU set depends on the other one of the at least two PDUs to function, such that the two PDUs function together as a whole. The priority relationship indicates that at least two PDUs in the first PDU set have a priority order in time for functioning, or have a priority order in transmission or processing requirements, or have a difference in priority in transmission or processing requirements.

The integration process relationship indicates that the integration process may be performed on at least two PDUs in the first PDU set (or the second PDU set and the third PDU set). The differentiation process relationship indicates that the differentiation process may be performed on at least two PDUs in the first PDU set (or the second PDU set and the third PDU set).

It should be noted that, the PDU set may further include at least one fourth PDU set, wherein the fourth PDU set has a first relationship with the second PDU set and the third PDU set. Similarly, by analogy, the PDU set may further include a fifth PDU set, a sixth PDU set, or the like. For example, the second PDU set, the third PDU set, and the fourth PDU set are an I-frame, a P-frame, and a B-frame, respectively.

In some embodiments, the integration process or the differentiation process includes at least one of the following situations.
1. At least two PDUs in a first PDU set are identified.

For example, at least two PDUs (packets) are identified as falling into one PDU set, and/or at least two PDUs (packets) are identified as falling into the first PDU set.
2. At least one second PDU set and at least one third PDU set are identified (wherein 1 and 2 may be simply referred to as identification of PDU/PDU set).

For example, each PDU set is identified. In some embodiments, whether a first relationship is present between PDU sets is identified, and/or the first relationship between the PDU sets is identified.

For example, the second PDU set representing the I-frame is identified, and the third PDU set representing the P-frame is identified.
3. A transmission order of at least two PDUs in a first PDU set is rearranged.

For example, the transmission order of the at least two PDUs in the first PDU set is rearranged, such that the at least two PDUs in the first PDU set are transmitted in order.

For example, reordering is performed based on serial numbers of the at least two PDUs in the first PDU set, such that that the at least two PDUs in the first PDU set are transmitted in order.

At a transmitter side, the transmission order refers to an order from a higher layer to a lower layer; and at a receiver side, the transmission order refers to an order from a lower layer to a higher layer.

Alternatively, at a transmitter side, the transmission order refers to an order from a previous function to a next function; and at a receiver side, the transmission order refers to an order from a previous function to a next function.
4. A transmission order of at least one second PDU set and at least one third PDU set is rearranged (wherein 3 and 4 may be simply referred to as reordering).

For example, the transmission order of the at least one second PDU set and the at least one third PDU set is rearranged, such that the at least one second PDU set and the at least one third PDU set are transmitted in order.

For example, reordering is performed based on serial numbers of the at least one second PDU set and the at least one third PDU set, such that the at least one second PDU set and the at least one third PDU set are transmitted in order.

For another example, in the case that the second PDU set and the third PDU set have a dependency relationship, the second PDU set on which the third PDU set is dependent is transmitted first, and then the third PDU set is transmitted.

In some embodiments, the second PDU set representing the I-frame is transmitted first, and then the third PDU set representing the P-frame is transmitted (wherein the P-frame depends on the I-frame).
5. At least two PDUs in a first PDU set from at least one input channel are reordered.

For example, the first PDU set includes PDUs with identifiers of 3, 5, 2, 4, and 1. The PDUs with identifiers of 3, 5, 2, 4, and 1 are reordered to be PDUs with identifiers of 1, 2, 3, 4, and 5.

In some embodiments, the at least one input channel includes a path or an entity. For example, the path includes any one of a QoS flow, a DRB, an RLC channel, or an LCH. For example, the entity includes any one of an SDAP entity, a PDCP entity, an RLC entity, or a MAC entity. In some embodiments, the at least two PDUs in the first PDU set are from the same input channel or different input channels.

It should be noted that the different input channels can be understood herein as different QoS flows, or different DRBs, or different RLC channels, or different LCHs, or different SDAP entities, or different PDCP entities, or different RLC entities, or different MAC entities.

In some embodiments, the at least two PDUs in the first PDU set are from at least one input channel of a higher layer or a lower layer.

In some embodiments, in the case that the at least two PDUs in the first PDU set are not delivered to the newly introduced target protocol layer (or any protocol layer in the AS protocol layer architecture, or any function of any protocol layer in the AS protocol layer architecture) in an order corresponding to the dependency relationship, the at least two PDUs in the first PDU set are reordered.

In some embodiments, the at least two PDUs in the first PDU set from the at least one input channel are reordered based on SN numbers or control information (e.g., a control packet). In some embodiments, the at least two PDUs in the first PDU set from the at least one input channel are reordered based on values of SN numbers of data packets. In some embodiments, the at least two PDUs in the first PDU set from the at least one input channel are reordered based on information of a start control packet. For example, the at least two PDUs in the first PDU set and between two start packets are reordered. In some embodiments, the at least two PDUs in the first PDU set from the at least one input channel are reordered based on information of an end control packet. In some embodiments, the at least two PDUs in the first PDU set from the at least one input channel are reordered based on information of a start control packet and information of an end control packet. In some embodiments, the at least two PDUs in the first PDU set from the at least one input channel are reordered based on a start identifier and an end identifier. In some embodiments, the information is at least one of: a start identifier, an end identifier, a bitmap indication of a path traveled by each PDU, a lower-layer path to which a current data packet is delivered, a lower-layer path to which a next data packet is delivered, a lower-layer path to which a previous data packet is delivered, a bitmap indication of lower-layer paths to which a current data packet and an adjacent data packet are delivered, a serial number of current control information or control PDU, an identifier of current control information or control PDU, data packets that are delivered to different paths (e.g., indicated by a bitmap), paths to which a plurality of data packets between start markers are delivered, paths to which a plurality of data packets between end markers are delivered, a path to which a data packet corresponding to a serial number of current control information or control PDU is delivered, paths to which a plurality of data packets corresponding to a serial number of current control information or control PDU are delivered, a path to which a data packet corresponding to an identifier number of current control information or control PDU is delivered, or paths to which a plurality of data packets corresponding to an identifier number of current control information or control PDU are delivered. In some embodiments, the identification information of the control information or the control PDU represents a position of the control information or the control PDU in order of information. In some embodiments, with respect to a plurality of output paths, each piece of generated control information, such as the control PDU, is transmitted to all the paths. Alternatively, each piece of generated control information, such as the control PDU, is transmitted to only one of all the paths (e.g., to a main path, or to a default path, or to a pre-configured path). The control information or the control PDU is configured such that a receiver performs reordering in the case that the receiver acquires the control information or SDAP data PDUs corresponding to the control PDU (data packets corresponding to the PDU set) from different DRBs or PDCP layers. In some embodiments, the at least two PDUs in the first PDU set from the at least one input channel are reordered based on a bitmap indication of a path traveled by each PDU.

The following description is given using two PDU sets as an example. However, the description is also applicable to a scenario of a plurality of PDU sets, or a scenario of a plurality of PDUs in a single PDU set. With respect to the transmitter: regarding data packets in PDU set 1 and PDU set 2, the data packets in PDU set 1 are routed to Path 1, and the data packets in PDU set 2 are routed to Path 2. The control information, e.g., the control PDU, such as control PDU 1, is added before or after the data packets in PDU set 1. The control PDU 1 carries Identifier 1. The control information, e.g., the control PDU, such as control PDU 2, is added before or after the data packets in PDU set 2. Control PDU 2 carries Identifier 2. The receiver receives data packets from two paths that correspond to Path 1 and Path 2 of the transmitter, and reorders PDU set 1 and PDU set 2 based on the control PDU information, such as the Identifier 1 in control PDU 1 and Identifier 2 in control PDU 2. For example, the reordering is performed by determining data packets and/or an order of data packets corresponding to control PDU 1 (e.g., PDU set 1 before or after control PDU 1) and data packets corresponding to the control PDU 2 (e.g., PDU set 2 before or after control PDU 2) based on Identifier 1 in control PDU 1 and Identifier 2 in control PDU 2. In some embodiments, whether the control information, such as the the control PDU, is before or after the corresponding data packets, is predefined, configured, or the like. In some embodiments, the transmitter and the receiver are implemented by SDAPs, and the paths are implemented by PDCP 1 and PDCP 2. In some embodiments, the transmitter and the receiver are implemented by PDCPs, and the paths are implemented by RLC 1 and RLC 2.

The following description is described with two PDU sets being present. However, the description is also applicable to a scenario of a plurality of PDU sets, or a scenario of a plurality of PDUs in a single PDU set. With respect to the transmitter: regarding data packets in PDU set 1 and PDU set 2, the data packets in PDU set 1 are routed to Path 1, and the data packets in PDU set 2 are routed to Path 2. SN numbers, such as SN 1 (or SN 1 to SN M), are added to headers of the data packets in PDU set 1. SN numbers, such as SN 2 (or SN M+1 to SN K), are added to headers of the data packets in PDU set 2. The receiver receives data packets from two paths that correspond to Path 1 and Path 2 of the transmitter, and reorders PDU set 1 and PDU set 2 based on the SN numbers. For example, the reordering is performed by determining data packets and/or an order of data packets in PDU set 1 and PDU set 2 based on the SN numbers of PDU set 1 and PDU set 2. In some embodiments, the transmitter and the receiver are implemented by SDAPs, and the paths are implemented by PDCP 1 and PDCP 2. In some embodiments, the transmitter and the receiver are implemented by PDCPs, and the paths are implemented by RLC 1 and RLC 2.
6. At least one second PDU set and at least one third PDU set from at least one input channel are reordered.

For example, the second PDU set representing the I-frame is ordered before the third PDU set representing the P-frame.

In some embodiments, the at least one input channel includes a path or an entity. In some embodiments, the path includes any one of a QoS flow, a DRB, an RLC channel, or an LCH. In some embodiments, the entity includes any one of an SDAP entity, a PDCP entity, an RLC entity, or a MAC entity. In some embodiments, the at least one second PDU set and the at least one third PDU set are from the same input channel or different input channels.

It should be noted that the different input channels may be understood herein as different QoS flows, or different DRBs, or different RLC channels, or different LCHs, or different SDAP entities, or different PDCP entities, or different RLC entities, or different MAC entities.

In some embodiments, the at least one second PDU set and the at least one third PDU set are from at least one input channel of a higher layer or a lower layer.

For example, in the case that the at least one second PDU set and the at least one third PDU set are not delivered to the newly introduced target protocol layer (or any protocol layer in the AS protocol layer architecture, or any function of any protocol layer in the AS protocol layer) in an order corresponding to the dependency relationship, the at least one second PDU set and the at least one third PDU set are reordered.

In some embodiments, the at least one second PDU set and the at least one third PDU set from the at least one input channel are reordered based on SN numbers or control information (e.g., a control packet). In some embodiments, the at least one second PDU set and the at least one third PDU set from the at least one input channel are reordered based on values of serial SN numbers of data packets. In some embodiments, the at least one second PDU set and the at least one third PDU set from the at least one input channel are reordered based on information of a start control packet. For example, the at least one second PDU set and the at least one third PDU set between two start packets are reordered. In some embodiments, the at least one second PDU set and the at least one third PDU set from the at least one input channel are reordered based on information of an end control packet. In some embodiments, the at least one second PDU set and the at least one third PDU set from the at least one input channel are reordered based on information of a start control packet and information of an end control packet. In some embodiments, the at least one second PDU set and the at least one third PDU set from the at least one input channel are reordered based on a start identifier and an end identifier. In some embodiments, the information is at least one of: a start identifier, an end identifier, a bitmap indication of a path traveled by each PDU, a lower-layer path to which a current data packet is delivered, a lower-layer path to which a next data packet is delivered, a lower-layer path to which a previous data packet is delivered, a bitmap indication of lower-layer paths to which a current data packet and an adjacent data packet are delivered, a serial number of current control information or control PDU, an identifier of current control information or control PDU, data packets that are delivered to different paths (e.g., indicated by a bitmap), paths to which a plurality of data packets between start markers are delivered, paths to which a plurality of data packets between end markers are delivered, a path to which a data packet corresponding to a serial number of current control information or control PDU is delivered, paths to which a plurality of data packets corresponding to a serial number of current control information or control PDU are delivered, a path to which a data packet corresponding to an identifier number of current control information or control PDU is delivered, or paths to which a plurality of data packets corresponding to an identifier number of current control information or control PDU are delivered. In some embodiments, the identification information of the control information or the control PDU represents a position of the control information or the control PDU in order of information. In some embodiments, with respect to a plurality of output paths, each piece of generated control information, such as the control PDU, is transmitted to all the paths. Alternatively, each piece of generated control information, such as the control PDU, is transmitted to only one of all the paths (e.g., to a main path, or to a default path, or to a pre-configured path). The control information or the control PDU is configured such that a receiver can perform reordering in the case that the receiver acquires the control information or SDAP data PDUs corresponding to the control PDU (data packets corresponding to the PDU set) from different DRBs or PDCP layers. In some embodiments, the at least one second PDU set and the at least one third PDU set from the at least one input channel are reordered based on a bitmap indication of a path traveled by each PDU.

The following description is given using two PDU sets as an example. However, the description is also applicable to a scenario of a plurality of PDU sets, or a scenario of a plurality of PDUs in a single PDU set. With respect to the transmitter: regarding data packets in PDU set 1 and PDU set 2, the data packets in PDU set 1 are routed to Path 1, and the data packets in PDU set 2 are routed to Path 2. The control information, e.g., the control PDU, such as control PDU 1, is added before or after the data packets in PDU set 1. The control PDU1 carries Identifier 1. The control information, e.g., the control PDU, such as control PDU 2, is added before or after the data packets in PDU set 2. The control PDU 2 carries Identifier 2. The receiver receives data packets from two paths that correspond to Path 1 and Path 2 of the transmitter, and reorders PDU set 1 and PDU set 2 based on the control PDU information, such as Identifier 1 in control PDU 1 and the Identifier 2 in control PDU 2. For example, the reordering is performed by determining data packets and/or an order of data packets corresponding to the control PDU1 (e.g., PDU set 1 before or after control PDU 1) and data packets corresponding to the control PDU 2 (e.g., PDU set 2 before or after control PDU 2) based on Identifier 1 in the control PDU 1 and Identifier 2 in control PDU 2. In some embodiments, whether the control information, such as the the control PDU, is before or after the corresponding data packets, is predefined, configured, or the like. In some embodiments, the transmitter and the receiver are implemented by SDAPs, and the paths are implemented by PDCP 1 and PDCP 2. In some embodiments, the transmitter and the receiver are implemented by PDCPs, and the paths are implemented by RLC 1 and RLC 2.

The following description is given using two PDU sets as an example. However, the description is also applicable to a scenario of a plurality of PDU sets, or a scenario of a plurality of PDUs in a single PDU set. With respect to the transmitter: regarding data packets in PDU set 1 and PDU set 2, the data packets in PDU set1 are routed to Path 1, and the data packets in PDU set 2 are routed to Path 2. SN numbers, such as SN 1 (or SN 1 to SN M), are added to headers of the data packets in the PDU set 1. SN numbers, such as SN 2 (or an SN M+1 to an SN K), are added to headers of the data packets in PDU set 2. The receiver receives data packets from two paths that correspond to Path 1 and Path 2 of the transmitter, and reorders PDU set 1 and PDU set 2 based on the SN numbers. For example, the reordering is performed by determining data packets and/or an order of data packets in PDU set 1 and PDU set 2 based on the SN numbers of PDU set 1 and PDU set 2. In some embodiments, the transmitter and the receiver are implemented by SDAPs, and the paths are implemented by PDCP 1 and PDCP 2. In some embodiments, the transmitter and the receiver are implemented by PDCPs, and the paths are implemented by RLC 1 and RLC 2.
7. SNs are added to at least two PDUs in a first PDU set.

For example, the transmitter adds SNs to the at least two PDUs in the first PDU set, such that the receiver is capable of delivering the data packets to the higher layer in order based on the SN numbers, or such that the receiver is capable of delivering the data packets to the higher layer in order after reordering based on the SN numbers.

It should be noted that, in all the embodiments of the present disclosure, the higher layer refers to a last protocol layer in the protocol layer architecture, or a higher-layer function of the protocol layer. The lower layer refers to a next protocol layer in the protocol layer architecture, or a lower-layer function of the protocol layer.
8. SNs are added to at least one second PDU set and at least one third PDU set (wherein 7 and 8 may be simply referred to as SNs or addition of SNs).

For example, the transmitter adds SNs to the at least one second PDU set and the at least one third PDU set, such that the receiver is capable of delivering the data packets to the higher layer in order based on the SN numbers, or such that the receiver is capable of delivering the data packets to the higher layer in order after reordering based on the SN numbers.
9. Packet headers of at least two PDUs in a first PDU set are added or removed.
10. Packet headers of at least one second PDU set and at least one third PDU set are added or removed (wherein 9 and 10 may be simply referred to as addition or removal of packet headers).
11. At least two PDUs in a first PDU set are routed to at least two output channels.

In some embodiments, the out channel includes a path or an entity. In some embodiments, the path includes any one of a QoS flow, a DRB, an RLC channel, or an LCH. In some embodiments, the entity includes any one of an SDAP entity, a PDCP entity, an RLC entity, or a MAC entity. In some embodiments, the output channels are different output channels or the same output channel.

It should be noted that the different output channels can be understood herein as different QoS flows, or different DRBs, or different RLC channels, or different LCHs, or different SDAP entities, or different PDCP entities, or different RLC entities, or different MAC entities.

In some embodiments, an input channel includes a path or an entity. In some embodiments, the path includes any one of a QoS flow, a DRB, an RLC channel, or an LCH. In some embodiments, the entity includes any one of an SDAP entity, a PDCP entity, an RLC entity, or a MAC entity.

For example, the input channel is implemented by one PDCP, and the output channels are implemented by the same or different RLCs. For example, the input channel is implemented by one SDAP/DRB, and the output channels are implemented by the same or different PDCPs.

For example, the input channels are implemented by a plurality of PDCPs, and the output channels are implemented by the same or different RLCs. For example, the input channels are implemented by a plurality of SDAP/DRBs, and the output channels are implemented by the same or different PDCPs.

In some embodiments, the output channels are to the higher layer or the lower layer.

In some embodiments, the transmitter or the receiver routes the at least two PDUs in the first PDU set to the at least two output channels based on first routing information, wherein the first routing information includes any one of configuration information, pre-configuration information, or indication information. In some embodiments, the first routing information is configured by a base station over RRC signaling. In some embodiments, the first routing information is identification information, and the first routing information identifies a corresponding relationship between the at least two PDUs in the first PDU set and the at least two output channels. In some embodiments, the first routing information is identification information, and the first routing information identifies a corresponding relationship between the at least two PDUs in the first PDU set and one input channel. In some embodiments, the first routing information is identification information, and the first routing information identifies a corresponding relationship between the at least two PDUs in the first PDU set and a plurality of input channels. In some embodiments, the first routing information is identification information, and the first routing information identifies a corresponding relationship between the input channels and the output channels.
12. At least two PDUs in a first PDU set from at least two input channels are routed to one output channel.

In some embodiments, the input channel includes a path or an entity. In some embodiments, the path includes any one of a QoS flow, a DRB, an RLC channel, or an LCH. In some embodiments, the entity includes any one of an SDAP entity, a PDCP entity, an RLC entity, or a MAC entity. In some embodiments, the input channels are different input channels or the same input channel.

It should be noted that the different input channels can be understood herein as different QoS flows, or different DRBs, or different RLC channels, or different LCHs, or different SDAP entities, or different PDCP entities, or different RLC entities, or different MAC entities.

In some embodiments, the output channel includes a path or an entity. In some embodiments, the path includes any one of a QoS flow, a DRB, an RLC channel, or an LCH. In some embodiments, the entity includes any one of an SDAP entity, a PDCP entity, an RLC entity, or a MAC entity.

For example, the input channels are implemented by the same or different RLCs, and the output channel is implemented by one PDCP. For example, the input channels are implemented by the same or different PDCPs, and the output channel is implemented by one SDAP.

For example, the input channels are implemented by the same or different RLCs, and the output channels are implemented by a plurality of PDCPs. For example, the input channels are implemented by the same or different PDCPs, and the output channels are implemented by a plurality of SDAPs.

In some embodiments, the output channels are to the higher layer or the lower layer.

In some embodiments, the receiver routes the at least two PDUs in the first PDU set from the at least two input channels to one output channel based on the first routing information, wherein the first routing information includes any one of configuration information, pre-configuration information, or indication information. In some embodiments, the first routing information is configured by a base station over RRC signaling. In some embodiments, the first routing information is identification information, and the first routing information identifies a corresponding relationship between the at least two PDUs in the first PDU set and the at least two input channels. In some embodiments, the first routing information is identification information, and the first routing information identifies a corresponding relationship between the at least two PDUs in the first PDU set and at least one output channel. In some embodiments, the first routing information is identification information, and the first routing information identifies a corresponding relationship between the input channels and the output channels.
13. At least one second PDU set and at least one third PDU set are routed to at least two output channels.

For example, the I-frame and the P-frame are routed to the two output channels.

In some embodiments, the output channel includes a path or an entity. In some embodiments, the path includes any one of a QoS flow, a DRB, an RLC channel, or an LCH. In some embodiments, the entity includes any one of an SDAP entity, a PDCP entity, an RLC entity, or a MAC entity. In some embodiments, the output channels are different output channels or the same output channel. It should be noted that the different output channels can be understood herein as different QoS flows, or different DRBs, or different RLC channels, or different LCHs, or different SDAP entities, or different PDCP entities, or different RLC entities, or different MAC entities.

In some embodiments, the output channels are to the higher layer or the lower layer.

In some embodiments, the input channel includes a path or an entity. In some embodiments, the path includes any one of a QoS flow, a DRB, an RLC channel, or an LCH. In some embodiments, the entity includes any one of an SDAP entity, a PDCP entity, an RLC entity, or a MAC entity.

For example, the input channel is implemented by one SDAP/DRB, and the output channels are implemented by the same or different PDCPs.

For example, the input channels are implemented by a plurality of PDCPs, and the output channels are implemented by the same or different RLCs. For example, the input channels are implemented by a plurality of SDAP/DRBs, and the output channels are implemented by the same or different PDCPs.

In some embodiments, the transmitter or the receiver routes the at least one second PDU set and the at least one third PDU set to the at least two output channels based on second routing information, wherein the second routing information includes any one of configuration information, pre-configuration information, or indication information. In some embodiments, the second routing information is configured by a base station over RRC signaling. In some embodiments, the second routing information is identification information, and the second routing information identifies a corresponding relationship between the at least one second PDU set and the at least one third PDU set and the at least two output channels. In some embodiments, the second routing information is identification information, and the second routing information identifies a corresponding relationship between the at least one second PDU set and the at least one third PDU set and one input channel. In some embodiments, the second routing information is identification information, and the second routing information identifies a corresponding relationship between the input channels and the output channels.
14. At least one second PDU set and at least one third PDU set from at least two input channels are routed to one output channel (wherein 11, 12, 13, and 14 may be simply referred to as routing).

In some embodiments, the input channel includes a path or an entity. In some embodiments, the path includes any one of a QoS flow, a DRB, an RLC channel, or an LCH. In some embodiments, the entity includes any one of an SDAP entity, a PDCP entity, an RLC entity, or a MAC entity. In some embodiments, the input channels are different input channels or the same input channel.

It should be noted that the different input channels can be understood herein as different QoS flows, or different DRBs, or different RLC channels, or different LCHs, or different SDAP entities, or different PDCP entities, or different RLC entities, or different MAC entities.

In some embodiments, the output channel includes a path or an entity. In some embodiments, the path includes any one of a QoS flow, a DRB, an RLC channel, or an LCH. In some embodiments, the entity includes any one of an SDAP entity, a PDCP entity, an RLC entity, or a MAC entity.

For example, the input channels are implemented by the same or different RLCs, and the output channel is implemented by one PDCP. For example, the input channels are implemented by the same or different PDCPs, and the output channel is implemented by one SDAP.

For example, the input channels are implemented by the same or different RLCs, and the output channels are implemented by a plurality of PDCPs. For example, the input channels are implemented by the same or different PDCPs, and the output channels are implemented by a plurality of SDAPs.

In some embodiments, the output channels are to the higher layer or the lower layer.

In some embodiments, the receiver routes the at least one second PDU set and the at least one third PDU set from the at least two input channels to the one output channel based on the second routing information, wherein the second routing information includes any one of configuration information, pre-configuration information, or indication information. In some embodiments, the second routing information is configured by a base station over RRC signaling. In some embodiments, the second routing information is identification information, and the second routing information identifies a corresponding relationship between the at least one second PDU set and the at least one third PDU set and the at least two input channels. In some embodiments, the second routing information is identification information, and the second routing information identifies a corresponding relationship between the at least one second PDU set and the at least one third PDU set and at least one output channel. In some embodiments, the second routing information is identification information, and the second routing information identifies a corresponding relationship between the input channels and the output channels.
15. At least one of at least two PDUs in a first PDU set is deleted or fed back to delete.

For example, in the case that the at least two PDUs in the first PDU set are partially lost, the transmitter or the receiver deletes the first PDU set or a remaining part of the at least two PDUs in the first PDU set.

For example, in the case that the at least two PDUs in the first PDU set are partially lost, the receiver feeds back to the transmitter to delete the first PDU set or a remaining part of the at least two PDUs in the first PDU set.
16. At least one of at least one second PDU set and at least one third PDU set is deleted or fed back to delete.

For example, in the case that the at least one second PDU set and the at least one third PDU set are partially lost, the transmitter or the receiver deletes the at least one second PDU set and the at least one third PDU set or a remaining part of the at least one second PDU set and the at least one third PDU set.

For example, in the case that the at least one second PDU set and the at least one third PDU set are partially lost, the receiver feeds back to the transmitter to delete the at least one second PDU set and the at least one third PDU set or a remaining part of the at least one second PDU set and the at least one third PDU set.
17. At least one of at least two PDUs in a first PDU set is retransmitted or fed back to retransmit.

For example, in the case that the at least two PDUs in the first PDU set are partially lost, the transmitter retransmits the lost part or all of the at least two PDUs in the first PDU set.

For example, in the case that the at least two PDUs in the first PDU set are partially lost, the receiver feeds back to the transmitter to retransmit the lost part or all of the at least two PDUs in the first PDU.
18. At least one of at least one second PDU set or at least one third PDU set is retransmitted or fed back to retransmit.

For example, in the case that the at least one second PDU set and the at least one third PDU set are partially lost, the transmitter retransmits the lost part or all of the at least one second PDU set and the at least one third PDU set.

For example, in the case that the at least one second PDU set and the at least one third PDU set are partially lost, the receiver feeds back to the transmitter to retransmit the lost part or all of the at least one second PDU set and the at least one third PDU set.
19. A transmission state of a first PDU set is fed back, or a transmission state of at least one PDU in a first PDU set is fed back.

The receiver feeds back the transmission state of the first PDU set to the transmitter, or the receiver feeds back the transmission state of the at least one PDU in the first PDU set to the transmitter. For example, at least one of the following cases is included. In the case that the transmission is successful, ACK is fed back; in the case that the transmission is unsuccessful, NACK is fed back; and in the case that the transmission is lost, NACK is fed back.
20. Transmission states of at least one second PDU set and at least one third PDU set are fed back, or a transmission state of at least one of at least one second PDU set or at least one third PDU set is fed back.

The receiver feeds back the transmission states of the at least one second PDU set and the at least one third PDU set to the transmitter, or the receiver feeds back the transmission state of the at least one of the at least one second PDU set or the at least one third PDU set to the transmitter, or the receiver feeds back a transmission state of at least one PDU in the at least one second PDU set and the at least one third PDU set to the transmitter. For example, at least one of the following cases is included. In the case that the transmission is successful, ACK is fed back; in the case that the transmission is unsuccessful, NACK is fed back; and in the case that the transmission is lost, NACK is fed back.
21. A data packet is generated for a PDU set and transmitted to a lower layer.

In the case that a new target protocol layer is introduced, a PDU set or PDU needs to be generated for the target protocol layer. For example, one or more PDUs corresponding to the new protocol layer are generated.

In some embodiments, in the case that the new target protocol layer is introduced, a PDU corresponding to the new protocol layer is generated by performing the integration process on the first PDU set, or at least one second PDU set and at least one third PDU set. In some embodiments, in the case that a new function is introduced into an existing protocol layer, a PDU of a lower layer is generated by performing the integration process on the first PDU set, or at least one second PDU set and at least one third PDU set.

In some embodiments, the integration process includes the processing modes of 1-10, 12, and 14-21 as described above; and the differentiation process includes the processing modes of 1-11, 13, and 15-21 as described above.

In some embodiments, the integration process includes the processing modes of 1-8, 12, and 14-21 as described above; and the differentiation process includes the processing modes of 1-8, 11, 13, and 15-21 as described above.

In some embodiments, the integration process includes the processing modes of 1-6, 9, 10, 12, and 14-21 as described above; and the differentiation process includes the processing modes of 1-6, 9-11, 13, and 15-21 as described above.

In summary, the integration process or the differentiation process is performed based on a PDU set, such that at least two PDUs having a first relationship in the first PDU set, or at least one second PDU set and at least one third PDU set having a first relationship are prevented from being processed independently, thereby improving the data processing efficiency.

For example, the integration process or the differentiation process (wherein the compression decoding of the P-frame depends on the I-frame) is performed on the PDU set representing the I-frame and the PDU set representing the P-frame, such that the data processing efficiency is improved, and the PDU set representing the I-frame and the PDU set representing the P-frame are prevented from being processed independently.

Next, the integration process or the differentiation process performed by the transmitter and the receiver are further described.

With respect to a first communication device serving as the transmitter, the integration process or the differentiation process includes at least one of:
identifying the at least two PDUs in the first PDU set;
identifying the at least one second PDU set and the at least one third PDU set;
rearranging a transmission order of the at least two PDUs in the first PDU set;
rearranging a transmission order of the at least one second PDU set and the at least one third PDU set;
reordering at least two PDUs in the first PDU set from at least one input channel of a higher layer;
reordering the at least one second PDU set and the at least one third PDU set from at least one input channel of a higher layer;
adding SNs to the at least two PDUs in the first PDU set;
adding SNs to the at least one second PDU set and the at least one third PDU set;
adding packet headers of the at least two PDUs in the first PDU set;
adding packet headers of the at least one second PDU set and the at least one third PDU set;
routing the at least two PDUs in the first PDU set to at least two output channels of a lower layer;
routing the at least one second PDU set and the at least one third PDU set to at least two output channels of a lower layer;
deleting at least one of the at least two PDUs in the first PDU set;
deleting at least one of the at least one second PDU set and the at least one third PDU set;
retransmitting at least one of the at least two PDUs in the first PDU set;
retransmitting at least one of the at least one second PDU set and the at least one third PDU set; or
generating a data packet for a PDU set and transmitting the data packet to a lower layer.

In the case that the transmitter does not differentiate the at least one input channel of the at least two PDUs in the first PDU set, the integration process or the differentiation process includes at least one of:
identifying the at least two PDUs in the first PDU set;
rearranging a transmission order of the at least two PDUs in the first PDU set;
reordering the at least two PDUs in the first PDU set from at least one input channel of a higher layer;
adding SNs to the at least two PDUs in the first PDU set;
adding packet headers of the at least two PDUs in the first PDU set;
routing the at least two PDUs in the first PDU set to at least two output channels of a lower layer;
routing the at least two PDUs in the first PDU set to one output channel of a lower layer;
deleting at least one of the at least two PDUs in the first PDU set; or
retransmitting at least one of the at least two PDUs in the first PDU set.

Alternatively, in the case that the transmitter does not differentiate the at least two PDUs in the first PDU set coming from at least two input channels and being transmitted to one input channel (in some PDU sessions or applications or QoS flows, the input channels of the at least two PDUs are not differentiated, and in other PDU sessions or applications or QoS flows, the input channels of the at least two PDUs are differentiated), the integration process or the differentiation process includes at least one of:
identifying the at least two PDUs in the first PDU set;
rearranging a transmission order of the at least two PDUs in the first PDU set;
reordering the at least two PDUs in the first PDU set from at least one input channel of a higher layer;
adding SNs to the at least two PDUs in the first PDU set;
adding packet headers of the at least two PDUs in the first PDU set;
routing the at least two PDUs in the first PDU set to at least two output channels of a lower layer;
routing the at least two PDUs in the first PDU set to one output channel of a lower layer;
deleting at least one of the at least two PDUs in the first PDU set; or
retransmitting at least one of the at least two PDUs in the first PDU set.

Alternatively, in the case that the transmitter does not differentiate the at least two PDUs in the first PDU set being transmitted to different output channels, the integration process or the differentiation process includes at least one of:
identifying the at least two PDUs in the first PDU set;
rearranging a transmission order of the at least two PDUs in the first PDU set;
reordering the at least two PDUs in the first PDU set from at least one input channel of a higher layer;
adding SNs to the at least two PDUs in the first PDU set;
adding packet headers of the at least two PDUs in the first PDU set;
routing the at least two PDUs in the first PDU set to at least two output channels of a lower layer;
routing the at least two PDUs in the first PDU set to one output channel of a lower layer;
deleting at least one of the at least two PDUs in the first PDU set; or
retransmitting at least one of the at least two PDUs in the first PDU set.

Alternatively, in the case that the transmitter does not differentiate the at least two PDUs in the first PDU set being transmitted to the same output channel or to different output channels, the integration process or the differentiation process includes at least one of:
identifying the at least two PDUs in the first PDU set;
rearranging a transmission order of the at least two PDUs in the first PDU set;
reordering the at least two PDUs in the first PDU set from at least one input channel of a higher layer;
adding SNs to the at least two PDUs in the first PDU set;
adding packet headers of the at least two PDUs in the first PDU set;
routing the at least two PDUs in the first PDU set to at least two output channels of a lower layer;
routing the at least two PDUs in the first PDU set to one output channel of a lower layer;
deleting at least one of the at least two PDUs in the first PDU set; or
retransmitting at least one of the at least two PDUs in the first PDU set.

In some embodiments, the integration process is performed in the case that the first relationship between the at least two PDUs in the first PDU set includes the association relationship or the integration process relationship. In some embodiments, the differentiation process is performed in the case that the first relationship between the at least two PDUs in the first PDU set includes the dependency relationship, the differentiation process relationship or the priority relationship.

In some embodiments, the integration process includes routing the at least two PDUs in the first PDU set to one output channel of a lower layer; and the differentiation process includes routing the at least two different PDUs in the first PDU set to at least two different output channels of a lower layer.

In the case that the transmitter differentiates the input channels of the at least two PDUs in the first PDU set, with respect to a situation where the at least two PDUs in the first PDU set come from different input channels, the integration process or the differentiation process includes at least one of:
identifying the at least two PDUs in the first PDU set;
rearranging a transmission order of the at least two PDUs in the first PDU set;
reordering the at least two PDUs in the first PDU set from different input channels of a higher layer;
adding SNs to the at least two PDUs in the first PDU set;
adding packet headers of the at least two PDUs in the first PDU set;
routing the at least two PDUs in the first PDU set to at least two output channels of a lower layer;
routing the at least two PDUs in the first PDU set to one output channel of a lower layer;
deleting at least one of the at least two PDUs in the first PDU set; or
retransmitting at least one of the at least two PDUs in the first PDU set.

Alternatively, in the case that the transmitter differentiates the at least two PDUs in the first PDU set coming from at least two input channels and transmitting to one input channel (in some PDU sessions or applications or QoS flows, the at least two PDUs are differentiated as coming from different input channels, and in other PDU sessions or applications or QoS flows, the at least two PDUs are not differentiated as coming from different input channels), the integration process or the differentiation process includes at least one of:
identifying the at least two PDUs in the first PDU set;
rearranging a transmission order of the at least two PDUs in the first PDU set;
reordering the at least two PDUs in the first PDU set from different input channels of a higher layer;
adding SNs to the at least two PDUs in the first PDU set;
adding packet headers of the at least two PDUs in the first PDU set;
routing the at least two PDUs in the first PDU set to at least two output channels of a lower layer;
routing the at least two PDUs in the first PDU set to one output channel of a lower layer;
deleting at least one of the at least two PDUs in the first PDU set; or
retransmitting at least one of the at least two PDUs in the first PDU set.

Alternatively, in the case that the transmitter differentiates the at least two PDUs in the first PDU set being transmitted to different output channels, the integration process or the differentiation process includes at least one of:
identifying the at least two PDUs in the first PDU set;
rearranging a transmission order of the at least two PDUs in the first PDU set;
reordering the at least two PDUs in the first PDU set from different input channels of a higher layer;
adding SNs to the at least two PDUs in the first PDU set;
adding packet headers of the at least two PDUs in the first PDU set;
routing the at least two PDUs in the first PDU set to at least two output channels of a lower layer;
routing the at least two PDUs in the first PDU set to one output channel of a lower layer;
deleting at least one of the at least two PDUs in the first PDU set; or
retransmitting at least one of the at least two PDUs in the first PDU set.

Alternatively, in the case that the transmitter differentiates the at least two PDUs in the first PDU set being transmitted to the same output channel or to different output channels, the integration process or the differentiation process includes at least one of:
identifying the at least two PDUs in the first PDU set;
rearranging a transmission order of the at least two PDUs in the first PDU set;
reordering the at least two PDUs in the first PDU set from different input channels of a higher layer;
adding SNs to the at least two PDUs in the first PDU set;
adding packet headers of the at least two PDUs in the first PDU set;
routing the at least two PDUs in the first PDU set to at least two output channels of a lower layer;
routing the at least two PDUs in the first PDU set to one output channel of a lower layer;
deleting at least one of the at least two PDUs in the first PDU set; or
retransmitting at least one of the at least two PDUs in the first PDU set.

In some embodiments, the integration process is performed in the case that the first relationship between the at least two PDUs in the first PDU set includes the association relationship or the integration process relationship. In some embodiments, the differentiation process is performed in the case that the first relationship between the at least two PDUs in the first PDU set includes the dependency relationship or the differentiation process or the priority.

In some embodiments, the integration process includes routing the at least two PDUs in the first PDU set to one output channel of a lower layer; and the differentiation process includes routing the at least two different PDUs in the first PDU set to at least two different output channels of a lower layer.

In the case that the transmitter differentiates the input channels of the at least two PDUs in the first PDU set, with respect to a situation where the at least two PDUs in the first PDU set come from the same input channel, the integration process or the differentiation process includes at least one of:
identifying the at least two PDUs in the first PDU set;
rearranging a transmission order of the at least two PDUs in the first PDU set;
reordering the at least two PDUs in the first PDU set from the same input channel of a higher layer;
routing the at least two PDUs in the first PDU set to at least two output channels of a lower layer;
routing the at least two PDUs in the first PDU set to one output channel of a lower layer;
deleting at least one of the at least two PDUs in the first PDU set; or
retransmitting at least one of the at least two PDUs in the first PDU set.

Alternatively, in the case that the transmitter differentiates the at least two PDUs in the first PDU set coming from at least two input channels or being transmitting to one input channel (in some PDU sessions or applications or QoS flows, the at least two PDUs are differentiated as coming from the same input channel, and in other PDU sessions or applications or QoS flows, the at least two PDUs are not differentiated as coming from the same input channel), the integration process or the differentiation process includes at least one of:
identifying the at least two PDUs in the first PDU set;
rearranging a transmission order of the at least two PDUs in the first PDU set;
reordering the at least two PDUs in the first PDU set from the same input channel of a higher layer;
routing the at least two PDUs in the first PDU set to at least two output channels of a lower layer;
routing the at least two PDUs in the first PDU set to one output channel of a lower layer;
deleting at least one of the at least two PDUs in the first PDU set; or
retransmitting at least one of the at least two PDUs in the first PDU set.

Alternatively, in the case that the transmitter differentiates the at least two PDUs in the first PDU set being transmitted to different output channels, the integration process or the differentiation process includes at least one of:
identifying the at least two PDUs in the first PDU set;
rearranging a transmission order of the at least two PDUs in the first PDU set;
reordering the at least two PDUs in the first PDU set from the same input channel of a higher layer;
routing the at least two PDUs in the first PDU set to at least two output channels of a lower layer;
routing the at least two PDUs in the first PDU set to one output channel of a lower layer;
deleting at least one of the at least two PDUs in the first PDU set; or
retransmitting at least one of the at least two PDUs in the first PDU set.

Alternatively, in the case that the transmitter differentiates the at least two PDUs in the first PDU set being transmitted to the same output channel or to different output channels, the integration process or the differentiation process includes at least one of:
identifying the at least two PDUs in the first PDU set;
rearranging a transmission order of the at least two PDUs in the first PDU set;
reordering the at least two PDUs in the first PDU set from the same input channel of a higher layer;
routing the at least two PDUs in the first PDU set to at least two output channels of a lower layer;
routing the at least two PDUs in the first PDU set to one output channel of a lower layer;
deleting at least one of the at least two PDUs in the first PDU set; or
retransmitting at least one of the at least two PDUs in the first PDU set.

In some embodiments, the integration process is performed in the case that the first relationship between the at least two PDUs in the first PDU set includes the association relationship or the priority relationship or the integration process relationship. In some embodiments, the differentiation process is performed in the case that the first relationship between the at least two PDUs in the first PDU set includes the dependency relationship or the differentiation process relationship or the priority relationship.

In some embodiments, the integration process includes routing the at least two PDUs in the first PDU set to one output channel of the lower layer; and the differentiation process includes routing the at least two PDUs in the first PDU set to at least two different output channels of the lower layer.

In the case that the transmitter does not differentiate the input channels of the at least one second PDU set and the at least one third PDU set, the integration process or the differentiation process includes at least one of:
identifying the at least one second PDU set and the at least one third PDU set;
rearranging a transmission order of the at least one second PDU set and the at least one third PDU set;
reordering the at least one second PDU set and the at least one third PDU set from input channels of a higher layer;
adding SNs to the at least one second PDU set and the at least one third PDU set;
adding packet headers of the at least one second PDU set and the at least one third PDU set;
routing the at least one second PDU set and the at least one third PDU set to at least two output channels of a lower layer;
routing the at least one second PDU set and the at least one third PDU set to one output channel of a lower layer;
deleting at least one of the at least one second PDU set and at least one third PDU set; or
retransmitting at least one of the at least one second PDU set and the at least one third PDU set.

Alternatively, in the case that the transmitter does not differentiate whether one or more input channels of the at least one second PDU set and the at least one third PDU set are present (in some PDU sessions or applications or QoS flows, the input channels of the at least one second PDU set and the at least one third PDU set are differentiated, and in other PDU sessions or applications or QoS flows, the input channels of the at least one second PDU set and the at least one third PDU set are not differentiated), the integration process or the differentiation process includes at least one of:
identifying the at least one second PDU set and the at least one third PDU set;
rearranging a transmission order of the at least one second PDU set and the at least one third PDU set;
reordering the at least one second PDU set and the at least one third PDU set from input channels of a higher layer;
adding SNs to the at least one second PDU set and the at least one third PDU set;
adding packet headers of the at least one second PDU set and the at least one third PDU set;
routing the at least one second PDU set and the at least one third PDU set to at least two output channels of a lower layer;
routing the at least one second PDU set and the at least one third PDU set to one output channel of a lower layer;
deleting at least one of the at least one second PDU set and at least one third PDU set; or
retransmitting at least one of the at least one second PDU set and the at least one third PDU set.

Alternatively, in the case that the transmitter does not differentiate the at least one second PDU set and the at least one third PDU set being transmitted to different output channels, the integration process or the differentiation process includes at least one of:
identifying the at least one second PDU set and the at least one third PDU set;
rearranging a transmission order of the at least one second PDU set and the at least one third PDU set;
reordering the at least one second PDU set and the at least one third PDU set from input channels of a higher layer;
adding SNs to the at least one second PDU set and the at least one third PDU set;
adding packet headers of the at least one second PDU set and the at least one third PDU set;
routing the at least one second PDU set and the at least one third PDU set to at least two output channels of a lower layer;
routing the at least one second PDU set and the at least one third PDU set to one output channel of a lower layer;
deleting at least one of the at least one second PDU set and at least one third PDU set; or
retransmitting at least one of the at least one second PDU set and the at least one third PDU set.

Alternatively, in the case that the transmitter does not differentiate the at least one second PDU set and the at least one third PDU set being transmitted to the same output channel or different output channels, the integration process or the differentiation process includes at least one of:
identifying the at least one second PDU set and the at least one third PDU set;
rearranging a transmission order of the at least one second PDU set and the at least one third PDU set;
reordering the at least one second PDU set and the at least one third PDU set from input channels of a higher layer;
adding SNs to the at least one second PDU set and the at least one third PDU set;
adding packet headers of the at least one second PDU set and the at least one third PDU set;
routing the at least one second PDU set and the at least one third PDU set to at least two output channels of a lower layer;
routing the at least one second PDU set and the at least one third PDU set to one output channel of a lower layer;
deleting at least one of the at least one second PDU set and at least one third PDU set; or
retransmitting at least one of the at least one second PDU set and the at least one third PDU set.

In some embodiments, the integration process is performed in the case that the first relationship between the second PDU set and the third PDU set includes the association relationship or the priority relationship or the integration process relationship. In some embodiments, the differentiation process is performed in the case that the first relationship between the second PDU set and the third PDU set includes the dependency relationship or the differentiation process relationship or the priority relationship.

In some embodiments, the integration process includes routing the at least one second PDU set and the at least one third PDU set to one output channel of the lower layer; and the differentiation process includes routing the at least one second PDU set and the at least one third PDU to at least two different output channels of the lower layer.

In the case that the transmitter differentiates the input channels of the at least one second PDU set and the at least one third PDU set, with respect to a situation where the at least one second PDU set and the at least one third PDU set come from different input channels, the integration process or the differentiation process includes at least one of:
identifying the at least one second PDU set and the at least one third PDU set;
rearranging a transmission order of a the t least one second PDU set and the at least one third PDU set;
reordering the at least one second PDU set and the at least one third PDU set from different input channels of a higher layer;
adding SNs to the at least one second PDU set and the at least one third PDU set;
adding packet headers of the at least one second PDU set and the at least one third PDU set;
routing the at least one second PDU set and the at least one third PDU set to at least two output channels of a lower layer;
routing the at least one second PDU set and the at least one third PDU set to one output channel of a lower layer;
deleting at least one of the at least one second PDU set and the at least one third PDU set; or
retransmitting at least one of the at least one second PDU set and the at least one third PDU set.

Alternatively, in the case that the transmitter differentiates whether one or more input channels of the at least one second PDU set and the at least one third PDU set are present (in some PDU sessions or applications or QoS flows, the at least one second PDU set and the at least one third PDU set are differentiated as coming from different input channels, and in other PDU sessions or applications or QoS flows, the at least one second PDU set and the at least one third PDU set are not differentiated as coming from different input channels), the integration process or the differentiation process includes at least one of:
identifying the at least one second PDU set and the at least one third PDU set;
rearranging a transmission order of a the t least one second PDU set and the at least one third PDU set;
reordering the at least one second PDU set and the at least one third PDU set from different input channels of a higher layer;
adding SNs to the at least one second PDU set and the at least one third PDU set;
adding packet headers of the at least one second PDU set and the at least one third PDU set;
routing the at least one second PDU set and the at least one third PDU set to at least two output channels of a lower layer;
routing the at least one second PDU set and the at least one third PDU set to one output channel of a lower layer;
deleting at least one of the at least one second PDU set and the at least one third PDU set; or
retransmitting at least one of the at least one second PDU set and the at least one third PDU set.

Alternatively, in the case that the transmitter differentiates the at least one second PDU set and the at least one third PDU set being transmitted to different output channels, the integration process or the differentiation process includes at least one of:
identifying the at least one second PDU set and the at least one third PDU set;
rearranging a transmission order of a the t least one second PDU set and the at least one third PDU set;
reordering the at least one second PDU set and the at least one third PDU set from different input channels of a higher layer;
adding SNs to the at least one second PDU set and the at least one third PDU set;
adding packet headers of the at least one second PDU set and the at least one third PDU set;
routing the at least one second PDU set and the at least one third PDU set to at least two output channels of a lower layer;
routing the at least one second PDU set and the at least one third PDU set to one output channel of a lower layer;
deleting at least one of the at least one second PDU set and the at least one third PDU set; or
retransmitting at least one of the at least one second PDU set and the at least one third PDU set.

Alternatively, in the case that the transmitter differentiates the at least one second PDU set and the at least one third PDU set being transmitted to the same output channel or different output channels, the integration process or the differentiation process includes at least one of:
identifying the at least one second PDU set and the at least one third PDU set;
rearranging a transmission order of a the t least one second PDU set and the at least one third PDU set;
reordering the at least one second PDU set and the at least one third PDU set from different input channels of a higher layer;
adding SNs to the at least one second PDU set and the at least one third PDU set;
adding packet headers of the at least one second PDU set and the at least one third PDU set;
routing the at least one second PDU set and the at least one third PDU set to at least two output channels of a lower layer;
routing the at least one second PDU set and the at least one third PDU set to one output channel of a lower layer;
deleting at least one of the at least one second PDU set and the at least one third PDU set; or
retransmitting at least one of the at least one second PDU set and the at least one third PDU set.

In some embodiments, the integration process is performed in the case that the first relationship between the second PDU set and the third PDU set includes the association relationship or the priority relationship or the integration process relationship. In some embodiments, the differentiation process is performed in the case that the first relationship between the second PDU set and the third PDU set includes the dependency relationship or the differentiation process relationship or the priority relationship.

In some embodiments, the integration process includes routing the at least one second PDU set and the at least one third PDU set to one output channel of the lower layer; and the differentiation process includes routing the at least one second PDU set and the at least one third PDU to at least two different output channels of the lower layer.

In the case that the transmitter differentiates the input channels of the at least one second PDU set and the at least one third PDU set, with respect to a situation where the at least one second PDU set and the at least one third PDU set come from the same input channel, the integration process or the differentiation process includes at least one of:
identifying the at least one second PDU set and the at least one third PDU set;
rearranging a transmission order of the at least one second PDU set and the at least one third PDU set;
reordering the at least one second PDU set and the at least one third PDU set from the same input channel of a higher layer;
routing the at least one second PDU set and the at least one third PDU set to at least two output channels of a lower layer;
routing the at least one second PDU set and the at least one third PDU set to one output channel of a lower layer;
deleting at least one of the at least one second PDU set and the at least one third PDU set; or
retransmitting at least one of the at least one second PDU set and the at least one third PDU set.

Alternatively, in the case that the transmitter differentiates whether one or more input channels of the at least one second PDU set and the at least one third PDU set are present (in some PDU sessions or applications or QoS flows, the at least one second PDU set and the at least one third PDU set are differentiated as coming from the same input channel, and in other PDU sessions or applications or QoS flows, the at least one second PDU set and the at least one third PDU set are not differentiated as coming from the same input channel), the integration process or the differentiation process includes at least one of:
identifying the at least one second PDU set and the at least one third PDU set;
rearranging a transmission order of the at least one second PDU set and the at least one third PDU set;
reordering the at least one second PDU set and the at least one third PDU set from the same input channel of a higher layer;
routing the at least one second PDU set and the at least one third PDU set to at least two output channels of a lower layer;
routing the at least one second PDU set and the at least one third PDU set to one output channel of a lower layer;
deleting at least one of the at least one second PDU set and the at least one third PDU set; or
retransmitting at least one of the at least one second PDU set and the at least one third PDU set.

Alternatively, in the case that the transmitter differentiates the at least one second PDU set and the at least one third PDU set being transmitted to different output channels, the integration process or the differentiation process includes at least one of:
identifying the at least one second PDU set and the at least one third PDU set;
rearranging a transmission order of the at least one second PDU set and the at least one third PDU set;
reordering the at least one second PDU set and the at least one third PDU set from the same input channel of a higher layer;
routing the at least one second PDU set and the at least one third PDU set to at least two output channels of a lower layer;
routing the at least one second PDU set and the at least one third PDU set to one output channel of a lower layer;
deleting at least one of the at least one second PDU set and the at least one third PDU set; or
retransmitting at least one of the at least one second PDU set and the at least one third PDU set.

Alternatively, in the case that the transmitter differentiates the at least one second PDU set and the at least one third PDU set being transmitted to the same output channel or different output channels, the integration process or the differentiation process includes at least one of:
identifying the at least one second PDU set and the at least one third PDU set;
rearranging a transmission order of the at least one second PDU set and the at least one third PDU set;
reordering the at least one second PDU set and the at least one third PDU set from the same input channel of a higher layer;
routing the at least one second PDU set and the at least one third PDU set to at least two output channels of a lower layer;
routing the at least one second PDU set and the at least one third PDU set to one output channel of a lower layer;
deleting at least one of the at least one second PDU set and the at least one third PDU set; or
retransmitting at least one of the at least one second PDU set and the at least one third PDU set.

In some embodiments, the integration process is performed in the case that the first relationship between the second PDU set and the third PDU set includes the association relationship or the priority relationship or the integration process relationship. In some embodiments, the differentiation process is performed in the case that the first relationship between the second PDU set and the third PDU set includes the dependency relationship or the differentiation process relationship or the priority relationship.

In some embodiments, the integration process includes routing the at least one second PDU set and the at least one third PDU set to one output channel of the lower layer; and the differentiation process includes routing the at least one second PDU set and the at least one third PDU to at least two different output channels of the lower layer.

With respect to a second communication device serving as the receiver, the integration process or the differentiation process includes at least one of:
identifying the at least two PDUs in the first PDU set;
identifying the at least one second PDU set and the at least one third PDU set;
rearranging a transmission order of the at least two PDUs in the first PDU set;
rearranging a transmission order of the at least one second PDU set and the at least one third PDU set;
reordering the at least two PDUs in the first PDU set from input channels of a lower layer;
reordering the at least one second PDU set and the at least one third PDU set from input channels of a lower layer;
removing packet headers of the at least two PDUs in the first PDU set;
removing packet headers of the at least one second PDU set and the at least one third PDU set;
routing the at least two PDUs in the first PDU set to at least two output channels of a higher layer;
routing the at least one second PDU set and the at least one third PDU set to at least two output channels of a higher layer;
routing the at least two PDUs in the first PDU set from at least two input channels of a lower layer to one output channel of a higher layer;
routing the at least one second PDU set and the at least one third PDU set from at least two input channels of a lower layer to one output channel of a higher layer;
deleting or feeding back deletion of at least one of the at least two PDUs in the first PDU set;
deleting or feeding back deletion of at least one of the at least one second PDU set and the at least one third PDU set;
feeding back retrainsmission of at least one of the at least two PDUs in the first PDU set;
feeding back retransmission of at least one of the at least one second PDU set and the at least one third PDU set;
feeding back a transmission state of the first PDU set, or feeding back a transmission state of at least one PDU in the first PDU set; or
feeding back transmission states of the at least one second PDU set and the at least one third PDU set, or feeding back a transmission state of at least one of the at least one second PDU set or the at least one third PDU set.

In the case that the receiver does not differentiate the input channels of the at least two PDUs in the first PDU set, the integration process or the differentiation process includes at least one of:
identifying the at least two PDUs in the first PDU set;
rearranging a transmission order of the at least two PDUs in the first PDU set;
reordering the at least two PDUs in the first PDU set from input channels of a lower layer;
removing packet headers of the at least two PDUs in the first PDU set;
routing the at least two PDUs in the first PDU set to at least two output channels of a higher layer;
routing the at least two PDUs in the first PDU set from at least two input channels of a lower layer to one output channel of a higher layer;
deleting or feeding back deletion of at least one of the at least two PDUs in the first PDU set;
feeding back retransmission of at least one of the at least two PDUs in the first PDU set; or
feeding back a transmission state of the first PDU set, or feeding back a transmission state of at least one PDU in the first PDU set.

Alternatively, in the case that the receiver does not differentiate at least two input channels and one input channel of the at least two PDUs in the first PDU set (in some PDU sessions or applications or QoS flows, the input channels of the at least two PDUs are differentiated, and in other PDU sessions or applications or QoS flows, the input channels of the at least two PDUs are not differentiated), the integration process or the differentiation process includes at least one of:
identifying the at least two PDUs in the first PDU set;
rearranging a transmission order of the at least two PDUs in the first PDU set;
reordering the at least two PDUs in the first PDU set from input channels of a lower layer;
removing packet headers of the at least two PDUs in the first PDU set;
routing the at least two PDUs in the first PDU set to at least two output channels of a higher layer;
routing the at least two PDUs in the first PDU set from at least two input channels of a lower layer to one output channel of a higher layer;
deleting or feeding back deletion of at least one of the at least two PDUs in the first PDU set;
feeding back retransmission of at least one of the at least two PDUs in the first PDU set; or
feeding back a transmission state of the first PDU set, or feeding back a transmission state of at least one PDU in the first PDU set.

Alternatively, in the case that the receiver does not differentiate the output channels of the at least two PDUs in the first PDU set, the integration process or the differentiation process includes at least one of:
identifying the at least two PDUs in the first PDU set;
rearranging a transmission order of the at least two PDUs in the first PDU set;
reordering the at least two PDUs in the first PDU set from input channels of a lower layer;
removing packet headers of the at least two PDUs in the first PDU set;
routing the at least two PDUs in the first PDU set to at least two output channels of a higher layer;
routing the at least two PDUs in the first PDU set from at least two input channels of a lower layer to one output channel of a higher layer;
deleting or feeding back deletion of at least one of the at least two PDUs in the first PDU set;
feeding back retransmission of at least one of the at least two PDUs in the first PDU set; or
feeding back a transmission state of the first PDU set, or feeding back a transmission state of at least one PDU in the first PDU set.

Alternatively, in the case that the receiver does not differentiate at least two output channels and one output channel of the at least two PDUs in the first PDU set, the integration process or the differentiation process includes at least one of:
identifying the at least two PDUs in the first PDU set;
rearranging a transmission order of the at least two PDUs in the first PDU set;
reordering the at least two PDUs in the first PDU set from input channels of a lower layer;
removing packet headers of the at least two PDUs in the first PDU set;
routing the at least two PDUs in the first PDU set to at least two output channels of a higher layer;
routing the at least two PDUs in the first PDU set from at least two input channels of a lower layer to one output channel of a higher layer;
deleting or feeding back deletion of at least one of the at least two PDUs in the first PDU set;
feeding back retransmission of at least one of the at least two PDUs in the first PDU set; or
feeding back a transmission state of the first PDU set, or feeding back a transmission state of at least one PDU in the first PDU set.

In some embodiments, the integration process is performed in the case that the first relationship between the at least two PDUs in the first PDU set includes the association relationship or the priority relationship or the integration process relationship. In some embodiments, the differentiation process is performed in the case that the first relationship between the at least two PDUs in the first PDU set includes the dependency relationship or the differentiation process relationship or the priority relationship.

In some embodiments, the integration process includes routing the at least two PDUs in the first PDU set to one output channel of the higher layer; and the differentiation process includes routing the at least two PDUs in the first PDU set to at least two different output channels of the higher layer.

In the case that the receiver differentiates the input channels of the at least two PDUs in the PDU set, with respect to a situation where the at least two PDUs in the PDU set come from different input channels, the integration process or the differentiation process includes at least one of:
identifying the at least two PDUs in the first PDU set;
rearranging a transmission order of the at least two PDUs in the first PDU set;
reordering the at least two PDUs in the first PDU set from different input channels of a lower layer;
removing packet headers of the at least two PDUs in the first PDU set;
routing the at least two PDUs in the first PDU set to at least two output channels of a higher layer;
routing the at least one second PDU set and the at least one third PDU set from at least two input channels of a lower layer to one output channel of a higher layer;
deleting or feeding back deletion of at least one of the at least two PDUs in the first PDU set;
feeding back retransmission of at least one of the at least two PDUs in the first PDU set; or
feeding back a transmission state of the first PDU set, or feeding back a transmission state of at least one PDU in the first PDU set.

Alternatively, in the case that the receiver differentiates at least two input channels and one input channel of the at least two PDUs in the first PDU set (in some PDU sessions or applications or QoS flows, the at least two PDUs are differentiated as coming from different input channels, and in other PDU sessions or applications or QoS flows, the at least two PDUs are not differentiated as coming from different input channels), the integration process or the differentiation process includes at least one of:
identifying the at least two PDUs in the first PDU set;
rearranging a transmission order of the at least two PDUs in the first PDU set;
reordering the at least two PDUs in the first PDU set from different input channels of a lower layer;
removing packet headers of the at least two PDUs in the first PDU set;
routing the at least two PDUs in the first PDU set to at least two output channels of a higher layer;
routing the at least one second PDU set and the at least one third PDU set from at least two input channels of a lower layer to one output channel of a higher layer;
deleting or feeding back deletion of at least one of the at least two PDUs in the first PDU set;
feeding back retransmission of at least one of the at least two PDUs in the first PDU set; or
feeding back a transmission state of the first PDU set, or feeding back a transmission state of at least one PDU in the first PDU set.

Alternatively, in the case that the receiver differentiates the output channels of the at least two PDUs in the first PDU set, the integration process or the differentiation process includes at least one of:
identifying the at least two PDUs in the first PDU set;
rearranging a transmission order of the at least two PDUs in the first PDU set;
reordering the at least two PDUs in the first PDU set from different input channels of a lower layer;
removing packet headers of the at least two PDUs in the first PDU set;
routing the at least two PDUs in the first PDU set to at least two output channels of a higher layer;
routing the at least one second PDU set and the at least one third PDU set from at least two input channels of a lower layer to one output channel of a higher layer;
deleting or feeding back deletion of at least one of the at least two PDUs in the first PDU set;
feeding back retransmission of at least one of the at least two PDUs in the first PDU set; or
feeding back a transmission state of the first PDU set, or feeding back a transmission state of at least one PDU in the first PDU set.

Alternatively, in the case that the receiver differentiates at least two output channels and one output channel of the at least two PDUs in the first PDU set, the integration process or the differentiation process includes at least one of:
identifying the at least two PDUs in the first PDU set;
rearranging a transmission order of the at least two PDUs in the first PDU set;
reordering the at least two PDUs in the first PDU set from different input channels of a lower layer;
removing packet headers of the at least two PDUs in the first PDU set;
routing the at least two PDUs in the first PDU set to at least two output channels of a higher layer;
routing the at least one second PDU set and the at least one third PDU set from at least two input channels of a lower layer to one output channel of a higher layer;
deleting or feeding back deletion of at least one of the at least two PDUs in the first PDU set;
feeding back retransmission of at least one of the at least two PDUs in the first PDU set; or
feeding back a transmission state of the first PDU set, or feeding back a transmission state of at least one PDU in the first PDU set.

In some embodiments, the integration process is performed in the case that the first relationship between the at least two PDUs in the first PDU set includes the association relationship or the priority relationship or the integration process relationship. In some embodiments, the differentiation process is performed in the case that the first relationship between the at least two PDUs in the first PDU set includes the dependency relationship or the differentiation process relationship or the priority relationship.

In some embodiments, the integration process includes routing the at least two PDUs in the first PDU set to one output channel of the higher layer; and the differentiation process includes routing the at least two PDUs in the first PDU set to at least two different output channels of the higher layer.

In the case that the receiver differentiates the input channels of the at least two PDUs in the PDU set, with respect to a situation where the at least two PDUs in the PDU set come from the same input channel, the integration process or the differentiation process includes at least one of:
identifying the at least two PDUs in the first PDU set;
rearranging a transmission order of the at least two PDUs in the first PDU set;
reordering the at least two PDUs in the first PDU set from the same input channel of a lower layer;
routing the at least two PDUs in the first PDU set to at least two output channels of a higher layer;
routing the at least two PDUs in the first PDU set to one output channel of a higher layer;
deleting or feeding back deletion of at least one of the at least two PDUs in the first PDU set;
feeding back retransmission of at least one of the at least two PDUs in the first PDU set; or
feeding back a transmission state of the first PDU set, or feeding back a transmission state of at least one PDU in the first PDU set.

Alternatively, in the case that the receiver differentiates at least two input channels and one input channel of the at least two PDUs in the first PDU set (in some PDU sessions or applications or QoS flows, the at least two PDUs are differentiated as coming from the same input channel, and in other PDU sessions or applications or QoS flows, the at least two PDUs are not differentiated as coming from the same input channel), the integration process or the differentiation process includes at least one of:
identifying the at least two PDUs in the first PDU set;
rearranging a transmission order of the at least two PDUs in the first PDU set;
reordering the at least two PDUs in the first PDU set from the same input channel of a lower layer;
routing the at least two PDUs in the first PDU set to at least two output channels of a higher layer;
routing the at least two PDUs in the first PDU set to one output channel of a higher layer;
deleting or feeding back deletion of at least one of the at least two PDUs in the first PDU set;
feeding back retransmission of at least one of the at least two PDUs in the first PDU set; or
feeding back a transmission state of the first PDU set, or feeding back a transmission state of at least one PDU in the first PDU set.

Alternatively, in the case that the receiver differentiates the output channels of the at least two PDUs in the first PDU set, the integration process or the differentiation process includes at least one of:
identifying the at least two PDUs in the first PDU set;
rearranging a transmission order of the at least two PDUs in the first PDU set;
reordering the at least two PDUs in the first PDU set from the same input channel of a lower layer;
routing the at least two PDUs in the first PDU set to at least two output channels of a higher layer;
routing the at least two PDUs in the first PDU set to one output channel of a higher layer;
deleting or feeding back deletion of at least one of the at least two PDUs in the first PDU set;
feeding back retransmission of at least one of the at least two PDUs in the first PDU set; or
feeding back a transmission state of the first PDU set, or feeding back a transmission state of at least one PDU in the first PDU set.

Alternatively, in the case that the receiver differentiates at least two output channels and one output channel of the at least two PDUs in the first PDU set, the integration process or the differentiation process includes at least one of:
identifying the at least two PDUs in the first PDU set;
rearranging a transmission order of the at least two PDUs in the first PDU set;
reordering the at least two PDUs in the first PDU set from the same input channel of a lower layer;
routing the at least two PDUs in the first PDU set to at least two output channels of a higher layer;
routing the at least two PDUs in the first PDU set to one output channel of a higher layer;
deleting or feeding back deletion of at least one of the at least two PDUs in the first PDU set;
feeding back retransmission of at least one of the at least two PDUs in the first PDU set; or
feeding back a transmission state of the first PDU set, or feeding back a transmission state of at least one PDU in the first PDU set.

In some embodiments, the integration process is performed in the case that the first relationship between the at least two PDUs in the first PDU set includes the association relationship or the priority relationship or the integration process relationship. In some embodiments, the differentiation process is performed in the case that the first relationship between the at least two PDUs in the first PDU set includes the dependency relationship or the differentiation process relationship or the priority relationship.

In some embodiments, the integration process includes routing the at least two PDUs in the first PDU set to one output channel of the higher layer; and the differentiation process includes routing the at least two PDUs in the first PDU set to at least two different output channels of the higher layer.

In the case that the receiver does not differentiate the input channels of the at least one second PDU set and the at least one third PDU set, the integration process or the differentiation process includes at least one of the following; alternatively,
in the case that the receiver does not differentiate whether one or more input channels of the at least one second PDU set and the at least one third PDU set are present (in some PDU sessions or applications or QoS flows, the input channels of the at least one second PDU set and the at least one third PDU set are differentiated, and in other PDU sessions or applications or QoS flows, the input channels of the at least one second PDU set and the at least one third PDU set are not differentiated), the integration process or the differentiation process includes at least one of:
identifying the at least one second PDU set and the at least one third PDU set;
rearranging a transmission order of the at least one second PDU set and the at least one third PDU set;
reordering the at least one second PDU set and the at least one third PDU set from input channels of a lower layer;
removing packet headers of the at least one second PDU set and the at least one third PDU set;
routing the at least one second PDU set and the at least one third PDU set to at least two output channels of a higher layer;
routing the at least one second PDU set and the at least one third PDU set to one output channel of a higher layer;
deleting or feeding back deletion of at least one of the at least one second PDU set and the at least one third PDU set;
feeding back retransmission of at least one of the at least one second PDU set and the at least one third PDU set; or
feeding back transmission states of the at least one second PDU set and the at least one third PDU set, or feeding back a transmission state of at least one of the at least one second PDU set or the at least one third PDU set.

Alternatively, in the case that the receiver does not differentiate the at least one second PDU set and the at least one third PDU set being transmitted to different output channels, the integration process or the differentiation process includes at least one of:
identifying the at least one second PDU set and the at least one third PDU set;
rearranging a transmission order of the at least one second PDU set and the at least one third PDU set;
reordering the at least one second PDU set and the at least one third PDU set from input channels of a lower layer;
removing packet headers of the at least one second PDU set and the at least one third PDU set;
routing the at least one second PDU set and the at least one third PDU set to at least two output channels of a higher layer;
routing the at least one second PDU set and the at least one third PDU set to one output channel of a higher layer;
deleting or feeding back deletion of at least one of the at least one second PDU set and the at least one third PDU set;
feeding back retransmission of at least one of the at least one second PDU set and the at least one third PDU set; or
feeding back transmission states of the at least one second PDU set and the at least one third PDU set, or feeding back a transmission state of at least one of the at least one second PDU set or the at least one third PDU set.

Alternatively, in the case that the receiver does not differentiate the at least one second PDU set and the at least one third PDU set being transmitted to the same output channel or different output channels, the integration process or the differentiation process includes at least one of:
identifying the at least one second PDU set and the at least one third PDU set;
rearranging a transmission order of the at least one second PDU set and the at least one third PDU set;
reordering the at least one second PDU set and the at least one third PDU set from input channels of a lower layer;
removing packet headers of the at least one second PDU set and the at least one third PDU set;
routing the at least one second PDU set and the at least one third PDU set to at least two output channels of a higher layer;
routing the at least one second PDU set and the at least one third PDU set to one output channel of a higher layer;
deleting or feeding back deletion of at least one of the at least one second PDU set and the at least one third PDU set;
feeding back retransmission of at least one of the at least one second PDU set and the at least one third PDU set; or
feeding back transmission states of the at least one second PDU set and the at least one third PDU set, or feeding back a transmission state of at least one of the at least one second PDU set or the at least one third PDU set.

In some embodiments, the integration process is performed in the case that the first relationship between the second PDU set and the third PDU set includes the association relationship or the priority relationship or the integration process relationship. In some embodiments, the differentiation process is performed in the case that the first relationship between the second PDU set and the third PDU set includes the dependency relationship or the differentiation process relationship or the priority relationship.

In some embodiments, the integration process includes routing the at least one second PDU set and the at least one third PDU set to one output channel of the higher layer; and the differentiation process includes routing the at least one second PDU set and the at least one third PDU set to at least two different output channels of the higher layer.

In the case that the receiver differentiates the input channels of the at least one second PDU set and the at least one third PDU set, with respect to a situation where the at least one second PDU set and the at least one third PDU set come from different input channels, the integration process or the differentiation process includes at least one of:
identifying the at least one second PDU set and the at least one third PDU set;
rearranging a transmission order of the at least one second PDU set and the at least one third PDU set;
reordering the at least one second PDU set and the at least one third PDU set from different input channels of a lower layer;
removing packet headers of the at least one second PDU set and the at least one third PDU set;
routing the at least one second PDU set and the at least one third PDU set to at least two output channels of a higher layer;
routing the at least one second PDU set and the at least one third PDU set to one output channel of a higher layer;
deleting or feeding back deletion of at least one of the at least one second PDU set and the at least one third PDU set;
feeding back retransmission of at least one of the at least one second PDU set and the at least one third PDU set; or
feeding back transmission states of the at least one second PDU set and the at least one third PDU set, or feeding back a transmission state of at least one of the at least one second PDU set or the at least one third PDU set.

Alternatively, in the case that the receiver differentiates whether one or more input channels of the at least one second PDU set and the at least one third PDU set are present (in some PDU sessions or applications or QoS flows, the at least one second PDU set and the at least one third PDU set are differentiated as coming from different input channels, and in other PDU sessions or applications or QoS flows, the at least one second PDU set and the at least one third PDU set are not differentiated as coming from different input channels), the integration process or the differentiation process includes at least one of:
identifying the at least one second PDU set and the at least one third PDU set;
rearranging a transmission order of the at least one second PDU set and the at least one third PDU set;
reordering the at least one second PDU set and the at least one third PDU set from different input channels of a lower layer;
removing packet headers of the at least one second PDU set and the at least one third PDU set;
routing the at least one second PDU set and the at least one third PDU set to at least two output channels of a higher layer;
routing the at least one second PDU set and the at least one third PDU set to one output channel of a higher layer;
deleting or feeding back deletion of at least one of the at least one second PDU set and the at least one third PDU set;
feeding back retransmission of at least one of the at least one second PDU set and the at least one third PDU set; or
feeding back transmission states of the at least one second PDU set and the at least one third PDU set, or feeding back a transmission state of at least one of the at least one second PDU set or the at least one third PDU set.

Alternatively, in the case that the receiver differentiates the at least one second PDU set and the at least one third PDU set being transmitted to different output channels, the integration process or the differentiation process includes at least one of:
identifying the at least one second PDU set and the at least one third PDU set;
rearranging a transmission order of the at least one second PDU set and the at least one third PDU set;
reordering the at least one second PDU set and the at least one third PDU set from different input channels of a lower layer;
removing packet headers of the at least one second PDU set and the at least one third PDU set;
routing the at least one second PDU set and the at least one third PDU set to at least two output channels of a higher layer;
routing the at least one second PDU set and the at least one third PDU set to one output channel of a higher layer;
deleting or feeding back deletion of at least one of the at least one second PDU set and the at least one third PDU set;
feeding back retransmission of at least one of the at least one second PDU set and the at least one third PDU set; or
feeding back transmission states of the at least one second PDU set and the at least one third PDU set, or feeding back a transmission state of at least one of the at least one second PDU set or the at least one third PDU set.

Alternatively, in the case that the receiver differentiates the at least one second PDU set and the at least one third PDU set being transmitted to the same output channel or different output channels, the integration process or the differentiation process includes at least one of:
identifying the at least one second PDU set and the at least one third PDU set;
rearranging a transmission order of the at least one second PDU set and the at least one third PDU set;
reordering the at least one second PDU set and the at least one third PDU set from different input channels of a lower layer;
removing packet headers of the at least one second PDU set and the at least one third PDU set;
routing the at least one second PDU set and the at least one third PDU set to at least two output channels of a higher layer;
routing the at least one second PDU set and the at least one third PDU set to one output channel of a higher layer;
deleting or feeding back deletion of at least one of the at least one second PDU set and the at least one third PDU set;
feeding back retransmission of at least one of the at least one second PDU set and the at least one third PDU set; or
feeding back transmission states of the at least one second PDU set and the at least one third PDU set, or feeding back a transmission state of at least one of the at least one second PDU set or the at least one third PDU set.

In some embodiments, the integration process is performed in the case that the first relationship between the second PDU set and the third PDU set includes the association relationship or the priority relationship or the integration process relationship. In some embodiments, the differentiation process is performed in the case that the first relationship between the second PDU set and the third PDU set includes the dependency relationship or the differentiation process relationship or the priority relationship.

In some embodiments, the integration process includes routing the at least one second PDU set and the at least one third PDU set to one output channel of the higher layer; and the differentiation process includes routing the at least one second PDU set and the at least one third PDU set to at least two different output channels of the higher layer.

In the case that the receiver differentiates the input channels of the at least one second PDU set and the at least one third PDU set, with respect to a situation where the at least one second PDU set and the at least one third PDU set come from the same input channel, the integration process or the differentiation process includes at least one of:
identifying the at least one second PDU set and the at least one third PDU set;
rearranging a transmission order of the at least one second PDU set and the at least one third PDU set;
reordering the at least one second PDU set and the at least one third PDU set from the same input channel of a lower layer;
routing the at least one second PDU set and the at least one third PDU set to at least two output channels of a higher layer;
routing the at least one second PDU set and the at least one third PDU set to one output channel of a higher layer;
deleting or feeding back deletion of at least one of the at least one second PDU set and the at least one third PDU set;
feeding back retransmission of at least one of the at least one second PDU set and the at least one third PDU set; and
feeding back transmission states of the at least one second PDU set and the at least one third PDU set, or feeding back a transmission state of at least one of the at least one second PDU set or the at least one third PDU set.

Alternatively, in the case that the receiver differentiates whether one or more input channels of the at least one second PDU set and the at least one third PDU set are present (in some PDU sessions or applications or QoS flows, the at least one second PDU set and the at least one third PDU set are differentiated as coming from the same input channel, and in other PDU sessions or applications or QoS flows, the at least one second PDU set and the at least one third PDU set are not differentiated as coming from the same input channel), the integration process or the differentiation process includes at least one of:
identifying the at least one second PDU set and the at least one third PDU set;
rearranging a transmission order of the at least one second PDU set and the at least one third PDU set;
reordering the at least one second PDU set and the at least one third PDU set from the same input channel of a lower layer;
routing the at least one second PDU set and the at least one third PDU set to at least two output channels of a higher layer;
routing the at least one second PDU set and the at least one third PDU set to one output channel of a higher layer;
deleting or feeding back deletion of at least one of the at least one second PDU set and the at least one third PDU set;
feeding back retransmission of at least one of the at least one second PDU set and the at least one third PDU set; and
feeding back transmission states of the at least one second PDU set and the at least one third PDU set, or feeding back a transmission state of at least one of the at least one second PDU set or the at least one third PDU set.

Alternatively, in the case that the receiver differentiates the at least one second PDU set and the at least one third PDU set being transmitted to different output channels, the integration process or the differentiation process includes at least one of:
identifying the at least one second PDU set and the at least one third PDU set;
rearranging a transmission order of the at least one second PDU set and the at least one third PDU set;
reordering the at least one second PDU set and the at least one third PDU set from the same input channel of a lower layer;
routing the at least one second PDU set and the at least one third PDU set to at least two output channels of a higher layer;
routing the at least one second PDU set and the at least one third PDU set to one output channel of a higher layer;
deleting or feeding back deletion of at least one of the at least one second PDU set and the at least one third PDU set;
feeding back retransmission of at least one of the at least one second PDU set and the at least one third PDU set; and
feeding back transmission states of the at least one second PDU set and the at least one third PDU set, or feeding back a transmission state of at least one of the at least one second PDU set or the at least one third PDU set.

Alternatively, in the case that the receiver differentiates the at least one second PDU set and the at least one third PDU set being transmitted to the same output channel or different output channels, the integration process or the differentiation process includes at least one of:
identifying the at least one second PDU set and the at least one third PDU set;
rearranging a transmission order of the at least one second PDU set and the at least one third PDU set;
reordering the at least one second PDU set and the at least one third PDU set from the same input channel of a lower layer;
routing the at least one second PDU set and the at least one third PDU set to at least two output channels of a higher layer;
routing the at least one second PDU set and the at least one third PDU set to one output channel of a higher layer;
deleting or feeding back deletion of at least one of the at least one second PDU set and the at least one third PDU set;
feeding back retransmission of at least one of the at least one second PDU set and the at least one third PDU set; and
feeding back transmission states of the at least one second PDU set and the at least one third PDU set, or feeding back a transmission state of at least one of the at least one second PDU set or the at least one third PDU set.

In some embodiments, the integration process is performed in the case that the first relationship between the second PDU set and the third PDU set includes the association relationship or the priority relationship or the integration process relationship. In some embodiments, the differentiation process is performed in the case that the first relationship between the second PDU set and the third PDU set includes the dependency relationship or the differentiation process relationship or the priority relationship.

In some embodiments, the integration process includes routing the at least one second PDU set and the at least one third PDU set to one output channel of the higher layer; and the differentiation process includes routing the at least one second PDU set and the at least one third PDU set to at least two different output channels of the higher layer.

In summary, by describing details of the integration process or the differentiation process, a method for specifically improving the data processing efficiency is further provided.

Hereinafter, the function of the new target protocol layer introduced into the AS and addition of a new target function to the AS protocol layer are described with reference to FIGS. 7 to 17.

FIG. 7 illustrates the function of the target protocol layer in the case that the input channels of the at least two PDUs in the first PDU set (or the input channels of the at least one second PDU set and the at least one third PDU set) are not differentiated. In this case, the left part of FIG. 7 illustrates the function of the target protocol layer in the case that the UE serves as the transmitter, and the right part of FIG. 7 illustrates the function of the target protocol layer in the case that the UE serves as the receiver.

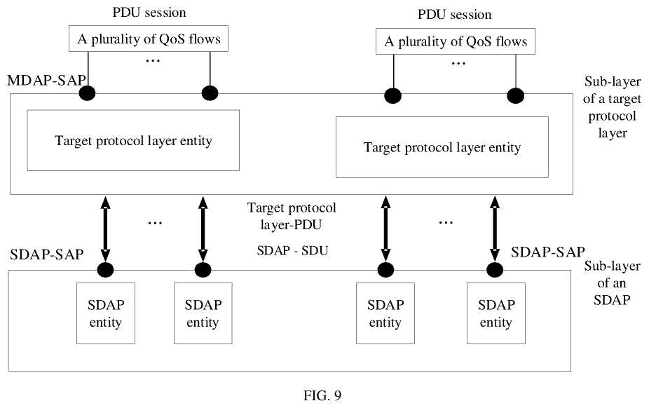

FIG. 8 illustrates a plurality of QoS flows corresponding to one target protocol layer entity. FIG. 9 illustrates a plurality of QoS flows corresponding to a plurality of target protocol layer entities.

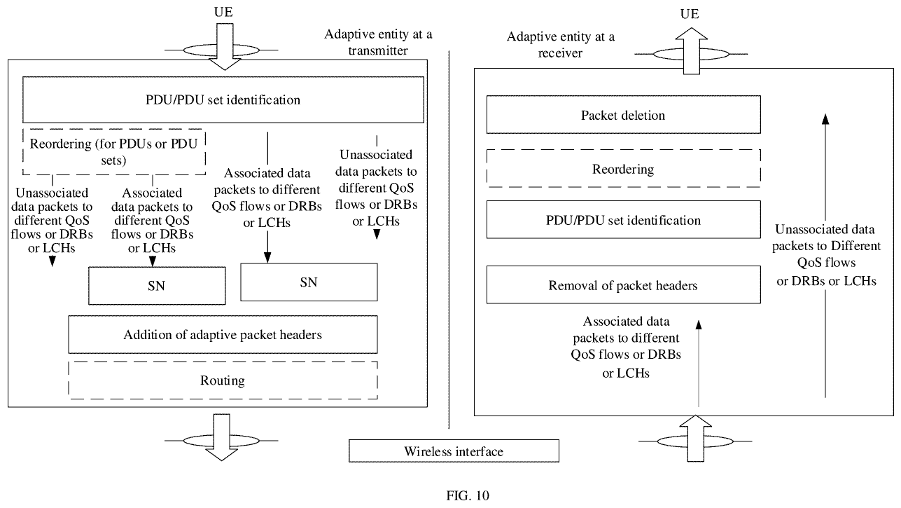

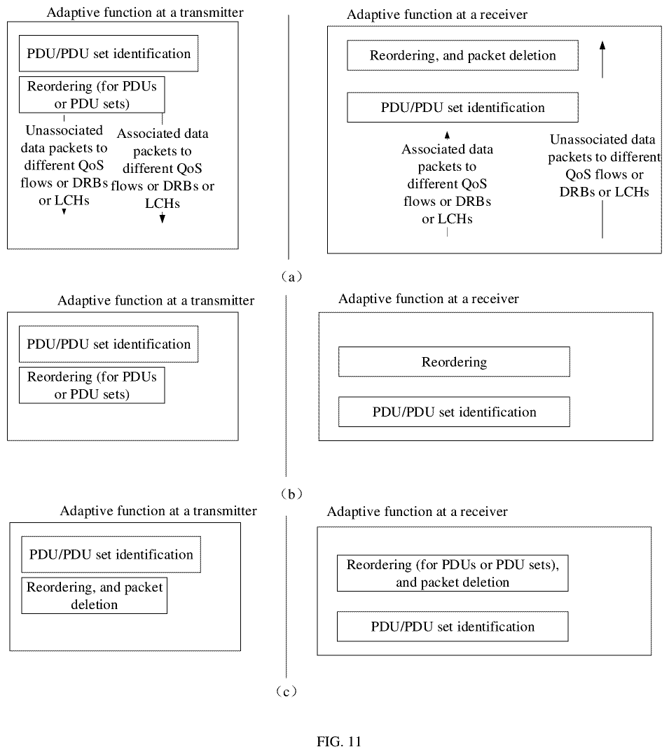

FIG. 10 illustrates a function of a new target protocol layer according to some embodiments. No SN is added to unassociated data packets to different QoS flows or different DRBs or different LCHs. SNs are added to associated data packets to different QoS flows or different DRBs or different LCHs. FIG. 10 further illustrates that the target protocol layer may further have a function of reordering.

FIG. 11 illustrates addition of a new target function to an AS protocol layer according to some embodiments.

Part (a) of FIG. 11 illustrates that the target function includes PDU identification (PDU set identification), reordering, and packet deletion. Part (b) of FIG. 11 illustrates that the target function includes PDU identification (PDU set identification) and reordering. Part (c) of FIG. 11 illustrates that the target function includes PDU identification (PDU set identification), reordering, and packet deletion. The target function illustrated in FIG. 11 is exemplary only. The specific contents of the target function have been listed above.

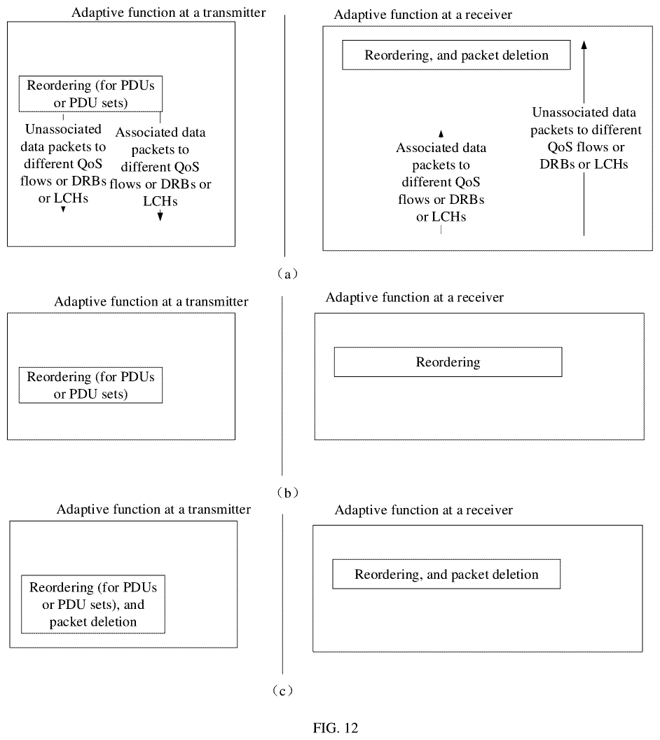

Part (a) of FIG. 12 illustrates that the target function includes reordering and packet deletion. Part (b) of FIG. 12 illustrates that the target function includes reordering. Part (c) of FIG. 12 illustrates that the target function includes reordering and packet deletion.

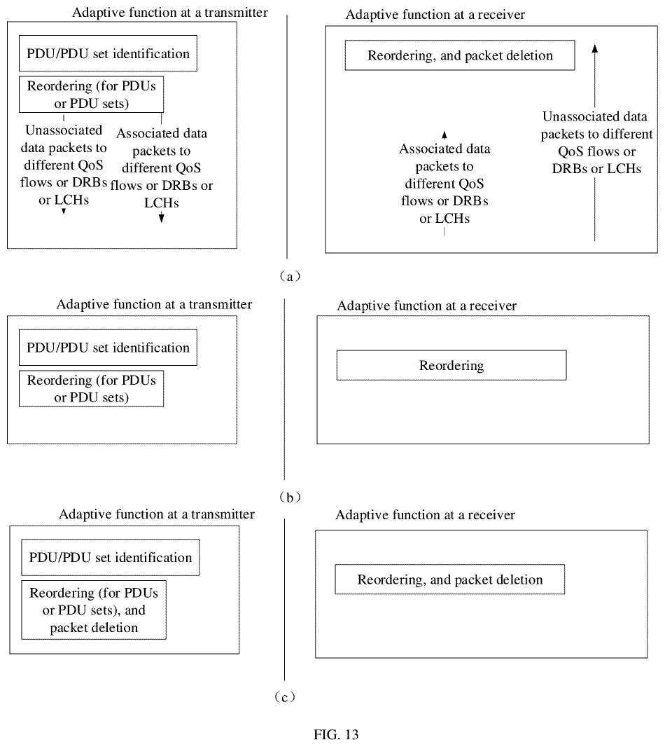

Part (a) of FIG. 13 illustrates that the target function includes PDU identification (PDU set identification) and reordering. Part (b) of FIG. 13 illustrates that the target function includes PDU identification (PDU set identification) and reordering. Part (c) of FIG. 13 illustrates that the target function includes PDU identification (PDU set identification), reordering, and packet deletion.

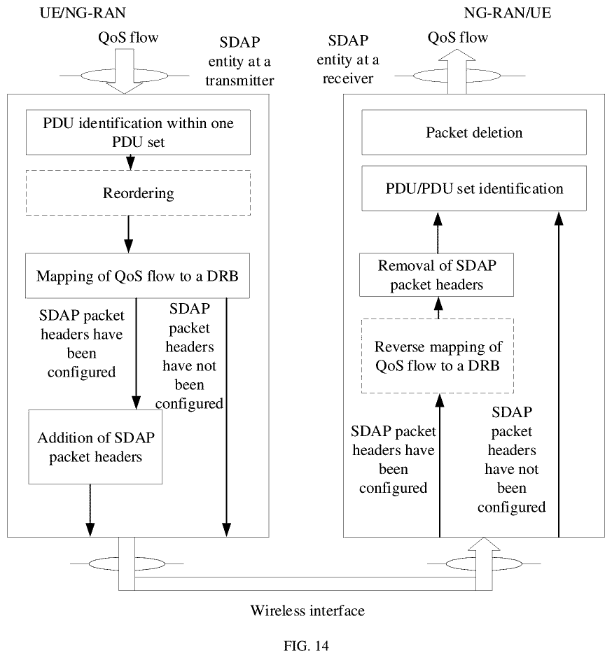

FIG. 14 illustrates addition of a new target function to an AS protocol layer according to some embodiments. FIG. 14 illustrates addition of the new target function corresponding to a QoS flow to an SDAP layer in the case that the AS protocol layer is the SDAP layer.

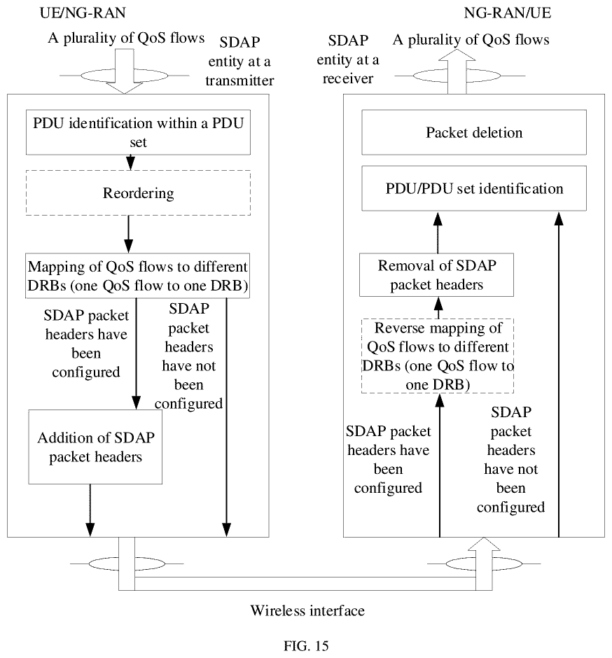

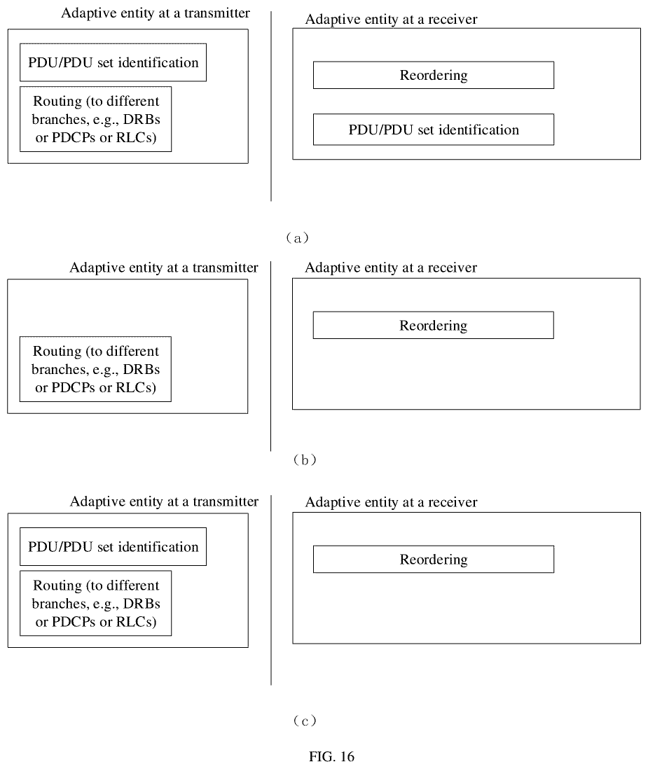

FIG. 15 illustrates addition of a new target function to an AS protocol layer according to some embodiments. FIG. 15 illustrates addition of the new target function corresponding to a plurality of QoS flows to an SDAP layer in the case that the AS protocol layer is the SDAP layer.

FIG. 16 illustrates addition of a new target function to an AS protocol layer according to some embodiments. Part (a) of FIG. 16 illustrates that the target function includes PDU identification (PDU set identification), reordering, and routing. Part (b) of FIG. 16 illustrates that the target function includes routing and reordering. Part (c) of FIG. 16 illustrates that the target function includes PDU identification (PDU set identification), reordering, and routing.

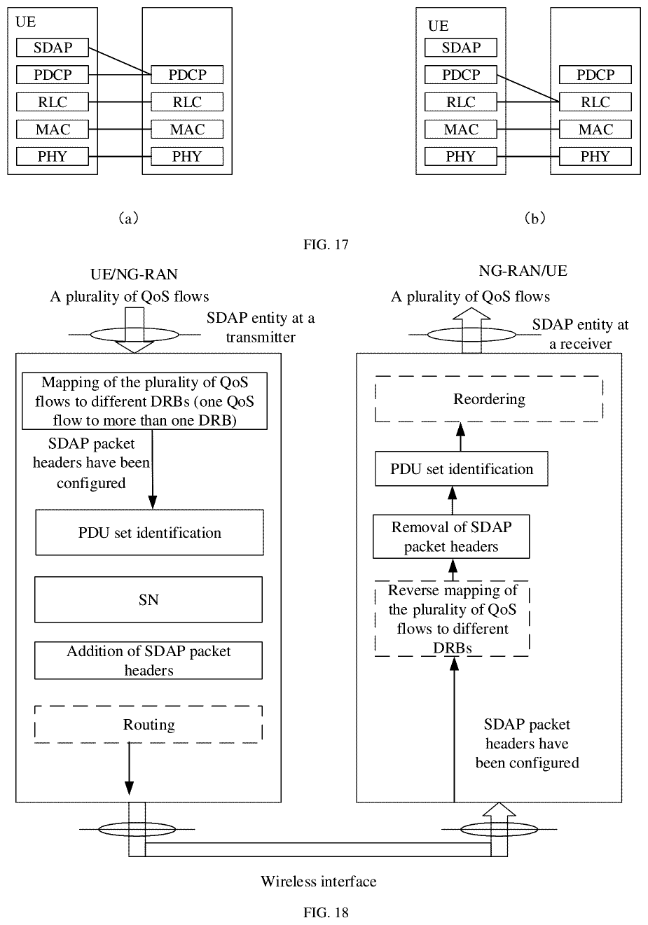

Part (a) of FIG. 17 illustrates that a function is added to an SDAP layer, and that a transmitter routes different types of PDU sets to different PDCP layers/DRBs, and part (b) of FIG. 17 illustrates that a function is added to a PDCP layer, and that a transmitter routes different types of PDU sets to different RLC layers.

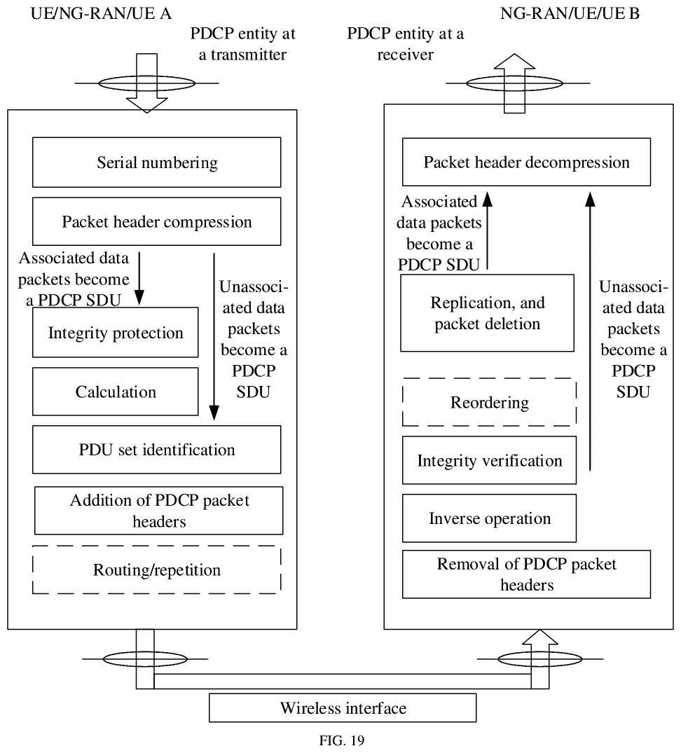

FIG. 18 illustrates an example where a target function is added to an SDAP layer. FIG. 19 illustrates an example where a target function is added to a PDCP layer.

The above embodiments have described in detail the modes in which the transmitter and the receiver perform the integration process or the differentiation process based on the PDU set. Hereinafter, the description explains that the transmitter and the receiver receive first information prior to performing the integration process or the differentiation process, wherein the first information is configured to instruct the transmitter or the receiver to perform the integration process or the differentiation process based on the PDU set.

First, reception of the first information based on first data is described.

The transmitter or the receiver receives the first information, wherein the first information is configured to determine at least one of:
at least two different pieces of data in the first data having a first relationship;
whether to perform the integration process or the differentiation process; or
data for the integration process or the differentiation process.

The first relationship includes at least one of: an association relationship, a dependency/dependence relationship, a priority relationship, an integration process relationship, or a differentiation process relationship.

In some embodiments, the first information includes at least one of: first indication information, an input channel, packet header information, a dedicated indication, or first packet indication information (also referred to as specific packet indication information).

In some embodiments, the first indication information is configured to instruct the first communication device serving as the transmitter or the second communication device serving as the receiver to perform the integration process or the differentiation process. In some embodiments, the first communication device serving as the transmitter includes any one of a terminal, an access network element, or a core network element. In some embodiments, the second communication device serving as the receiver includes any one of a terminal, an access network element, or a core network element. In some embodiments, the first indication information is from an access network element or a core network element.

In some embodiments, the packet header information is configured to determine at least one of: a type of first target data, an ID of first target data, a priority of first target data, a determination of presence of data of the first relationship with first target data, data of the first relationship with first target data, or data for the integration process or the differentiation process with first target data, wherein the first target data is any one of the at least two different pieces of data in the first data.

In some embodiments, the dedicated indication is configured to determine at least one of: data of the first relationship with first target data, or data for the integration process or the differentiation process with first target data, wherein the first target data is any one of the at least two different pieces of data in the first data.

In some embodiments, the first packet indication information is configured to determine at least one of: data of the first relationship with first target data, or data for the integration process or the differentiation process with first target data, wherein the first target data is any one of the at least two different pieces of data in the first data.

It should be noted that the at least two different pieces of data in the first data may be replaced by at least two PDUs in the first PDU set; and then, based on the first information, at least one of the following may be determined:
at least two PDUs in the first PDU set having the first relationship;
whether to perform the integration process or the differentiation process; or
at least two PDUs in the first PDU set for the integration process or the differentiation process.

In some embodiments, the at least two PDUs in the first PDU set are from different input channels.

In some embodiments, the different input channels include different QoS flows. Then, the first information includes first target information, wherein the first target information includes at least one of: an association relationship between different QoS flows (e.g., the association relationship between different QoS flows are determined based on identifiers of the QoS flows, and/or QoS parameters of the QoS flows, and/or PDU/frame types corresponding to the QoS flows); PDU information of at least two PDUs in first PDU sets in different QoS flows; or SNs of at least two PDUs in the first PDU set being the same or consecutive.

In some embodiments, the different input channels include different protocol layers. Then, the first information includes second target information, wherein the second target information includes at least one of: an association relationship between different protocol layers; PDU information of at least two PDUs in first PDU sets in different protocol layers; or SNs of at least two PDUs in the first PDU set being the same or consecutive.

The association relationship between different protocol layers may be understood as, for example: an association relationship between an SDAP entity 1 and an SDAP entity 2, an association relationship between a PDCP entity 1 and a PDCP entity 2, or an association relationship between an LCH 1 and an LCH 2. In some embodiments, the association relationship between different protocol layers is pre-configured by a base station, or configured by a network device, or selected by a terminal.

In some embodiments, the at least two PDUs in the first PDU set are from the same input channel.

In some embodiments, the same input channel includes a first QoS flow. Then, the first information includes third target information, wherein the third target information includes at least one of: an association relationship between the first QoS flow and at least one second QoS flow (e.g., the association relationship between the first QoS flow and the at least one second QoS flow is determined based on identifiers of the QoS flows, and/or QoS parameters of the QoS flows, and/or PDU/frame types corresponding to the QoS flows); SNs of at least two PDUs in the first PDU set being the same or consecutive; at least two PDUs in the first PDU set being present between two END identifiers; or at least two PDUs in the first PDU set being present between two START identifiers.

In some embodiments, the same input channel includes a first protocol layer. Then, the first information includes fourth target information, wherein the fourth target information includes at least one of: a mapping relationship between at least one second protocol layer and the first protocol layer; SNs of at least two PDUs in the first PDU set being the same or consecutive; at least two PDUs in the first PDU set being present between two END identifiers; at least two PDUs in the first PDU set being present between two end control packets; at least two PDUs in the first PDU set being present between two START identifiers; at least two PDUs in the first PDU set being present between two START control packets; at least two PDUs in the first PDU set being present between a start identifier and an end identifier; or at least two PDUs in the first PDU set being present between a start packet and an end packet.

Next, reception of second information based on the first data is described.

The transmitter or the receiver determines, based on the second information, at least one of:
different pieces of first data having the first relationship;
whether to perform the integration process or the differentiation process; or
different pieces of first data for the integration process or the differentiation process.

The first relationship includes at least one of: an association relationship, a dependency/dependence relationship, a priority relationship, an integration process relationship, or a differentiation process relationship.

In some embodiments, the second information includes at least one of: second indication information, an input channel, packet header information, a dedicated indication, or second packet indication information (also referred to as specific packet indication information).

In some embodiments, the second indication information is configured to instruct the first communication device serving as the transmitter or the second communication device serving as the receiver to perform the integration process or the differentiation process. In some embodiments, the first communication device includes any one of a terminal, an access network element, or a core network element. In some embodiments, the second communication device includes any one of a terminal, an access network element, or a core network element. In some embodiments, the second indication information is from an access network element or a core network element.

In some embodiments, the packet header information is configured to determine at least one of: a type of second target data; an ID of second target data; a priority of second target data; a determination of presence of data of the first relationship with second target data; data of the first relationship with second target data; or data for the integration process or the differentiation process with second target data, wherein the second target data is any one of different pieces of first data.

In some embodiments, the dedicated indication is configured to determine at least one of: data of the first relationship with second target data; or data for the integration process or the differentiation process with second target data, wherein the second target data is any one of different pieces of first data.

In some embodiments, the second packet indication information is configured to determine at least one of: data of the first relationship with second target data; or data for the integration process or the differentiation process with second target data, wherein the second target data is any one of different pieces of first data.

It should be noted that the different pieces of first data may be replaced by at least one second PDU set and at least one third PDU set; and then, based on the second information, at least one of the following can be determined: at least one second PDU set and at least one third PDU set having the first relationship; whether to perform the integration process or the differentiation process; or at least one second PDU set and at least one third PDU set for the integration process or the differentiation process.

In some embodiments, the at least one second PDU set and the at least one third PDU set are from different input channels.

In some embodiments, the different input channels include different QoS flows. Then, the second information includes fifth target information. The fifth target information includes at least one of: an association relationships between different QoS flows (e.g., the association relationship between different QoS flows is determined based on identifiers of the QoS flows, and/or QoS parameters of the QoS flows, and/or PDU/frame types corresponding to the QoS flows); PDU information of second PDU sets and third PDU sets in different QoS flows; or SNs of the second PDU set and the third PDU set (e.g., at least two of start numbers of SN numbers, the number of SN numbers, or end numbers of SN numbers in the I-frame and the P-frame being depended) being the same or consecutive.

In some embodiments, the different input channels include different protocol layers. Then, the second information includes sixth target information. The sixth target information includes at least one of: an association relationship between different protocol layers; PDU information of second PDU sets and third PDU sets in different protocol layers; or SNs of the second PDU set and the third PDU set (e.g., at least two of start numbers of SN numbers, the number of SN numbers, or end numbers of SN numbers in the I-frame and the P-frame being depended) being the same or consecutive.

The association relationship between different protocol layers may be understood as, for example: an association relationship between an SDAP entity 1 and an SDAP entity 2, an association relationship between a PDCP entity 1 and a PDCP entity 2, or an association relationship between an LCH 1 and an LCH 2. In some embodiments, the association relationship between different protocol layers is pre-configured by a base station, or configured by a network device, or selected by a terminal.

In some embodiments, the at least one second PDU set and the at least one third PDU set are from the same input channel.

In some embodiments, the same input channel includes a third QoS flow. The second information includes seventh target information. The seventh target information includes at least one of: an association relationship between the third QoS flow and at least one fourth QoS flow (e.g., the association relationship between the third QoS flow and the at least one fourth QoS flow is determined based on identifiers of the QoS flows, and/or QoS parameters of the QoS flows, and/or PDU/frame types corresponding to the QoS flows); SNs of at least one second PDU set and at least one third PDU set (e.g., at least two of start numbers of SN numbers, the number of SN numbers, or end numbers of SN numbers in the I-frame and the P-frame being depended) being the same or consecutive; at least one second PDU set and at least one third PDU set being present between two END identifiers; or at least one second PDU set and at least one third PDU set being present between two START identifiers.

In some embodiments, the same input channel includes a third protocol layer. The second information includes eighth target information. The eighth target information includes at least one of: a mapping relationship between at least one fourth protocol layer and the third protocol layer; SNs of the second PDU set and the third PDU set (e.g., at least two of start numbers of SN numbers, the number of SN numbers, or end numbers of SN numbers in the I-frame and the P-frame being depended) being the same or consecutive; the second PDU set and the third PDU set being present between two END identifiers; at least one second PDU set and at least one third PDU set being present between two end control packets; the second PDU set and the third PDU set being present between two START identifiers; at least one second PDU set and at least one third PDU set being present between two start control packets; at least one second PDU set and at least one third PDU set being present between a start identifier and an end identifier; or at least one second PDU set and at least one third PDU set being present between a start packet and an end packet.

In summary, the foregoing description provides to indicate to perform the integration process or the differentiation process based on the first information, and to indicate to perform the integration process or the differentiation process based on the second information, such that the problem of how to determine to perform the integration process or the differentiation process is solved.

The function of the target protocol layer introduced into the access stratum (AS) or the new target function added to the AS protocol layer has been fully described above. Hereinafter, contents related to configuration of the target protocol layer and configuration of the target function will be described.

With respect to the target protocol layer:

In some embodiments, the access network element configures a relevant configuration of the target protocol layer.

In some embodiments, the relevant configuration of the target protocol layer includes at least one of: a configuration based on each UE; a configuration based on each QoS flow; a configuration based on each PDU session; a configuration based on each MAC layer; a configuration based on each DRB; a configuration based on each LCH; or a configuration based on each PDCP layer.

In some embodiments, based on the relevant configuration of the target protocol layer, the terminal configures the target protocol layer, and/or performs a relevant operation of the target protocol layer.

In some embodiments, based on the relevant configuration of the target protocol layer, configuring the target protocol layer and/or performing the relevant operation of the target protocol layer includes at least one of:
using the target protocol layer and/or the function of the target protocol layer in response to receiving configuration information of the target protocol layer;
configuring the target protocol layer and/or the function of the target protocol layer in response to receiving configuration information of the target protocol layer;
using the target protocol layer and/or the function of the target protocol layer in response to receiving activation indication information from a network device and the target protocol layer being activated;
configuring the target protocol layer and/or the function of the target protocol layer in response to receiving activation indication information from a network device and the target protocol layer being activated;
resuming the target protocol layer and/or the function of the target protocol layer in response to receiving activation indication information from a network device and the target protocol layer being activated;
not using the target protocol layer and/or the function of the target protocol layer in response to receiving deactivation indication information from a network device and the target protocol layer being deactivated;
de-configuring the target protocol layer and/or the function of the target protocol layer in response to receiving deactivation indication information from a network device and the target protocol layer being deactivated; or
suspending the target protocol layer and/or the function of the target protocol layer in response to receiving deactivation indication information from a network device and the target protocol layer being deactivated.

In some embodiments, a data packet is cached in the case that the activated or deactivated state of the target protocol layer is changed.

Alternatively, a packet that has not been transmitted before a change is deleted in the case that the activated or deactivated state of the target function is changed.

Alternatively, a packet that has not been successfully transmitted is deleted in the case that the activated or deactivated state of the target function is changed.

With respect to the target function of the AS protocol layer:

In some embodiments, the access network element configures a relevant configuration of the target function.

In some embodiments, the relevant configuration of the target function is configured in at least one of: a PDCP configuration; an RLC configuration; an SDAP configuration; a DRB configuration; or a MAC configuration.

In some embodiments, based on the relevant configuration of the target function, the terminal configures the target function, and/or performs a relevant operation of the target function.

In some embodiments, based on the relevant configuration of the target function, configuring the target function and/or performing the relevant operation of the target function includes at least one of:
activating the target function at the AS protocol layer in response to receiving configuration information of the target function;
using the target function at the AS protocol layer in response to receiving configuration information of the target function;
configuring the target function at the AS protocol layer in response to receiving configuration information of the target function;
activating the target function at the AS protocol layer in response to receiving activation indication information from a network device and the target function being activated;
using the target function at the AS protocol layer in response to receiving activation indication information from a network device and the target function being activated;
configuring the target function at the AS protocol layer in response to receiving activation indication information from a network device and the target function being activated;
deactivating the target function at the AS protocol layer in response to receiving deactivation indication information from a network device and the target function being deactivated;
not using the target function at the AS protocol layer in response to receiving deactivation indication information from a network device and the target function being deactivated; or
de-configuring the target function at the AS protocol layer in response to receiving deactivation indication information from a network device and the target function being deactivated.

In some embodiments, a data packet is cached in the case that the activated or deactivated state of the target function is changed.

Alternatively, a packet that has not been transmitted before a change is deleted in the case that the activated or deactivated state of the target function is changed.

Alternatively, a packet that has not been successfully transmitted is deleted in the case that the activated or deactivated state of the target function is changed.

In summary, by describing the details of configuring the target protocol layer or the target function of the AS protocol layer, the problem of how to configure the target protocol layer or the target function of the AS protocol layer is solved.

It should be noted that in the above description, the method is applied to the access stratum (AS) for convenience of description, but all the embodiments of the present disclosure are still applicable to a non-access stratum (NAS).

In the case that the method is applied to the access stratum (AS), the first communication device serving as the transmitter includes the terminal and the access network element (base station). The second communication device serving as the receiver includes the access network element (base station) and the terminal.

In the case that the method is applied to the non-access stratum (NAS), the first communication device serving as the transmitter includes the terminal and the core network element. The second communication device serving as the receiver includes the core network element and the terminal.

Accordingly, the core network element implements the above actions of the access network element, wherein the actions include but not limited to configuring, activating, deactivating, using, and de-configuring the target protocol layer (or the target function), not using the relevant configuration of the target function and the relevant configuration/function of the core network element, etc.

In some embodiments, the core network element is a UPF or an SMF.

In the above description, the related contents of performing the integration process or the differentiation process in the target protocol layer (or the target function of the AS protocol layer), the related contents of indicating the target protocol layer (or the target function of the AS protocol layer) to perform the integration process or the differentiation process based on the first information (or the second information), and the related contents of configuring the target protocol layer (or the target function of the AS protocol layer) have been fully described.

Hereinafter, a detailed description will be given again regarding the influence of a mapping relationship between the input channel and the output channel on the integration process or the differentiation process. Different PDUs in the first PDU set (or the second PDU set and the third PDU set) may enter the target protocol layer (or the AS protocol layer) over the same input channel, or may enter the target protocol layer (or the AS protocol layer) over different input channels. Different PDUs in the first PDU set (or the second PDU set and the third PDU set) may leave the target protocol layer (or the AS protocol layer) over the same output channel, or may leave the target protocol layer (or the AS protocol layer) over different output channels.

For convenience of discussion, in the following embodiments, a path or an entity of the second PDU set and the third PDU set during data transmission, and the integration process or the differentiation process corresponding to the path will be described by way of example.

It should be noted that the following embodiments are also applicable to a scenario of different PDUs in a single PDU set. Accordingly, it is possible to replace the second PDU set and the third PDU set with a portion of PDUs in the first PDU set and another portion of PDUs in the first PDU set.
1. One QoS flow corresponds to the second PDU set and the third PDU set.
1.1. One QoS flow corresponds to one SDAP layer, one DRB, one PDCP layer, and one RLC layer. The integration process or the differentiation process is performed based on the target function in the SDAP layer.
1.1.1. The integration process or the differentiation process includes: identification and/or reordering.

With respect to the transmitter, the SDAP layer or the PDCP layer or the RLC layer identifies the second PDU set and the third PDU set, and/or reorders the second PDU set and the third PDU set (assuming that the second PDU set and the third PDU set are not delivered to the SDAP layer or the PDCP layer or the RLC layer in order from a higher layer).

With respect to the receiver, the SDAP layer or the PDCP layer or the RLC layer receives the second PDU set and the third PDU set from a lower layer, and delivers the second PDU set and the third PDU set to a higher layer.

In some embodiments, the base station configures the terminal, and/or the core network configures the base station, including at least one of: a mapping relationship between the QoS flow and the SDAP/DRB/PDCP/RLC layer, whether to perform PDU set identification, or reordering operations.
1.1.2. The integration process or the differentiation process includes: identification and/or packet deletion.

With respect to the transmitter, the SDAP layer or the PDCP layer or the RLC layer identifies the second PDU set and the third PDU set. Alternatively, in the case that the second PDU set and the third PDU set have the first relationship, and in the case that a portion of the PDU sets is lost or does not satisfy a PDB of the PDU sets, or the PDU sets do not satisfy a PDB of the associated PDU sets, the transmitter performs packet deletion, and/or the transmitter indicates a lower layer of a current layer (corresponding to an SDU of the current layer) to perform the packet deletion. The packet deletion includes: deleting PDUs or data packets in the PDU sets that satisfy the first relationship.

With respect to the receiver, the SDAP layer or the PDCP layer or the RLC layer receives lower-layer data and delivers the lower-layer data to the higher layer. Further, the SDAP layer or the PDCP layer or the RLC layer identifies the second PDU set and the third PDU set. In the case that the second PDU set and the third PDU set have the first relationship, and in the case that a portion of the PDU sets is lost or does not satisfy a PDB of the PDU sets, or the PDU sets satisfying the first relationship do not satisfy a PDB of the associated PDU sets, the receiver performs packet deletion, and/or the receiver indicates a lower layer of a current layer (corresponding to an SDU of the current layer) to perform the packet deletion. The packet deletion includes: deleting PDUs or data packets in the PDU sets that satisfy the first relationship. Further, the current layer may feed back NACK to a peer terminal.

In some embodiments: the base station configures the terminal, and/or the core network configures the base station, including at least one of: a mapping relationship between the QoS flow and the SDAP layer or the DRB or the PDCP layer or the RLC layer, whether to perform PDU set identification, packet deletion, or feedback operations.
1.1.3. The solutions of 1.1.1 and 1.1.2 are used in combination.

With respect to the transmitter, the SDAP layer or the PDCP layer or the RLC layer identifies the second PDU set and the third PDU set, and reorders the second PDU set and the third PDU set (assuming that the second PDU set and the third PDU set are not delivered to the SDAP layer or the PDCP layer or the RLC layer in order from a higher layer). Further, the transmitter may perform a packet deletion operation.

With respect to the receiver, the SDAP layer or the PDCP layer or the RLC layer receives lower-layer data and delivers the lower-layer data to the higher layer. Further, the receiver performs a packet deletion operation and/or a feedback operation.

In some embodiments: the base station configures the terminal, and/or the core network configures the base station, including at least one of: a mapping relationship between the QoS flow and the SDAP layer or the DRB or the PDCP layer or the RLC layer (e.g., configured in an SDAP configuration, a PDCP configuration, or an RLC configuration), whether to perform PDU set identification, reordering, packet deletion, or feedback operations.
1.2. One QoS flow corresponds to one SDAP layer, one SDAP layer corresponds to a plurality of DRBs or a plurality of PDCP layers, and different DRB/PDCP layers transmit or route different PDU sets.
1.2.1. The integration process or the differentiation process includes: identification and/or reordering (reordering by the transmitter).

With respect to the transmitter, the SDAP layer or the PDCP layer identifies different PDU sets, and/or reorders different PDU sets (assuming that the different PDU sets are not delivered in order from a higher layer to a current layer, or to an AS layer).

With respect to the receiver, the SDAP layer or the PDCP layer or the RLC layer receives lower-layer data and delivers the lower-layer data to the higher layer.

In some embodiments: the base station configures the UE, and/or the core network configures the base station, including at least one of: a mapping relationship between the QoS flow and the SDAP/DRB/PDCP/RLC layer, whether to perform PDU set identification, or reordering operations.

In some embodiments, the network configures the UE, an association relationship between the SDAP layer and a plurality of DRB/PDCP layers (e.g., in SDAP-config), and/or configures information of a PDU set (e.g., a type of the PDU set) corresponding to each DRB/PDCP layer (e.g., in PDCP-config).
1.2.2. The integration process or the differentiation process includes: identification and/or reordering (reordering by the receiver).

With respect to the transmitter, for example, the SDAP layer identifies different PDU sets. Alternatively, the transmitter generates corresponding data packets (SDAP PDUs) for each PDU set, and adds serial numbers to packet headers of the corresponding SDAP PDUs, wherein the serial numbers are configured such that in the case that the receiver acquires data packets corresponding to SDAP layers from different DRBs or PDCP layers, the receiver is capable of performing reordering. Alternatively, the transmitter adds control information, such as an SDAP control PDU, between one or more corresponding data packets (SDAP PDUs) generated for each PDU set (e.g., adds the control information, such as the SDAP control PDU, before or after a plurality of data packets in the current PDU set). The control information or the SDAP control PDU includes at least one of: a start marker, an end marker, a lower-layer path to which a current data packet is delivered, a lower-layer path to which a next data packet is delivered, a lower-layer path to which a previous data packet is delivered, a bitmap indication of lower-layer paths to which a current data packet and an adjacent data packet are delivered, a serial number of current control information or control PDU, an identifier of current control information or control PDU, data packets that are delivered to different paths (e.g., indicated by a bitmap), paths to which a plurality of data packets between start markers are delivered, paths to which a plurality of data packets between end markers are delivered, a path to which a data packet corresponding to a serial number of current control information or control PDU is delivered, paths to which a plurality of data packets corresponding to a serial number of current control information or control PDU are delivered, a path to which a data packet corresponding to an identifier number of current control information or control PDU is delivered, and paths to which a plurality of data packets corresponding to an identifier number of current control information or control PDU are delivered. In some embodiments, the identification information of the control information or the control PDU represents a position of the control information or the control PDU in order of information. In some embodiments, with respect to a plurality of output paths, each piece of generated control information, such as the control PDU, is transmitted to all the paths. Alternatively, each piece of generated control information, such as the control PDU, is transmitted to only one of all the paths (e.g., to a main path, or to a default path, or to a pre-configured path). The control information or the control PDU is configured such that in the case that the receiver acquires SDAP data PDUs corresponding to the control information or the control PDU (data packets corresponding to the PDU set) from different DRBs or PDCP layers, the receiver is capable of performing reordering.

In some embodiments, before the above processes, the transmitter reorders different PDU sets (assuming that the different PDU sets are not delivered in order from the higher layer to the current layer, or to the AS protocol layer).

With respect to the receiver, for example, the SDAP layer or the PDCP layer or the RLC layer receives lower-layer data and performs reordering. For example, with respect to the receiver, the SDAP layer or the PDCP layer or the RLC layer receives the lower-layer data, and reorders PDU sets from different DRBs or PDCP layers based on SN numbers, or SDAP packet header information, or control information, such as the SDAP control PDU. Upon reordering, the receiver delivers the lower-layer data to the higher layer.

In some embodiments: the base station configures the terminal, and/or the core network configures the base station, including at least one of: a mapping relationship between the QoS flow and the SDAP layer or the DRB or the PDCP layer or the RLC layer, whether to perform PDU set identification, or reordering operations.

In some embodiments: the base station configures the terminal, and/or the core network configures the base station, including at least one of: a mapping relationship between the QoS flow and the SDAP layer, whether to perform PDU set identification, or reordering operations.

In some embodiments, the network device configures the terminal, an association relationship between the SDAP layer and a plurality of DRBs or PDCP layers (e.g., in an SDAP configuration), and/or configures information of a PDU set (e.g., a type of the PDU set) corresponding to each DRB or PDCP layer (e.g., in a PDCP configuration).
1.2.3. The integration process or the differentiation process includes: identification and/or packet deletion.

With respect to the transmitter, the SDAP layer or the PDCP layer identifies different PDU sets. Alternatively, in the case that the different PDU sets have the first relationship, and in the case that a portion of the PDU sets is lost or does not satisfy a PDB of the PDU sets, or the PDU sets satisfying the first relationship do not satisfy a PDB of the associated PDU sets, the transmitter performs packet deletion, and/or the transmitter indicates a lower layer of a current layer (corresponding to an SDU of the current layer) to perform the packet deletion. The packet deletion includes: deleting PDUs or data packets in the PDU sets that satisfy the first relationship.

With respect to the receiver, the SDAP layer or the PDCP layer receives lower-layer data and delivers the lower-layer data to the higher layer. Further, with respect to the receiver, the SDAP layer or the PDCP layer identifies different PDU sets. In the case that the different PDU sets have the first relationship, and in the case that a portion of the PDU sets is lost or does not satisfy a PDB of the PDU sets, or the PDU sets satisfying the first relationship do not satisfy a PDB of the associated PDU sets, and then the receiver performs packet deletion, and/or indicates a lower layer of a current layer (corresponding to an SDU of the current layer) to perform the packet deletion. The packet deletion includes: deleting PDUs or data packets in the PDU sets that satisfy the first relationship. Further, the current layer may feed back NACK to a peer terminal.

In some embodiments: the base station configures the terminal, and/or the core network configures the base station, including at least one of: a mapping relationship between the QoS flow and the SDAP layer, whether to perform PDU set identification, packet deletion, or feedback operations.

In some embodiments, the network device configures the terminal, an association relationship between the SDAP layer and a plurality of DRBs or PDCP layers (e.g., in an SDAP configuration), and/or configures information of a PDU set (e.g., a type of the PDU set) corresponding to each DRB or PDCP layer (e.g., in a PDCP configuration).
1.2.4. The integration process or the differentiation process includes at least one of: identification, routing, or reordering.

With respect to the transmitter, the SDAP layer identifies different PDU sets, and/or routes different PDU sets to different lower layers, such as the PDCP layer. Which lower layer to route to may be determined based on an association relationship between the SDAP layer and the PDCP layer configured by the network device and/or information of PDU sets corresponding to different PDCP layers. In some embodiments, in the case that different PDU sets are not delivered in order from the higher layer to the current layer, or to the AS protocol layer, then a reordering operation is performed prior to routing.

With respect to the receiver, the SDAP layer receives lower-layer data of the different PDCP layers and delivers the lower-layer data to the higher layer.

In some embodiments, the base station configures the terminal, and/or the core network configures the base station, including at least one of: a mapping relationship between the QoS flow and the SDAP layer or the DRB or the PDCP layer or the RLC layer, whether to perform PDU set identification, routing, or reordering operations.

In some embodiments, the network device configures the terminal, an association relationship between the SDAP layer and a plurality of DRBs or PDCP layers (e.g., in an SDAP configuration), and/or configures information of a PDU set (e.g., a type of the PDU set) corresponding to each DRB or PDCP layer (e.g., in a PDCP configuration).
1.2.5. At least two of the foregoing 1.2.1, 1.2.2, 1.2.3, or 1.2.4 may be used in combination.
1.3. One QoS flow corresponds to one SDAP layer, one SDAP layer corresponds to one DRB or PDCP layer, one DRB or PDCP layer corresponds to a plurality of RLC layers, and different RLC layers transmit or route different PDU sets.
1.3.1. The integration process or the differentiation process includes: identification and/or reordering (reordering by the transmitter).

With respect to the transmitter, the SDAP layer or the PDCP layer identifies different PDU sets, and/or reorders different PDU sets (assuming that the different PDU sets are not delivered in order from a higher layer to a current layer, or to an AS protocol layer).

With respect to the receiver, the SDAP layer or the PDCP layer receives lower-layer data and delivers the lower-layer data to the higher layer.

In some embodiments, the base station configures the terminal, and/or the core network configures the base station, including at least one of: a mapping relationship between the QoS flow and the SDAP layer or the DRB or the PDCP layer, whether to perform PDU set identification, or reordering operations.

In some embodiments, the network device configures the UE, an association relationship between the PDCP layer and a plurality of RLC layers (e.g., in a PDCP configuration), and/or configures information of a PDU set (e.g., a type of the PDU set) corresponding to each RLC layer (e.g., in an RLC configuration).
1.3.2. The integration process or the differentiation process includes: identification and/or reordering (reordering by the receiver).

With respect to the transmitter, the PDCP layer identifies different PDU sets. Alternatively, the transmitter generates corresponding data packets (PDCP PDUs) for each PDU set, and adds serial numbers to the corresponding PDCP PDUs, for example, to packet headers, wherein the serial numbers are configured such that in the case that the receiver acquires data packets corresponding to the received PDCP layers from different RLC layers, the receiver is capable of performing reordering. Alternatively, the transmitter adds control information, such as a PDCP control PDU, between one or more corresponding data packets (PDCP PDUs) generated for each PDU set (e.g., adds the control information, such as the PDCP control PDU, before or after a plurality of data packets in the current PDU set). The control information or the PDCP control PDU includes at least one of: a start marker, an end marker, a lower-layer path to which a current data packet is delivered, a lower-layer path to which a next data packet is delivered, a lower-layer path to which a previous data packet is delivered, a bitmap indication of lower-layer paths to which a current data packet and an adjacent data packet are delivered, a serial number of current control information or control PDU, an identifier of current control information or control PDU, data packets that are delivered to different paths (e.g., indicated by a bitmap), paths to which a plurality of data packets between start markers are delivered, paths to which a plurality of data packets between end markers are delivered, a path to which a data packet corresponding to a serial number of current control information or control PDU is delivered, paths to which a plurality of data packets corresponding to a serial number of current control information or control PDU are delivered, a path to which a data packet corresponding to an identifier number of current control information or control PDU is delivered, or paths to which a plurality of data packets corresponding to an identifier number of current control information or control PDU are delivered. In some embodiments, the identification information of the control information or the control PDU represents a position of the control information or the control PDU in order of information. In some embodiments, with respect to a plurality of output paths, each piece of generated control information, such as the control PDU, is transmitted to all the paths. Alternatively, each piece of generated control information, such as the control PDU, is transmitted to only one of all the paths (e.g., to a main path, or to a default path, or to a pre-configured path). The control information or the control PDU is configured such that in the case that the receiver acquires PDCP data PDUs corresponding to the control information or control PDU (PDUs of the PDU set) from different RLC layers, the receiver is capable of performing reordering.

In some embodiments, before above processes, the transmitter reorders different PDU sets (assuming that the different PDU sets are not delivered in order from the higher layer to the current layer, or to the AS protocol layer).

With respect to the receiver, the PDCP layer receives lower-layer data and performs reordering. For example, with respect to the receiver, the PDCP layer receives the lower-layer data, and reorders PDU sets from different RLC layers based on SN numbers, or PDCP packet header information, or control information, or PDCP control PDU. Upon reordering, the receiver delivers the lower-layer data to the higher layer.

In some embodiments: the base station configures the UE, and/or the core network configures the base station, including at least one of: a mapping relationship between the QoS flow and the SDAP/DRB/PDCP layer, whether to perform PDU set identification, or reordering operations.

In some embodiments, the network device configures the UE, an association relationship between the PDCP layer and a plurality of RLC layers (e.g., in a PDCP configuration), and/or configures information of a PDU set (e.g., a type of the PDU set) corresponding to each RLC layer (e.g., in an RLC configuration).
1.3.3. The integration process or the differentiation process includes: identification and/or packet deletion.

With respect to the transmitter, the PDCP layer identifies different PDU sets. Alternatively, in the case that the different PDU sets have the first relationship, and a portion of the PDU sets is lost or does not satisfy a PDB of the PDU sets, or the PDU sets satisfying the first relationship do not satisfy a PDB of the associated PDU sets, then the transmitter performs packet deletion, and/or indicates a lower layer of a current layer (corresponding to an SDU of the current layer) to perform the packet deletion. The packet deletion includes: deleting PDUs or data packets in the PDU sets that satisfy the first relationship.

With respect to the receiver, for example, the PDCP layer receives lower-layer data and delivers the lower-layer data to the higher layer. Further, with respect to the receiver, for example, the PDCP layer identifies different PDU sets. In the case that the different PDU sets have the first relationship, and a portion of the PDU sets is lost or does not satisfy a PDB of the PDU sets, or the PDU sets satisfying the first relationship do not satisfy a PDB of the associated PDU sets, then the receiver performs packet deletion, and/or indicates a lower layer of a current layer (corresponding to an SDU of the current layer) to perform the packet deletion. The packet deletion includes: deleting PDUs or data packets in the PDU sets that satisfy the first relationship. Further, the current layer may feed back NACK to a peer terminal.

In some embodiments: the base station configures the terminal, and/or the core network configures the base station, including at least one of: a mapping relationship between the QoS flow and the SDAP layer, whether to perform PDU set identification, packet deletion, or feedback operations.

In some embodiments, the network device configures the terminal, an association relationship between the PDCP layer and a plurality of RLC layers (e.g., in a PDCP configuration), and/or configures information of a PDU set (e.g., a type of the PDU set) corresponding to each RLC layer (e.g., in an RLC configuration).
1.3.4. The integration process or the differentiation process includes at least one of: identification, routing, or reordering.

With respect to the transmitter, for example, the PDCP layer identifies different PDU sets. Alternatively, the PDCP layer routes different PDU sets to different lower layers, such as the RLC layer. Which lower layer to route to may be determined based on an association relationship between the PDCP layer and the RLC layer configured by the network and/or information of PDU sets corresponding to different RLC layers. In some embodiments, in the case that different PDU sets are not delivered in order from the higher layer to the current layer, or to the AS protocol layer, then a reordering operation is performed prior to routing.

With respect to the receiver, for example, the PDCP layer receives lower-layer data of the different RLC layers and delivers the lower-layer data to the higher layer.

In some embodiments, the base station configures the terminal, and/or the core network configures the base station, including at least one of: a mapping relationship between the QoS flow and the SDAP layer or the DRB or the PDCP layer, whether to perform PDU set identification, routing, or reordering operations.

In some embodiments, the network device configures the terminal, an association relationship between the PDCP layer and a plurality of RLC layers (e.g., in a PDCP configuration), and/or configures information of a PDU set (e.g., a type of the PDU set) corresponding to each RLC layer (e.g., in an RLC configuration).
1.3.5. At least two of the foregoing 1.3.1, 1.3.2, 1.3.3, or 1.3.4 may be used in combination.
1.4. One QoS flow is associated with a plurality of SDAP layers, one SDAP layer corresponds to one DRB or PDCP layer, and different SDAP layers transmit or route different PDU sets.
1.4.1. The integration process or the differentiation process includes: identification and/or reordering (reordering by the transmitter).

With respect to the transmitter, for example, an M-layer (e.g., a new layer on the SDAP layer, or a high SDAP layer (a total SDAP layer associating the different SDAP layers)) identifies different PDU sets, and/or reorders different PDU sets (assuming that the different PDU sets are not delivered in order from a higher layer to a current layer, or to an AS protocol layer).

With respect to the receiver, for example, the M-layer receives lower-layer data and delivers the lower-layer data to the higher layer.

In some embodiments: the base station configures the terminal, and/or the core network configures the base station, including at least one of: a mapping relationship between the QoS flow and the SDAP/DRB/PDCP layer, whether to perform PDU set identification, reordering operations, or the M-layer.

In some embodiments, the network device configures the terminal, an association relationship between the QoS flow and a plurality of SDAP layers (e.g., in an SDAP configuration), and/or a relationship between the M-layer and the SDAP layers, and/or configures information of a PDU set (e.g., a type of the PDU set) corresponding to each SDAP layer (e.g., in the SDAP configuration)
1.4.2. The integration process or the differentiation process includes: identification and/or reordering (reordering by the receiver).

### In a Method A:

With respect to the transmitter, for example, an M-layer (e.g., a new layer on the SDAP layer, or a high SDAP layer (a total SDAP layer associating the different SDAP layers)) identifies different PDU sets. The transmitter generates corresponding data packets (M-layer PDUs) for each PDU set, and adds serial numbers to packet headers of the corresponding M-layer PDUs, wherein the serial numbers are configured such that in the case that the receiver acquires data packets corresponding to the received M-layer from different RLC layers, the receiver is capable of performing reordering. Alternatively, the transmitter adds M-layer control information, such as a control PDU, between one or more corresponding data packets (M-layer PDUs) generated for each PDU set (e.g., adds the M-layer control PDU before or after a plurality of data packets in the current PDU set). The M-layer control PDU includes at least one of: a start marker, an end marker, a lower-layer path to which a current data packet is delivered, a lower-layer path to which a next data packet is delivered, a lower-layer path to which a previous data packet is delivered, a bitmap indication of lower-layer paths to which a current data packet and an adjacent data packet are delivered, a serial number of current control information or control PDU, an identifier of current control information or control PDU, data packets that are delivered to different paths (e.g., indicated by a bitmap), paths to which a plurality of data packets between start markers are delivered, paths to which a plurality of data packets between end markers are delivered, a path to which a data packet corresponding to a serial number of current control information or control PDU is delivered, paths to which a plurality of data packets corresponding to a serial number of current control information or control PDU are delivered, a path to which a data packet corresponding to an identifier number of current control information or control PDU is delivered, or paths to which a plurality of data packets corresponding to an identifier number of current control information or control PDU are delivered. In some embodiments, the identification information of the control information or the control PDU represents a position of the control information or the control PDU in order of information. In some embodiments, with respect to a plurality of output paths, each piece of generated control information, such as the control PDU, is transmitted to all the paths. Alternatively, each piece of generated control information, such as the control PDU, is transmitted to only one of all the paths (e.g., to a main path, or to a default path, or to a pre-configured path). The control information or the control PDU is configured such that in the case that the receiver acquires M-layer data PDUs corresponding to the control PDU (PDUs of the PDU set) from different SDAP layers, the receiver is capable of performing reordering.

In some embodiments, before above processes, the transmitter reorders different PDU sets (assuming that the different PDU sets are not delivered in order from the higher layer to the current layer, or to the AS protocol layer).

With respect to the receiver, for example, the SDAP layer or the PDCP layer or the RLC layer receives lower-layer data and performs reordering. For example, with respect to the receiver, the M-layer receives lower-layer data, and reorders PDU sets from different SDAP layers based on M-layer packet header information, or the M-layer control PDU. Upon reordering, the receiver delivers the lower-layer data to the higher layer.

In some embodiments: the base station configures the terminal, and/or the core network configures the base station, including at least one of: a mapping relationship between the QoS flow and the SDAP layer or the DRB or the PDCP layer, whether to perform PDU set identification, reordering operations, or the M-layer.

Alternatively, in addition to the method A, another method combines the method A with 1.4.4 routing. In this method, a receiving and/or transmitting SDAP function module is changed. That is, one QoS flow is connected to one common module corresponding to two SDAP ports under an SDAP function architecture. Identification/routing/reordering is in the common module, and two SDAP ports are present below the common module.

With respect to the transmitter, for example, the SDAP layer identifies different PDU sets. Alternatively, the transmitter generates corresponding data packets (SDAP PDUs) for each PDU set, and adds serial numbers to the corresponding SDAP PDUs, for example, to packet headers, wherein the serial numbers are configured such that in the case that the receiver acquires data packets corresponding to the received SDAP layers from different RLC layers, the receiver is capable of performing reordering. Alternatively, the transmitter (TX) adds control information, such as an SDAP control PDU, between one or more corresponding data packets (SDAP PDUs) generated for each PDU set (e.g., adds the control information, such as the SDAP control PDU, before or after a plurality of data packets in the current PDU set). The control information or the SDAP control PDU includes at least one of: a start marker, an end marker, a lower-layer path to which a current data packet is delivered, a lower-layer path to which a next data packet is delivered, a lower-layer path to which a previous data packet is delivered, a bitmap indication of lower-layer paths to which a current data packet and an adjacent packet are delivered, a serial number of current control information or control PDU, an identifier of current control information or control PDU, data packets that are delivered to different paths (e.g., indicated by a bitmap), paths to which a plurality of data packets between start markers are delivered, paths to which a plurality of data packets between end markers are delivered, a path to which a data packet corresponding to a serial number of current control information or control PDU is delivered, paths to which a plurality of data packets corresponding to a serial number of current control information or control PDU are delivered, a path to which a data packet corresponding to an identifier number of current control information or control PDU is delivered, or paths to which a plurality of data packets corresponding to an identifier number of current control information or control PDU are delivered. In some embodiments, the identification information of the control information or the control PDU represents a position of the control information or the control PDU in order of information. In some embodiments, with respect to a plurality of output paths, each piece of generated control information, such as the control PDU, is transmitted to all the paths. Alternatively, each piece of generated control information, such as the control PDU, is transmitted to only one of all the paths (e.g., to a main path, or to a default path, or to a pre-configured path). The control information or the control PDU is configured such that in the case that the receiver acquires SDAP data PDUs corresponding to the control information or control PDU (PDUs of the PDU set) from different SDAP layers, the receiver is capable of performing reordering.

In some embodiments, before above process, the transmitter reorders different PDU sets (assuming that the different PDU sets are not delivered in order from the higher layer to the current layer, or to the AS protocol layer).

With respect to the receiver, the SDAP layer receives lower-layer data and performs reordering. For example, with respect to the receiver, the SDAP layer receives the lower-layer data, and reorders PDU sets from different SDAP receiving ports based on SN numbers, or SDAP packet header information, or control information, or SDAP control PDU. Upon reordering, the receiver delivers the lower-layer data to the higher layer.

In some embodiments: the base station configures the terminal, and/or the core network configures the base station, including at least one of: a mapping relationship between the QoS flow and the SDAP layer or the DRB or the PDCP layer, whether to perform PDU set identification, or reordering operations.

In some embodiments, the network device configures the terminal, an association relationship between the QoS flow and a plurality of SDAP layers (e.g., in an SDAP configuration), and/or a relationship between the M-layer and the SDAP layers, and/or configures information of a PDU set (e.g., a type of the PDU set) corresponding to each SDAP layer (e.g., in the SDAP configuration).
1.4.3. The integration process or the differentiation process includes: identification and/or packet deletion.

With respect to the transmitter, for example, the M-layer identifies different PDU sets. Alternatively, in the case that the different PDU sets have the first relationship, and a portion of the PDU sets is lost or does not satisfy a PDB of the PDU sets, or the PDU sets satisfying the first relationship do not satisfy a PDB of the associated PDU sets, then the transmitter performs packet deletion, and/or indicates a lower layer of a current layer (corresponding to an SDU of the current layer) to perform the packet deletion. The packet deletion includes: deleting PDUs or data packets in the PDU sets that satisfy the first relationship.

With respect to the receiver, for example, the M-layer receives lower-layer data and delivers the lower-layer data to the higher layer. Further, with respect to the receiver, for example, the PDCP layer identifies different PDU sets. In the case that the different PDU sets have the first relationship, and a portion of the PDU sets is lost or does not satisfy a PDB of the PDU sets, or the PDU sets satisfying the first relationship do not satisfy a PDB of the associated PDU sets, then the receiver performs packet deletion, and/or indicates a lower layer of a current layer (corresponding to an SDU of the current layer) to perform the packet deletion. The packet deletion includes: deleting PDUs or data packets in the PDU sets that satisfy the first relationship. Further, the current layer may feed back NACK to a peer terminal.

In some embodiments, the base station configures the terminal, and/or the core network configures the base station, including at least one of: a mapping relationship between the QoS flow and the SDAP layer, whether to perform PDU set identification, packet deletion, feedback operations, or the M-layer.

In some embodiments, the network device configures the terminal, an association relationship between the QoS flow and a plurality of SDAP layers (e.g., in an SDAP configuration), and/or a relationship between the M-layer and the SDAP layers, and/or configures information of a PDU set (e.g., a type of the PDU set) corresponding to each SDAP layer (e.g., in the SDAP configuration).
1.4.4. The integration process or the differentiation process includes at least one of: identification, routing, or reordering.

With respect to the transmitter, for example, the M-layer identifies different PDU sets. Alternatively, the M-layer routes different PDU sets to different lower layers, such as the SDAP layer. Which lower layer to route to may be determined based on an association relationship between the QoS flow and a plurality of SDAP layers configured by the network device, and/or a relationship between the M-layer and the SDAP layers, and/or configured information of a PDU set corresponding to each SDAP layer. In some embodiments, in the case that different PDU sets are not delivered in order from the higher layer to the current layer, or to the AS protocol layer, then a reordering operation is performed prior to routing.

With respect to the receiver, for example, the M-layer receives lower-layer data of different SDAP layers and delivers the lower-layer data to the higher layer.

In some embodiments: the base station configures the terminal, and/or the core network configures the base station, including at least one of: a mapping relationship between the QoS flow and the SDAP layer, whether to perform PDU set identification, routing, reordering operations, or the M-layer.

In some embodiments, the network device configures the terminal, an association relationship between the QoS flow and a plurality of SDAP layers (e.g., in an SDAP configuration), and/or a relationship between the M-layer and the SDAP layers, and/or configures information of a PDU set (e.g., a type of the PDU set) corresponding to each SDAP layer (e.g., in the SDAP configuration).
1.4.5. At least two of the foregoing 1.4.1, 1.4.2, 1.4.3, or 1.4.4 may be used in combination.
2. Different QoS flows correspond to different PDU sets.

One QoS flow corresponds to one SDAP/DRB/PDCP/RLC layer. Each path processes its own PDU sets.

In some embodiments, the base station configures the terminal, and/or the core network configures the base station, including at least one of: a mapping relationship between the QoS flow and the SDAP layer or the DRB or the PDCP layer or the RLC layer, and/or configures information of a PDU set (e.g., a type of the PDU set) corresponding to each SDAP layer or DRB or PDCP layer or RLC layer (e.g., in an SDAP configuration).
3. Different QoS flows correspond to different PDU sets, and the different QoS flows are mapped to one SDAP layer.
3.1. Different QoS flows are associated with one SDAP layer or DRB or PDCP layer or RLC layer.

It is similar to the method described in the 1.1 above.
3.2. Different QoS flows are associated with one SDAP layer, the one SDAP layer is associated with a plurality of DRBs/PDCP layers, and different DRBs or PDCP layers transmit or route different PDU sets.

It is similar to the method described in the 1.2.
3.3. Different QoS flows are associated with one SDAP layer, the one SDAP layer is associated with one DRB or PDCP layer, the one DRB or PDCP layer is associated with a plurality of RLC layers, and different RLC layers transmit or route different PDU sets.

It is similar to the method described in the 1.3.
3.4. Different QoS flows are associated with different SDAP layers, one SDAP layer corresponds to one DRB or PDCP layer, and different SDAP layers transmit or route different PDU sets.

It is similar to the method described in the 2.

In summary, the influence of the input channel and the output channel on the integration process or the differentiation process is described in detail, further ensuring the improvement of the data processing efficiency.

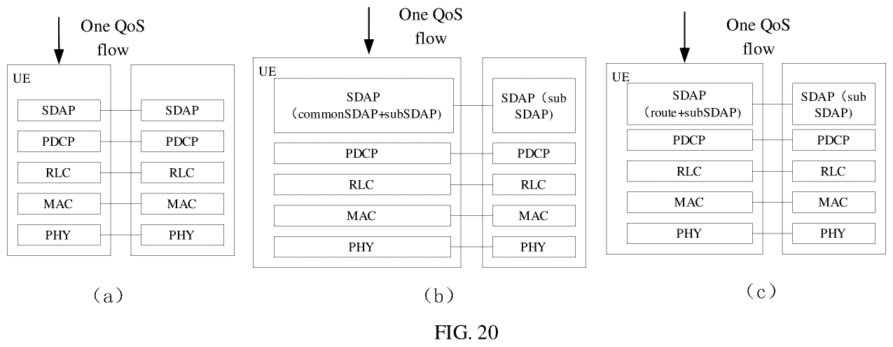

Part (a) of FIG. 20 illustrates that the transmitter routes different types of PDU sets to different SDAP layers. Part (b) of FIG. 20 illustrates that the transmitter routes different types of PDU sets to different sub SDAP layers. Part (c) of FIG. 20 illustrates that the transmitter routes different types of PDU sets to different sub SDAP layers.

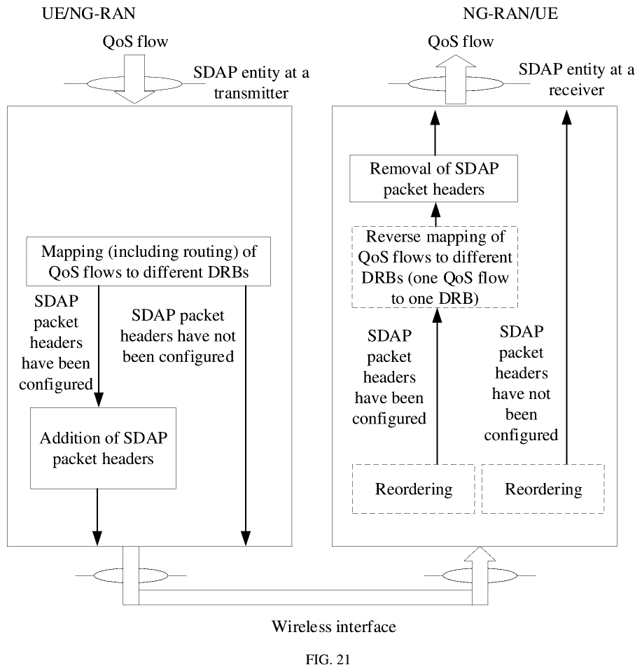

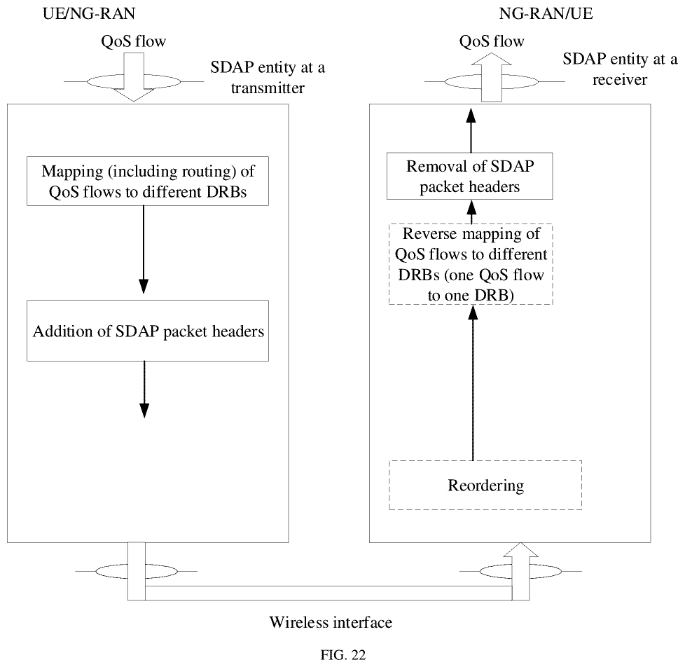

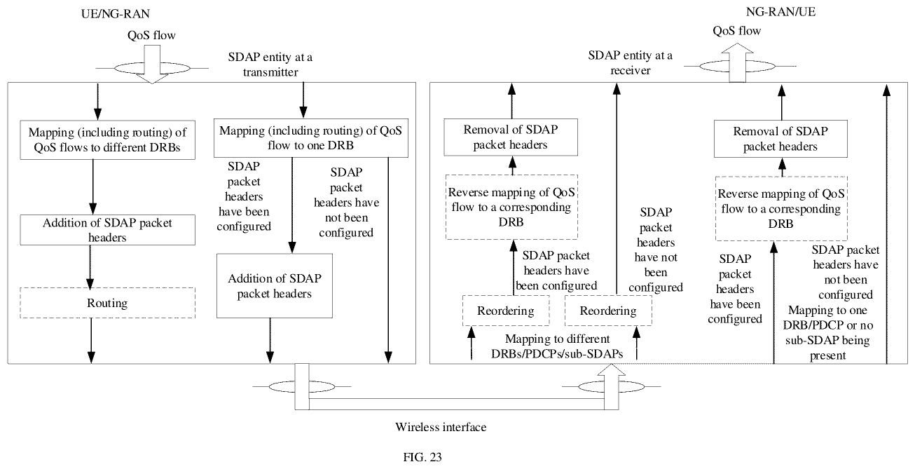

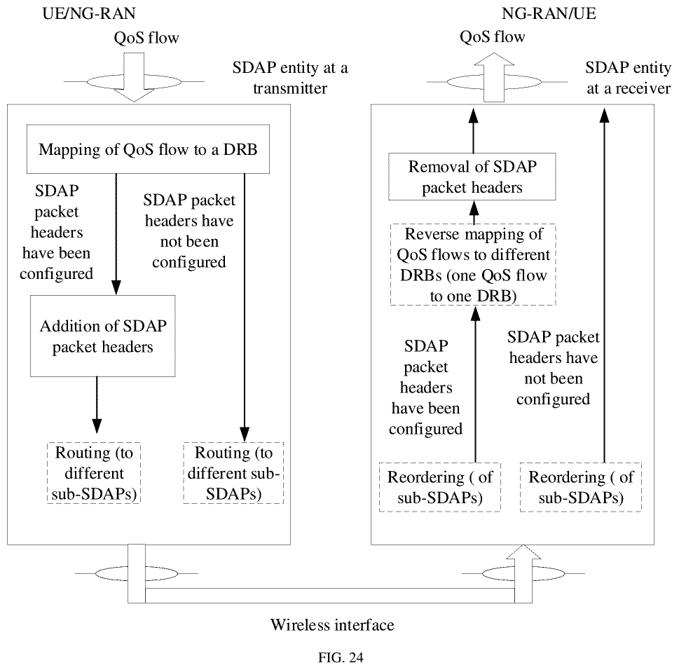

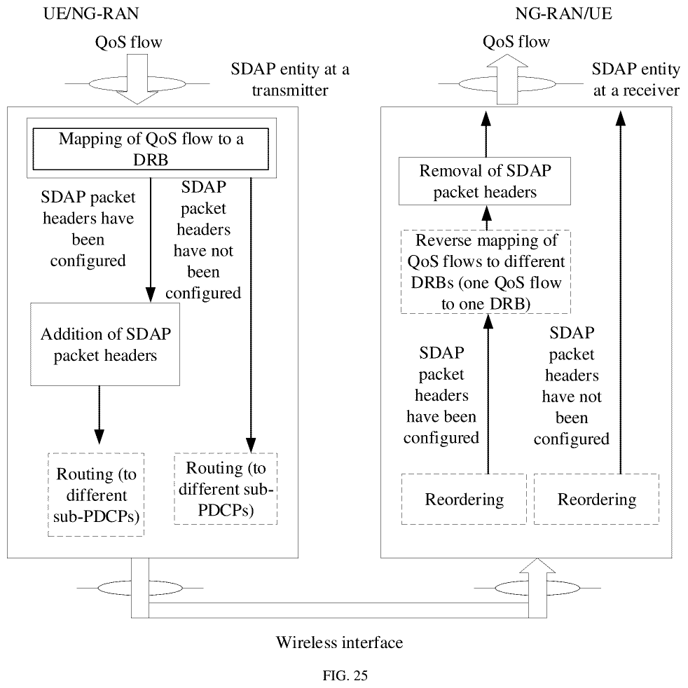

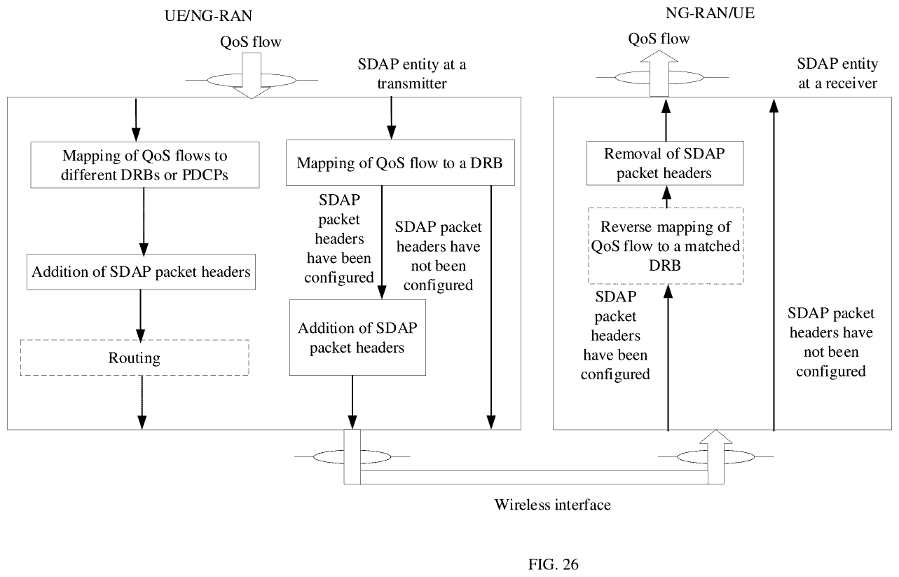

FIG. 21 illustrates a schematic diagram of one QoS flow path to a plurality of PDCP layers and addition of a target function in an SDAP layer. FIG. 22 illustrates a schematic diagram of another QoS flow path to a plurality of PDCP layers and addition of a target function in an SDAP layer. FIG. 23 illustrates a schematic diagram of one QoS flow path to a plurality of PDCP layers or subSDAP layers and addition of a target function in an SDAP layer. FIG. 24 illustrates a schematic diagram of one QoS flow path to a plurality of subPDCP layers and addition of a target function in an SDAP layer. FIG. 25 illustrates a schematic diagram of one SDAP path to a plurality of PDCP layers and addition of a target function in the SDAP layer. FIG. 26 illustrates a schematic diagram of one QoS flow path to a plurality of PDCP layers or subSDAP layers and addition of a target function in an SDAP layer.

FIGS. 25 to 28 illustrate schematic diagrams of routing of a transmitter and/or reordering of a receiver.

FIGS. 25 and 26 illustrate routing of a transmitter and/or reordering of a receiver. The method is applicable to routing of a transmitter and/or reordering of a receiver in a mode for the control information. In addition, the method may also be used in or not limited for use in routing of a transmitter and/or reordering of a receiver in a mode for addition of an SN or a packet header.

With respect to the uplink, an SDAP entity of the transmitter receives one SDAP SDU from a higher layer over one QoS flow.
In the case that a mapping relationship between the DRB and the SDAP SDU has been configured over an RRC message (with an SDAP packet header), the SDAP entity of the transmitter performs, in the case that routing and/or PDU/PDU set identification has been configured, at least one of: routing, generating an SDAP data PDU, or delivering the SDAP data PDU to a lower layer.
Otherwise, the SDAP entity of the transmitter performs, in the case that routing and/or PDU/PDU set identification has been configured, at least one of: routing, generating an SDAP data PDU, or delivering the SDAP data PDU to a lower layer. Otherwise, at least one of the following actions is performed: generating an SDAP data PDU, or delivering the SDAP data PDU to a lower layer.

With respect to the downlink, an SDAP entity of the receiver receives one SDAP data PDU for one QoS flow from a lower layer.
In the case that a mapping relationship between the DRB and the SDAP data PDU has been configured over an RRC message (with an SDAP packet header), the SDAP entity of the receiver performs, in the case that reordering and/or PDU/PDU set identification has been configured, at least one of: reordering (e.g., reordering based on control information, or based on SN numbers), reflective QoS flow to DRB mapping, RQI processing, recovering an SDAP SDU from the SDAP data PDU, or delivering the SDAP SDU to a higher layer.
Otherwise, the SDAP entity of the receiver performs, in the case that reordering and/or PDU/PDU set identification has been configured, at least one of: reordering (e.g., reordering based on control information), recovering an SDAP SDU from the SDAP data PDU, or delivering the SDAP SDU to a higher layer. Otherwise, at least one of the following actions is performed: recovering an SDAP SDU from the SDAP data PDU, or delivering the SDAP SDU to a higher layer.

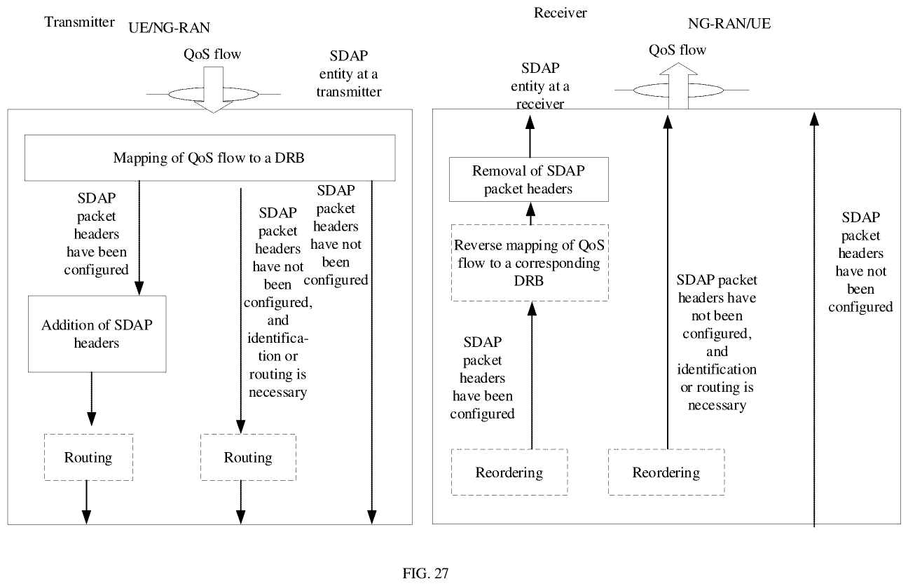

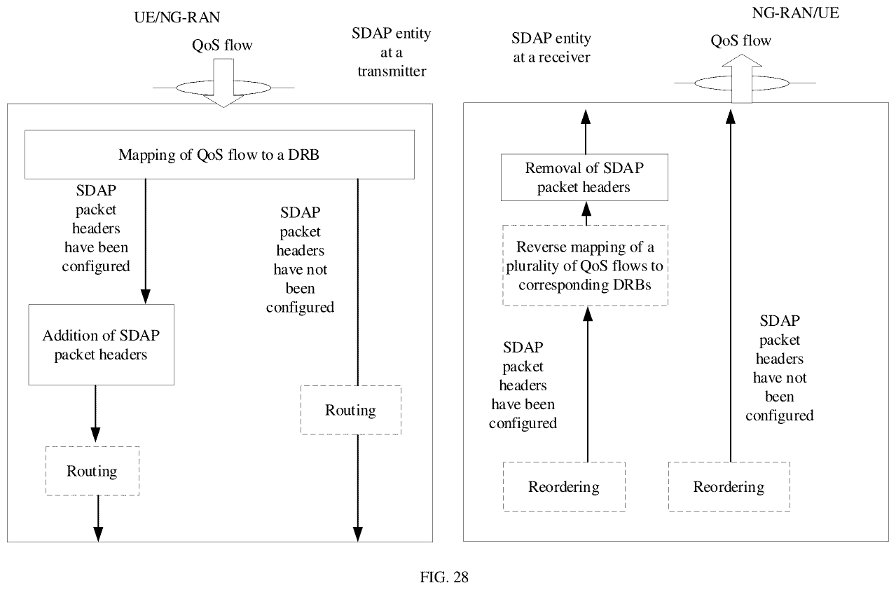

FIGS. 27 and 28 illustrate routing of a transmitter and/or reordering of a receiver. The method is applicable to routing of a transmitter and/or reordering of a receiver in a mode for addition of an SN or a packet header. In addition, the method may also be used in or not limited for use in routing of a transmitter and/or reordering of a receiver in a mode for control information.

With respect to the uplink, an SDAP entity of the transmitter receives one SDAP SDU from an upper layer over one QoS flow.
In the case that a mapping relationship between the DRB and the SDAP SDU has been configured over an RRC message (with an SDAP packet header), the SDAP entity of the transmitter performs, in the case that routing and/or PDU/PDU set identification has been configured, at least one of: routing, generating an SDAP data PDU, or delivering the SDAP data PDU to a lower layer.
Otherwise, the SDAP entity of the transmitter performs at least one of: generating an SDAP data PDU, or delivering the SDAP data PDU to a lower layer.

With respect to the downlink, an SDAP entity of the receiver receives one SDAP data PDU for one QoS flow from a lower layer.
In the case that a mapping relationship between the DRB and the SDAP data PDU has been configured over an RRC message (with an SDAP packet header), the SDAP entity of the receiver performs, in the case that reordering and/or PDU/PDU set identification has been configured, at least one of: reordering (e.g., reordering based on SN numbers, or based on control information), reflective QoS flow to DRB mapping, RQI processing, recovering an SDAP SDU from the SDAP data PDU (e.g., using different packet header formats), or delivering the SDAP SDU to a higher layer.
Otherwise, the SDAP entity of the receiver performs at least one of: recovering an SDAP SDU from the SDAP data PDU, or delivering the SDAP SDU to a higher layer.

### In Other Embodiments:

With respect to the uplink, an SDAP entity of the transmitter receives one SDAP SDU from an upper layer over one QoS flow.
In the case that a mapping relationship between the DRB and the SDAP SDU has been configured over an RRC message (with an SDAP packet header), the SDAP entity of the transmitter performs, in the case that routing and/or PDU/PDU set identification has been configured, at least one of: routing, generating an SDAP data PDU, or delivering the SDAP data PDU to a lower layer.
In the case that a mapping relationship between the DRB and the SDAP SDU has been configured over an RRC message (with an SDAP packet header), the SDAP entity of the transmitter performs, in the case that routing and/or PDU/PDU set identification has not been configured, at least one of: generating an SDAP data PDU, or delivering the SDAP data PDU to a lower layer.
Otherwise, the SDAP entity of the transmitter performs at least one of: generating an SDAP data PDU, or delivering the SDAP data PDU to a lower layer.

With respect to the downlink, an SDAP entity of the receiver receives one SDAP data PDU for one QoS flow from a lower layer.
In the case that a mapping relationship between the DRB and the SDAP data PDU has been configured over an RRC message (with an SDAP packet header), the SDAP entity of the receiver performs, in the case that reordering and/or PDU/PDU set identification has been configured, at least one of: reordering (e.g., reordering based on SN numbers, or based on control information), reflective QoS flow to DRB mapping, RQI processing, recovering an SDAP SDU from the SDAP data PDU (e.g., using different packet header formats), or delivering the SDAP SDU to a higher layer.
In the case that a mapping relationship between the DRB and the SDAP data PDU has been configured over an RRC message (with an SDAP packet header), the SDAP entity of the receiver performs, in the case that reordering and/or PDU/PDU set identification has not been configured, at least one of: reflective QoS flow to DRB mapping, RQI processing, recovering an SDAP SDU from the SDAP data PDU (e.g., in a packet header format, such as an existing TS37. 234 protocol format), or delivering the SDAP SDU to a higher layer.
Otherwise, the SDAP entity of the receiver performs at least one of: recovering an SDAP SDU from the SDAP data PDU, or delivering the SDAP SDU to a higher layer.

It should be noted that with respect to at least one of routing, reordering, or PDU/PDU set identification in a mode for addition of an SN or a packet header, at least one of the following needs to be introduced:
a new SDAP data PDU format;
adopting information in a new SDAP data PDU in the case that the SDAP data PDU is packetized or an SDAP SDU is recovered from the SDAP data PDU;
adopting information in a new SDAP data PDU in the case that the SDAP data PDU is packetized or an SDAP SDU is recovered from the SDAP data PDU, in at least one of configured or activated routing, reordering, or PDU/PDU set identification; or
carrying at least one of the following information in an SDAP data PDU packet header or payload, wherein the carried information is configured for control information for the integration or differentiation process, and the carried information includes: control information for performing routing/reordering operations, wherein the control information includes: an SN number, a PDU/PDU set identifier, and an identifier of a lower-layer path that is used.

It should be noted that with respect to at least one of routing, reordering, or PDU/PDU set identification in a mode for addition of control information, a data packet or a control information indication carrying the control information needs to be introduced. For example, the data packet carrying the control information is an SDAP control PDU. Then, in some embodiments, 1) the function of the control information needs to be indicated in the PDU packet header or payload, i.e., the control information is not an end-marker control PDU in TS 37.234 (V16.3.0), but the control information for the integration or differentiation process, for example, control information for performing routing/reordering operations; and/or, 2) at least one of the following information needs to be carried in the PDU packet header or payload: a start point, an end point, a start SN, an end SN, an identifier of a lower-layer path that is used, or an indication of a lower-layer path to route to (e.g., a bitmap).

It should be noted that, with respect to a plurality of output paths, each piece of generated control information, such as the control PDU, is transmitted to all the paths in some embodiments of the present disclosure. Alternatively, each piece of generated control information, such as the control PDU, is transmitted only to a portion (one or more) of all the paths, such as only to one of the paths (e.g., to any one of the paths, a path over which the corresponding data is to be transmitted, a main path, a default path, or a pre-configured path).

It should be noted that, identification information is included in each piece of control information, such as the control PDU in some embodiments of the present disclosure. The identification information is, for example, a serial number of the control information or the control PDU. For example, the identification information represents a position of the control information or the control PDU.

It should be noted that, the PDU/PDU set identification, routing, and reordering based on the mode for addition of an SN or a packet header and based on the mode for control information, such as the control PDU, are used alone or in combination in some embodiments in the present disclosure.

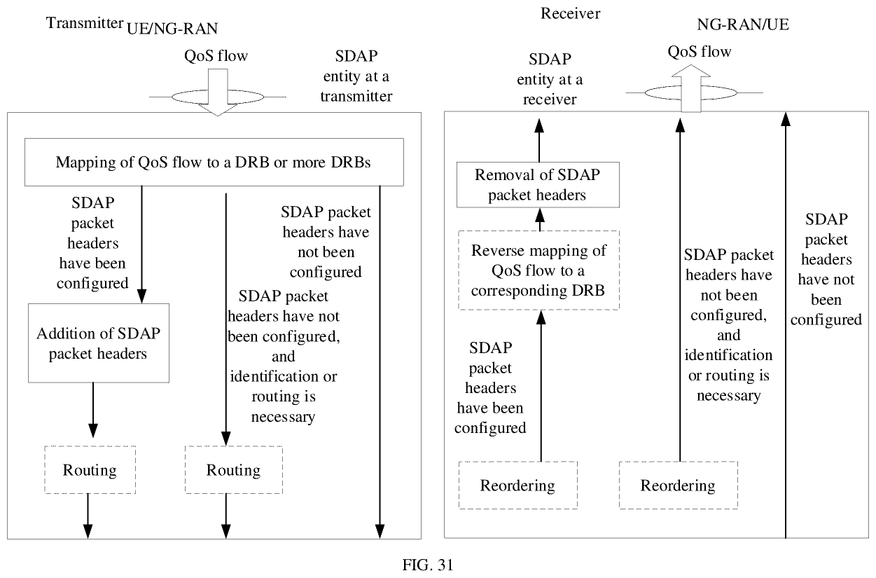

FIGS. 31 to 34 illustrate schematic diagrams of routing of a transmitter and/or reordering of a receiver.

It can be seen that a difference between FIGS. 31 and 27 at least includes: a change from “mapping of QoS flow to a DRB” of the transmitter in FIG. 27 to “mapping of QoS flow to a DRB or more DRBs”.

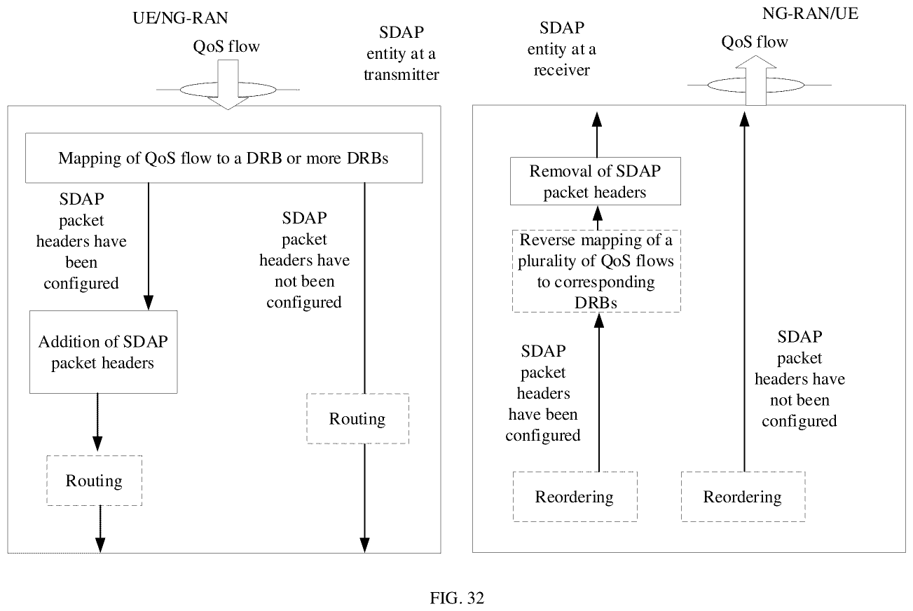

A difference between FIGS. 32 and 28 are similar to the difference between FIGS. 31 and 27, which is not repeated.

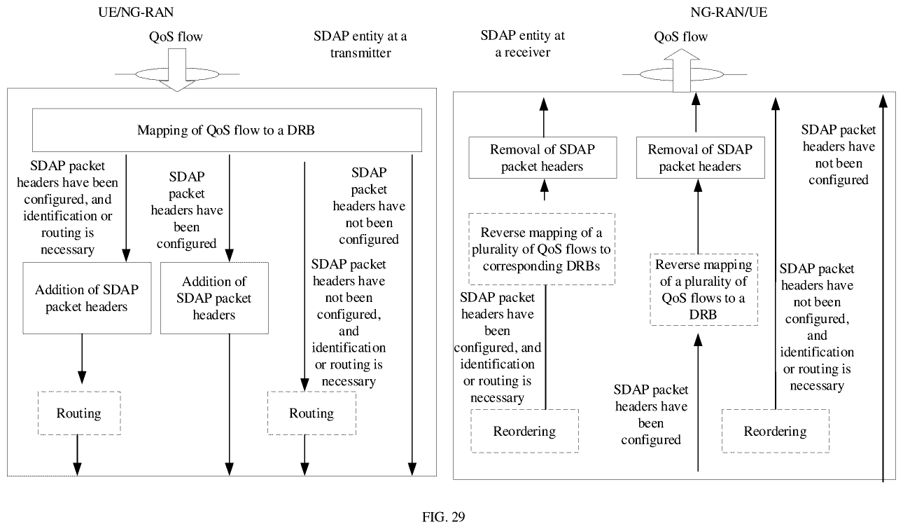

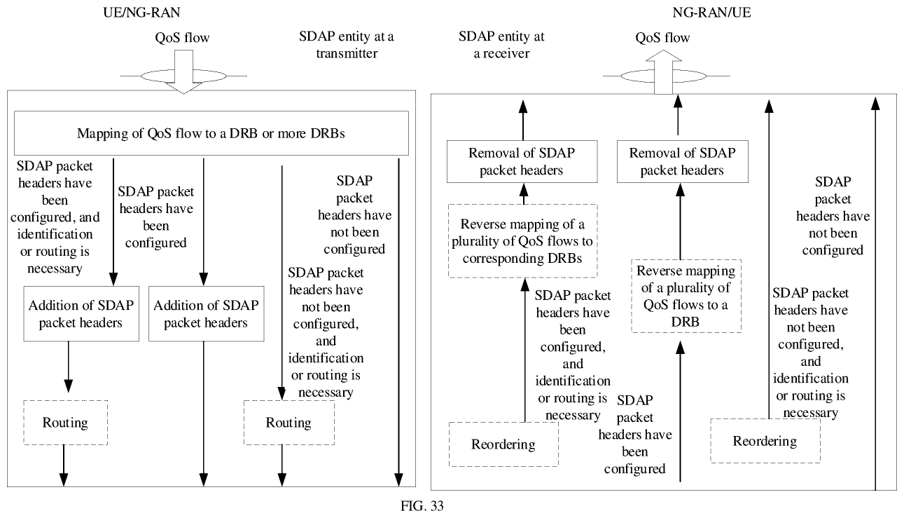

A difference between FIGS. 33 and 29 is similar to the difference between FIG. 31 and FIG. 27, which is not repeated.

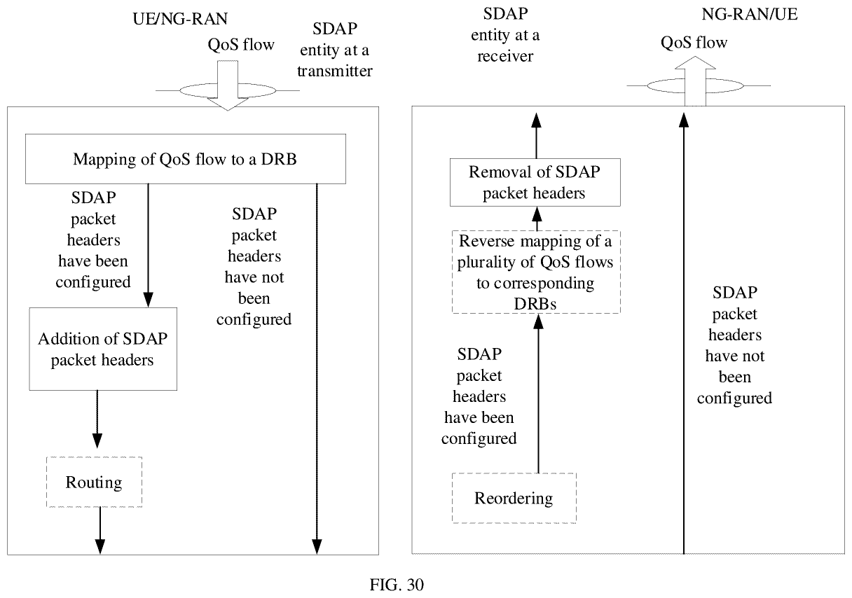

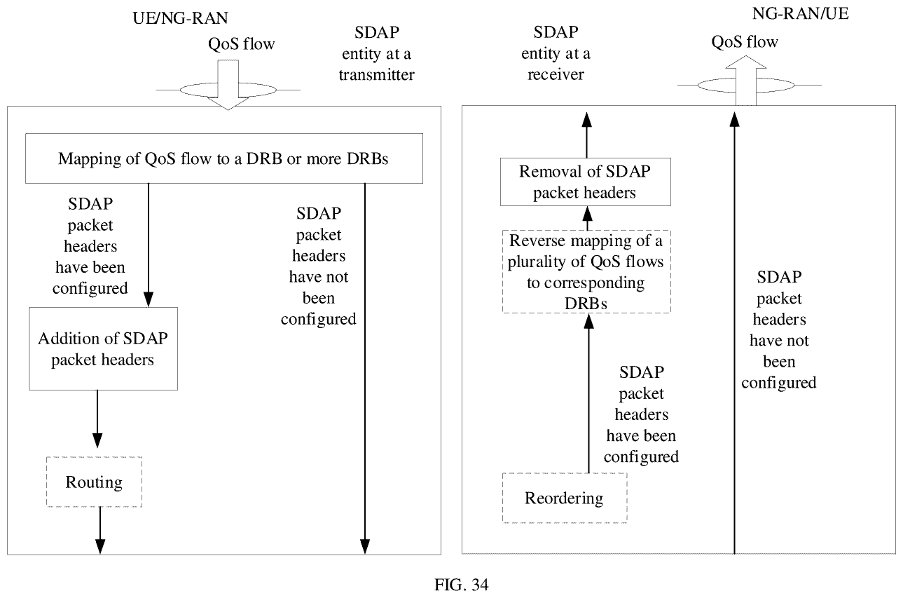

A difference between FIGS. 34 and 30 is similar to the difference between FIGS. 31 and 27, which is not repeated.

It should be noted that another possible variation is present in FIGS. 27 to 34.

In FIGS. 27 to 30, “mapping of QoS flow to a DRB” is included in a function branch without routing and/or reordering and/or PDU (set) identification, and “mapping of QoS flow to a DRB or more DRBs” or “mapping of QoS flow to more DRBs” is included in a function branch with routing and/or reordering and/or PDU (set) identification.

In some embodiments, in FIGS. 31 to 34, “mapping of QoS flow to a DRB or more DRBs” or “mapping of QoS flow to more DRBs” is included in a function branch with routing and/or reordering and/or PDU (set) identification. “Mapping of QoS flow to a DRB” is included in a function branch without routing and/or reordering and/or PDU (set) identification. It should be noted that the DRB may be replaced by a PDCP layer or an RLC layer.

It should be noted that another possible variation is present in FIGS. 27 to 34 in the case that the function corresponding to the integration process or the differentiation process is in the SDAP layer or entity. Hereinafter, the DRB is used as an example, and the example can be used in the case that the DRB is replaced by the PDCP layer, the RLC layer, or the like.

In FIGS. 27 to 30, a function branch does not include functions of routing and/or reordering and/or PDU (set) identification and/or packet deletion in the case that the function branch has at least one of the following first situations.

The first situations include: the presence of “mapping of QoS flow to a DRB”, no SDAP packet header configured, no control SDAP packet header configured, no support for control information (or control PDU), and no control SDAP packet header configured in the function branch.

A function branch includes functions of routing and/or reordering and/or PDU (set) identification and/or packet deletion in the case that the function branch has at least one of the following second situations.

The second situations include: “mapping of QoS flow to a DRB or more DRBs”, “mapping of QoS flow to more DRBs”, an SDAP packet header configured, support for control information (or control PDU), a control SDAP packet header configured in the function branch, and a control SDAP packet header configured.

In FIGS. 31 to 34, a function branch does not include functions of routing and/or reordering and/or PDU (set) identification and/or packet deletion in the case that the function branch has at least one of the following third situations.

The third situations include: “mapping of QoS flow to a DRB or more DRBs”, “mapping of QoS flow to more DRBs”, no SDAP packet header configured, no control SDAP packet header configured, no support for control information (or control PDU), and no control SDAP packet header configured in the function branch.

A function branch includes functions of routing and/or reordering and/or PDU (set) identification and/or packet deletion in the case that the function branch has at least one of the following fourth situations.

The fourth situations include: “mapping of QoS flow to a DRB”, “mapping of QoS flow to more DRBs”, support for control information (or control PDU), a control SDAP packet header configured in the function branch, an SDAP packet header configured, and a control SDAP packet header configured.

It should be noted that, in some embodiments of the present disclosure, the integration or differentiation process (for example, identification, reordering, and routing), or the use of control information, such as the control PDU, is applicable to a scenario of SDAP packet header configuration, and/or a scenario of SDAP control packet header configuration, or a scenario of mapping a plurality of paths (for example, DRB/PDCP layer/RLC layer), and/or a scenario where the processing is related to the SDAP layer (for example, the integration or differentiation process function is in the SDAP entity, or the entity or path involved in the integration or differentiation process includes the SDAP layer (for example, one QoS flows to a plurality of SDAP layers, or a new protocol layer is above or below the SDAP layer), etc.).

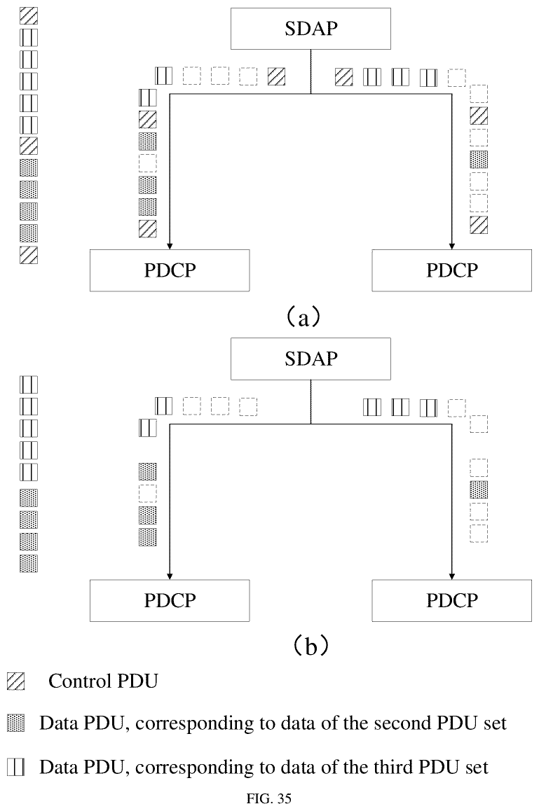

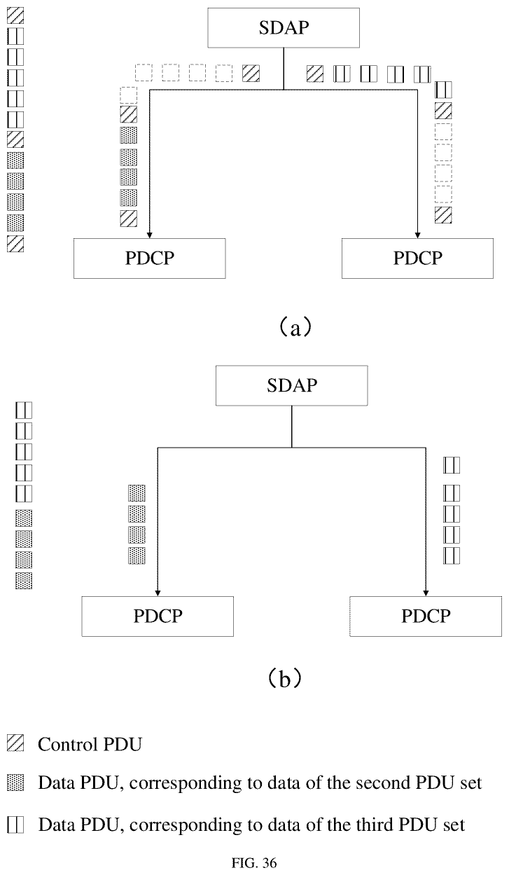

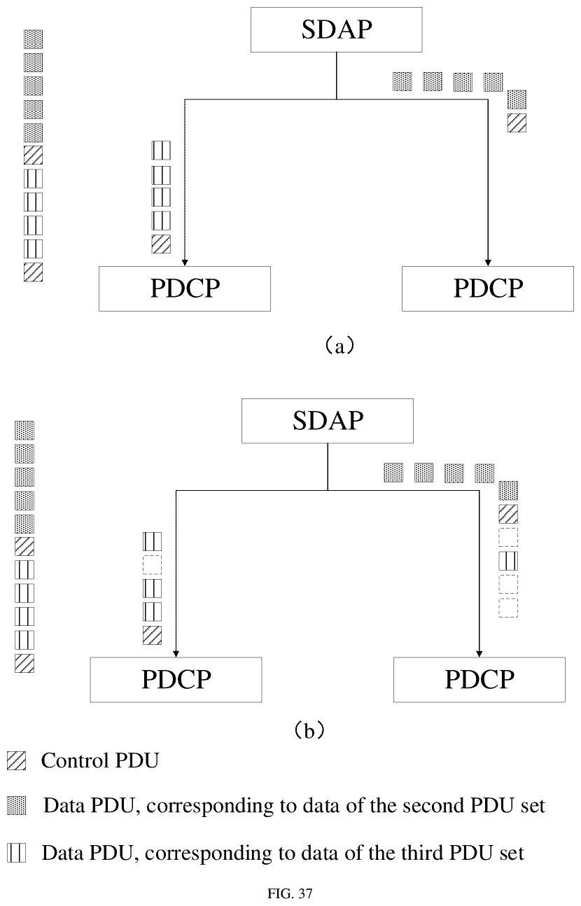

Further, FIGS. 35, 36, FIG. 37 illustrate exemplary diagrams of packet delivery in scenarios of PDU/PDU set identification, routing, and reordering based on the mode for addition of an SN or a packet header and based on the mode for control information (such as the control PDU). It should be noted that FIGS. 35, 36, and 37 only use SDAP layer to PDCP layer as an example, but the FIGS. 35, 36, and 37 are also applicable to other cases involving a plurality of paths, such as PDCP layer to RLC layer.

It should be noted that, in the accompanying drawings related to function modules in the present disclosure, functions identified by dashed boxes are optional functions, i.e., the functions may or may not be performed in the case that the integration process or the differentiation process is performed. Alternatively, the functions identified by the dashed boxes may also be understood as added functions for performing the integration process or the differentiation process. Further, in some cases, the functions identified by the dashed boxes may also be necessary. In some embodiments, whether the function is optional is configured by the network, or determined based on a predefined rule, or determined by a user. In some embodiments, whether the function is necessary is configured by the network, or determined based on a predefined rule, or determined by a user, or predefined by a protocol.

It should be noted that, in the accompanying drawings related to function modules in the present disclosure, with respect to each accompanying drawing, the function modules involved may be all, partially, or conditionally present. In addition, the association relationship between the transmitter and the receiver may be tight coupling (for example, with respect to an accompanying drawing in which the transmitter and the receiver are present, the transmitter and the receiver have to be of one-to-one corresponding relationship), or loose coupling (for example, with respect to a plurality of accompanying drawings in which the transmitter and the receiver are present, the transmitter and the receiver may not be of one-to-one corresponding relationship, for example, a selected transmitter in one accompanying drawing corresponds to the receiver in another accompanying drawing).

First embodiment (A new receiving/transmitter function is introduced, or the transmitter and/or the receiver performs specific actions. The new function or protocol layer is applicable to at least one of: the integration process of a first unit, different first units of different priorities, different first units of different importance levels, different first units of different dependency levels, or a second unit of a superior priority or order than a third unit),

The applicable scenarios include at least one of:
the case where the first unit is a PDU set (e.g., an I-frame, a P-frame, or a B-frame), or PDU sets with an association relationship or an integration process (also referred to as integrated packet handling) requirement (e.g., an I-frame and a P-frame, or two P-frames and a B-frame);
the case where the second unit and the third unit are PDU sets (e.g., the second unit is an I-frame, and the third unit is a P-frame);
the case where different first units/different PDU sets are mapped to different QoS flows (e.g., PDU sets of different priorities are mapped to different QoS flows), or to one QoS flow but of different DRB/PDCP layers, or to one QoS flow and of the same DRB/PDCP layer but different RLC layers;
the case where different PDUs/packets in different PDU sets are mapped to different QoS flows (e.g., PDU sets of different priorities are mapped to different QoS flows), or the second unit and the third unit are mapped to different QoS flows; or different PDU sets are mapped to the same QoS flow, or the second unit and the third unit are mapped to the same QoS flow; or
the case where different PDUs/packets in a PDU set are mapped to different QoS flows, or different PDUs/packets in a PDU set are mapped to the same QoS flow.

The implementation is as follows (applicable to both uplink (UL) and downlink (DL)).
1. With respect to the transmitter:

The transmitter may be at either the UE or the network side.

A peer entity for the transceiving processing is UE-gNB or UE-core network entity (such as UPF).

A new function or a new protocol is introduced.

The new function or the new protocol includes at least one of:
PDU set identification (identifying each or different PDU sets, or associated PDU identification, or identifying an association or dependency relationship between PDU sets), PDU/packet identification (e.g., identifying which PDUs/packets fall into a PDU set, or whether PDUs/packets fall into the same PDU set), reordering (the reordering ensures a sequential transmission of packets within a PDU set, or a sequential transmission of PDU sets) (e.g., a dependent PDU set is transmitted after a PDU set being depended, or an I-frame is transmitted prior to a P-frame, or a PDU set of a higher importance is transmitted prior to a PDU set of a lower importance, or a PDU set of a higher priority is transmitted prior to a PDU set of a lower priority), addition of SNs (SN numbers are added to ensure that the receiver can deliver data packets to a higher layer in order based on the SN numbers, or ensure that the receiver can deliver data packets to a higher layer in order based on the SN numbers upon reordering), PDU generation (after a new layer or entity is introduced, a PDU for the layer needs to be generated), packet deletion (the packet deletion is performed based on a feedback from a peer terminal; for example, in the case that the peer terminal indicates that a particular PDU set is lost (e.g., an I-frame), an associated P-frame is deleted), retransmission (the retransmission is performed based on a feedback from a peer terminal; for example, in the case that the peer terminal indicates that a particular PDU set is lost (e.g., an I-frame), a specific corresponding PDU set is retransmitted), or routing (based on types/priority levels/dependency levels, etc., of different PDU sets, different PDU sets are routed to different next paths, e.g., from one QoS flow to different SDAP layers, or from one SDAP layer to different DRBs/PDCP layers, or from one PDCP layer to different RLC layers; the different next paths correspond to different types/priority levels/dependency relationships, etc., wherein the paths and the corresponding relations thereof may be configured to the transmitter (UE) by a base station, e.g., over RRC signaling).

With respect to the peer entity for the transceiving processing being the UE-core network entity (such as UPF), basic functions may include: PDU set identification/PDU identification, reordering; or
addition of a new function or a new protocol to the existing AS layer, or the introduction of a new layer or a new entity.

The existing AS layer may be at least one of: an SDAP layer, a PDCP layer, or an RLC layer.

The new layer or the new entity may be located above the SDAP layer, or between the SDAP layer and the PDCP layer, or between the PDCP layer and the RLC layer, or below the RLC layer.
2. With respect to the receiver:

The receiver may be at either the UE or the network side.

The peer entity for the transceiving processing is UE-gNB or UE-core network entity (such as UPF).

A new function or a new protocol is introduced.

The new function or the new protocol includes at least one of:
PDU set identification (identifying each or different PDU sets, or associated PDU identification, or identifying an association or dependency relationship between PDU sets), PDU/packet identification (e.g., identifying which PDUs/packets fall into a PDU set, or whether PDUs/packets fall into the same PDU set), reordering (such as reordering based on SN numbers, with a purpose to ensure a sequential delivery of packets within a PDU set to a higher layer, or a sequential delivery of PDU sets to a higher layer (e.g., a dependent PDU set is delivered after a PDU set being depended, or an I-frame is delivered prior to a P-frame, or a PDU set of a higher importance is delivered prior to a PDU set of a lower importance, or a PDU set of a higher priority is delivered prior to a PDU set of a lower importance)), removal of a PDU packet header, reception of a buffer (with a function to process packets in a PDU set after the packets are buffered, or to process the associated PDU sets after the PDU sets are buffered), packet deletion (e.g., in the case that a portion of packets are lost, deleting the rest of the packets in the same PDU set or the associated PDU sets), or feedback (for the transmitter to perform packet deletion or retransmission processing).

With respect to the peer entity for the transceiving processing being the UE-core network entity (such as UPF), basic functions may include: PDU set identification/PDU identification, reordering; or
addition of a new function or a new protocol to the existing AS layer, or the introduction of a new layer or a new entity.

The existing AS layer may be at least one of: an SDAP layer, a PDCP layer, or an RLC layer.

The new layer or the new entity may be located above the SDAP layer, or between the SDAP layer and the PDCP layer, or between the PDCP layer and the RLC layer, or below the RLC layer.

Beneficial effects are as follows. A new function or protocol is defined for a data transmitter and/or a data receiver, such that the requirements of integrated packet handling of a PDU set or the associated PDU sets are met, or the requirements of preferential transmission or processing of a specific PDU set are met. The embodiment is an overview of the function or the protocol, and an implementation is described in the embodiments hereinafter.

Second embodiment (A new protocol layer or entity is introduced, and a first function or protocol is supported).

The applicable scenarios include: the cases where the new protocol layer is located above the SDAP layer, or between the SDAP layer and the PDCP layer, or between the PDCP layer and the RLC layer, or below the RLC layer (and above the MAC layer).

The new protocol layer may be referred to as: an MDAC layer, an AAC layer, an AMT layer, an AMC layer, an adaptive layer, or an MDAP layer. However, other names may also be used.

### Example 1: A Protocol Layer from a Function Perspective

(The UE is taken as an example, and the function flow may also be adopted by the gNB).

A flow or a module execution order at the transmitter is as follows (in the case that each function is configured/activated, or present): PDU/PDU set identification, reordering (which may be performed in a TX buffer), addition of SNs, addition of packet headers, and routing.

A flow or a module execution order at the receiver is as follows (in the case that each function is configured/activated, or present): removal of packet headers, PDU/PDU set identification, and reception of a buffer (including at least one of reordering, packet deletion, or feedback).

### Example 2: A Protocol Layer from an Architecture Perspective

The new layer may be located above the SDAP layer, or between the SDAP layer and the PDCP layer, or between the PDCP layer and the RLC layer, or below the RLC layer.

The mapping of the QoS flow is illustrated hereinafter with the new protocol layer being located above the SDAP layer layer as an example.
A: with respect to the associated PDU sets.
1) In the case that the associated PDU sets, such as the I-frame and the P-frame, or in the case that different PDUs in a PDU set, or PDU sets of different types/priority levels/dependency levels, etc., are transmitted to an RAN over different QoS flows, at least one of the following is included:
a) acquiring an association relationship between the QoS flows by the RAN. The associated QoS flows are determined based on identifiers of the QoS flows and/or PDU/frame types corresponding to the QoS flows (such as whether the QoS flows correspond to the I-frame or the P-frame), i.e., by acquiring the associated PDU sets and/or the PDU/frame types corresponding to the QoS flows (such as whether the QoS flows correspond to the I-frame or the P-frame);
b) determining the information by indicating the association and/or PDU/frame types corresponding to the QoS flows (such as whether the QoS flows correspond to the I-frame or the P-frame) based on QoS parameters of the QoS flows, e.g., new QoS parameters; or
c) determining the information by determining the association and/or PDU/frame types corresponding to the QoS flows (such as whether the QoS flows correspond to the I-frame or the P-frame) based on packet information carried in PDU sets in the QoS flows.

In some embodiments, with respect to at least one of a, b, or c, in the case that a plurality of PDU sets in the associated PDU sets are determined, the plurality of PDU sets in the associated PDU sets are determined based on serial numbers (SNs), for example, the associated I-frame and the associated P-frame are of the same SN number, or consecutive SN numbers (e.g., in the packet of the I-frame or the P-frame, the packet header indicates at least two of start numbers of the SN numbers, the number of the SN numbers, or end numbers of the SN numbers for the associated SN numbers).
2) In the case that the associated PDU sets, such as the I-frame and the P-frame, or PDU sets of different types/priority levels/dependency levels, etc., are transmitted to an RAN over the same QoS flow, at least one of the following is included:
a) acquiring an association relationship between the QoS flows by the RAN in some embodiments of the present disclosure. The packets of the PDU sets are determined to be transmitted over only one QoS flow; or
b) in the case that a plurality of associated PDU sets of the associated PDU sets are determining, determining the plurality of associated PDU sets based on serial numbers (SNs), for example, that the associated I-frame and the associated P-frame are of the same SN number, or consecutive SN numbers (e.g., in the packet of the I-frame or the P-frame, the packet header indicates at least two of start numbers of the SN numbers, the number of the SN numbers, or end numbers of the SN numbers for the associated SN numbers).
B: with respect to one PDU set.
1) In the case that different PDUs in the PDU set are transmitted to an RAN over different QoS flows, at least one of the following is included:
a) acquiring an association relationship between the QoS flows by the RAN. The associated QoS flows are determined based on identifiers of the QoS flows, i.e., from which QoS flows the PDUs of the PDU set are acquired is determined;
b) determining the information by indicating the association based on QoS parameters of the QoS flows, e.g., new QoS parameters; or
c) determining the information by determining the association based on packet information carried in the PDU set in the QoS flows.

In some embodiments, with respect to at least one of a, b, or c, in the case that an association in each PDU set is determined, the association is determined based on serial numbers (SNs), for example, the associated I-frames are of the same SN number, or consecutive SN numbers (e.g., in the PDUs of the I-frame, the packet headers indicate at least two of start numbers of the SN numbers, the number of the SN numbers, or end numbers of the SN numbers for the associated SN numbers).
2) In the case that different PDUs in the PDU set, such as one or more PDUs of the I-frame, or one or more PDUs of the P-frame, are transmitted to an RAN over the same QoS flow, at least one of the following is included:
a) acquiring an association relationship between the QoS flows by the RAN in some embodiments of the present disclosure, The packets of the PDU sets are determined to be transmitted over only one QoS flow; or
b) in the case that one or more PDUs in the PDU set are determining, determining the one or more PDUs in the PDU set based on serial numbers (SNs), for example, one or more PDUs of the I-frame are of the same SN number, or consecutive SN numbers (e.g., in the packet of the I-frame, the packet header indicates at least two of start numbers of the SN numbers, the number of the SN numbers, or end numbers of the SN numbers for the associated SN numbers).

### Example 3: An Implementation Flow is as Follows (Applicable to UL and/or DL)

1. The base station configures a relevant configuration of a first protocol layer.
a) The relevant configuration of the first protocol layer is per UE, per QoS flow, per PDU session, per MAC layer, per DRB, per LCH, or per PDCP layer.
b) The first protocol layer may be referred to as: an MDAC layer, an AAC layer, an AMT layer, an AMC layer, an adaptive layer, or an MDAP layer. However, other names may also be used.
2. The UE configures the protocol layer based on the relevant configuration of the first protocol layer and performs a relevant operation of the first protocol layer.
a) In some embodiments, in the case that the UE receives configuration information of the first protocol layer, the first protocol layer is used and/or configured.
b) In some embodiments, in the case that the UE receives activation indication information from the network, the first protocol layer is used and/or configured in response to activation of the first protocol layer.
c) In some embodiments, in the case that the UE receives deactivation indication information from the network, the first protocol layer is not used and/or de-configured in response to deactivation of the first protocol layer.

It should be noted that, in the embodiment, the transceiving entity is UE-RAN, but the transceiving entity may also be UE-CN (such as UPF). The function of the transceiving entity is at least one of the functions in the embodiment.

Beneficial effects are as follows. A method for introducing a new protocol layer to implement the integration process of a PDU/PDU set is provided, such that network transmission/decoding requirements of integrated packet handling are met. Compared with a third embodiment, no matter whether the types of the integrated objects are the same, such as whether the integrated objects are transmitted over the same QoS flow/DRB/LCH/SDAP layer or different QoS flows/DRBs/LCHs/SDAP layers, the new function/protocol is not subjected to the differentiation process.

Third embodiment (A new protocol layer or entity is introduced, and a first function or protocol is supported. The processing modes of the new protocol layer or the entity are different for different types of integrated objects).

The applicable scenarios include: the cases where the new protocol layer is located above the SDAP layer, or between the SDAP layer and the PDCP layer, or between the PDCP layer and the RLC layer, or below the RLC layer (and above the MAC layer).

The new protocol layer may be referred to as: an MDAC layer, an AAC layer, an AMT layer, an AMC layer, an adaptive layer, or an MDAP layer. However, other names may also be used.

### Example 1: A Protocol Layer from a Function Perspective

(The UE is taken as an example, and the function flow may also be adopted by the gNB).

A flow or a module execution order at the transmitter is as follows (in the case that each function is configured/activated, or present): PDU/PDU set identification, reordering (which may be performed in a TX buffer), addition of SNs, addition of packet headers, and routing.

The processing modes are different for different types of integrated objects. Alternatively, the processing modes are different for PDU sets of different types/priority levels/dependency levels, etc. In some embodiments, the types of the integrated objects refer to whether the integrated objects are transmitted over the same QoS flow/DRB/LCH/SDAP layer (or a relationship thereof) or different QoS flows/DRBs/LCHs/SDAP layers (or a relationship thereof).

With respect to the packets being transmitted over different QoS flows/DRBs/LCHs/SDAP layers, addition of SNs, addition of headers, and routing operations are performed after PDU/PDU set identification and reordering.

With respect to the packets being transmitted over the same QoS flow/DRB/LCH/SDAP layer, at least one of addition of SNs, addition of headers, or routing operations may not be performed after PDU/PDU set identification and reordering.

A flow or a module execution order at the receiver is as follows (in the case that each function is configured/activated, or present): removal of packet headers, PDU/PDU set identification, and reception of a buffer (including at least one of reordering, packet deletion, or feedback).

The processing modes are different for different types of integrated objects. Alternatively, the processing modes are different for PDU sets of different types/priority levels/dependency levels, etc. In some embodiments, the types of the integrated objects refer to whether the integrated objects are transmitted over the same QoS flow (or QoS flow/DRB/LCH/SDAP layer) or different QoS flows (or QoS flows/DRBs/LCHs/SDAP layers).

With respect to the packets being transmitted over different QoS flows/DRBs/LCHs/SDAP layers, the operations of removal of headers, PDU/PDU set identification, and reception of a buffer are performed.

With respect to the packets being transmitted over the same QoS flow/DRB/LCH/SDAP layer, the protocol layer may be transpartently transmitted, or at least one of PDU/PDU set identification (e.g., whether PDU sets are the same one, or associated PDU sets, or the I-frame or the P-frame based on information in the packet header of a higher layer, such as SN numbers) or reception of a buffer (e.g., at least one of reordering, packet deletion, or feedback) is performed.

### Example 2: A Protocol Layer from an Architecture Perspective

The new layer may be located above the SDAP layer, or between the SDAP layer and the PDCP layer, or between the PDCP layer and the RLC layer, or below the RLC layer.

The mapping of the QoS flow is illustrated hereinafter with the new protocol layer being located above the SDAP layer as an example.
A: with respect to the associated PDU sets.
1) In the case that the associated PDU sets, such as the I-frame and the P-frame, or in the case that different PDUs in a PDU set, or PDU sets of different types/priority levels/dependency levels, etc., are transmitted to an RAN over different QoS flows, at least one of the following is included:
a) acquiring an association relationship between the QoS flows by the RAN. The associated QoS flows are determined based on identifiers of the QoS flows and/or PDU/frame types corresponding to the QoS flows (such as whether the PDU/frame types corresponding to the QoS flows are the I-frame or the P-frame), i.e., by acquiring the associated PDU sets and/or the PDU/frame types corresponding to the QoS flows (such as whether the PDU/frame types corresponding to the QoS flows are the I-frame or the P-frame);
b) determining the information by indicating the association and/or PDU/frame types corresponding to the QoS flows (such as whether the PDU/frame types corresponding to the QoS flows are the I-frame or the P-frame) based on QoS parameters of the QoS flows, e.g., new QoS parameters; or
c) determining the information by determining the association and/or PDU/frame types corresponding to the QoS flows (such as whether the PDU/frame types corresponding to the QoS flows are the I-frame or the P-frame) based on packet information carried in PDU sets in the QoS flows.

In some embodiments, with respect to at least one of a, b, or c, in the case that a plurality of PDU sets in the associated PDU sets are determined, the plurality of PDU sets are determined based on serial numbers (SNs), for example, the associated I-frame and the associated P-frame are of the same SN number, or consecutive SN numbers (e.g., in the packet of the I-frame or the P-frame, the packet header indicates at least two of start numbers of the SN numbers, the number of the SN numbers, or end numbers of the SN numbers for the associated SN numbers).
2) In the case that the associated PDU sets, such as the I-frame and the P-frame, or PDU sets of different types/priority levels/dependency levels, etc., are transmitted to an RAN over the same QoS flow, at least one of the following is included:
a) acquiring an association relationship between the QoS flows by the RAN in some embodiments of the present disclosure. The packets of the PDU sets are determined to be transmitted over only one QoS flow; or
b) in the case that a plurality of associated PDU sets in the associated PDU sets are determined, determining the plurality of PDU sets based on serial numbers (SNs), for example, that the associated I-frame and the associated P-frame are of the same SN number, or consecutive SN numbers (e.g., in the packet of the I-frame or the P-frame, the packet header indicates at least two of start numbers of the SN numbers, the number of the SN numbers, or end numbers of the SN numbers for the associated SN numbers).
B: with respect to one PDU set.
1) In the case that different PDUs in the PDU set are transmitted to an RAN over different QoS flows, the followings are included:
a) acquiring an association relationship between the QoS flows by the RAN. The associated QoS flows are determined based on identifiers of the QoS flows, i.e., from which QoS flows the PDUs of the PDU set are acquired is determined;
b) determining the information by indicating the association based on QoS parameters of the QoS flows, e.g., new QoS parameters; or
c) determining the information by determining the association based on packet information carried in the PDU set in the QoS flows.

In some embodiments, with respect to at least one of a, b, or c, in the case that an association in each PDU set is determined, the association is determined based on serial numbers (SNs), for example, the associated I-frame is of the same SN number, or consecutive SN numbers (e.g., in the PDUs of the I-frame, the packet headers indicate at least two of start numbers of the SN numbers, the number of the SN numbers, or end numbers of the SN numbers for the associated SN numbers).
2) In the case that different PDUs in the PDU set, such as one or more PDUs of the I-frame, or one or more PDUs of the P-frame, are transmitted to an RAN over the same QoS flow, at least one of the following is included:
a) acquiring an association relationship between the QoS flows by the RAN in some embodiments of the present disclosure. The packets of the PDU sets are determined to be transmitted over only one QoS flow; or
b) in the case that one or more PDUs in the PDU set are determined, determining the one or more PDUs based on serial numbers (SNs), for example, one or more PDUs of the I-frame are of the same SN number, or consecutive SN numbers (e.g., in the packet of the I-frame, the packet header indicates at least two of start numbers of the SN numbers, the number of the SN numbers, or end numbers of the SN numbers for the associated SN numbers).

### Example 3: An Implementation Flow is as Follows (Applicable to UL and/or DL)

The base station configures a relevant configuration of a first protocol layer.

The relevant configuration of the first protocol layer is per UE, per QoS flow, per PDU session, per MAC layer, per DRB, per LCH, or per PDCP layer.

The first protocol layer may be referred to as: an MDAC layer, an AAC layer, an AMT layer, an AMC layer, an adaptive layer, or an MDAP layer. However, other names may also be used.

The UE configures the protocol layer based on the relevant configuration of the first protocol layer and performs a relevant operation of the first protocol layer. In some embodiments, in the case that the UE receives configuration information of the first protocol layer, the first protocol layer is used and/or configured. In some embodiments, in the case that the UE receives activation indication information from the network, the first protocol layer is used and/or configured in response to activation of the first protocol layer. In some embodiments, in the case that the UE receives deactivation indication information from the network, the first protocol layer is not used and/or de-configured in response to deactivation of the first protocol layer.

In the embodiment, the transceiving entity is UE-RAN, but the transceiving entity may also be UE-CN (such as UPF). The function of the transceiving entity is at least one of the functions in the embodiment.

Beneficial effects are as follows. A method for introducing a new protocol layer to implement the integration process of a PDU/PDU set is provided, such that network transmission/decoding requirements of integrated packet handling are met. Compared with the second embodiment, in the case that the types of the integrated objects are different, such as that the integrated objects are transmitted over the same QoS flow or different QoS flows, the new function/protocol is subjected to the differentiation process.

Fourth embodiment (A new function or module or protocol is introduced into the existing protocol layer or entity. In some embodiments, the function or module is subjected to or not subjected to the differentiation process in the case that the types of the integrated objects are different).

The applicable scenarios include: the cases where the new function or module or protocol is located within the SDAP layer (above the existing functions, or below the existing functions, or between the existing functions), or within the PDCP layer (above the existing functions, or below the existing functions, or between the existing functions), or within the RLC layer (above the existing functions, or below the existing functions, or between the existing functions), or within the MAC layer (above the existing functions, or below the existing functions, or between the existing functions).

The new protocol module or protocol may be referred to as: an MDAC layer, an AAC layer, an AMT layer, an AMC layer, or an MDAP layer. However, other names may also be used.

### Example 1: From a Function Perspective

(The UE is taken as an example, and the function flow may also be adopted by the gNB).

A protocol flow or a module execution order at the transmitter is as follows (in the case that each function is configured/activated, or present): PDU/PDU set identification, reordering (which may be performed in a TX buffer), and routing (optional).

The processing modes are the same or different for different types of integrated objects, or for PDU sets of different types/priority levels/dependency levels, etc.

In the case that the processing modes are the same, the function flows or the module execution orders described above are the same for all packets.

In the case that the processing modes are different, the function flows or the module execution orders described above are different for all packets.

In some embodiments, the types of the integrated objects refer to whether the integrated objects are transmitted over the same QoS flow/DRB/LCH/SDAP layer (or a relationship thereof) or different QoS flows/DRBs/LCHs/SDAP layers (or a relationship thereof).

In some embodiments, the different PDU sets are PDU sets of different types/priority levels/dependency levels, etc. The different PDU sets are routed to different next paths, e.g., from one QoS flow to different SDAP layers, or from one SDAP layer to different DRBs/PDCP layers, or from one PDCP layer to different RLC layers. The different next paths correspond to different types/priority levels/dependency relationships, etc., wherein the paths and the corresponding relationships thereof may be configured to the transmitter (UE) by a base station, e.g., over RRC signaling.

With respect to the packets being transmitted over different QoS flows/DRBs/LCHs/SDAP layers, the routing operation is performed after PDU/PDU set identification and reordering. Alternatively, addition of SN numbers (optional) and/or routing (and optional reordering) is performed after identification.

With respect to different PDU sets, addition of SN numbers (optional) and/or routing (and optional reordering) is performed after identification.

With respect to the packets being transmitted over the same QoS flow/DRB/LCH/SDAP layer, the routing operation is or is not performed after PDU/PDU set identification and reordering (with respect to a situation where routing is performed, for example, one QoS flow to different DRBs/PDCP layers, e.g., one PDCP layer to different RLC layers).

With respect to different PDU sets, the removal of SN numbers (optional) and/or routing (and optional reordering) is performed after identification.

A flow or a module execution order at the receiver is as follows (in the case that each function is configured/activated, or present): PDU/PDU set identification, and reception of a buffer (including at least one of reordering, packet deletion, or feedback).

The processing modes are the same or different for different types of integrated objects, or for PDU sets of different types/priority levels/dependency levels, etc.

In the case that the processing modes are the same, the function flows or the module execution orders described above are the same for all packets.

In the case that the processing modes are different, the function flows or the module execution orders described above are different for all packets.

In some embodiments, the types of the integrated objects refer to whether the integrated objects are transmitted over the same QoS flow (or QoS flow/DRB/LCH/SDAP layer) or different QoS flows (or QoS flows/DRBs/LCHs/SDAP layers).

In some embodiments, the different PDU sets are PDU sets of different types/priority levels/dependency levels, etc. The different PDU sets are routed to different next paths, e.g., from one QoS flow to different SDAP layers, or from one SDAP layer to different DRBs/PDCP layers, or from one PDCP layer to different RLC layers. The different next paths correspond to different types/priority levels/dependency relationships, etc., wherein the paths and the corresponding relationships thereof may be configured to the transmitter (UE) by a base station, e.g., over RRC signaling.

With respect to the packets being transmitted over different QoS flows/DRBs/LCHs/SDAP layers, the operations of PDU/PDU set identification, and reception of a buffer are performed.

With respect to different PDU sets, reordering is performed after identification.

With respect to the packets being transmitted over the same QoS flow/DRB/LCH/SDAP layer, the protocol layer may be transparently transmitted, or at least one of PDU/PDU set identification (e.g., whether PDU sets are the same one, or associated PDU sets, or the I-frame or the P-frame based on information in the packet header of a higher layer, such as SN numbers) or reception of a buffer (e.g., at least one of reordering, packet deletion, or feedback) is performed.

### Example 2: A Protocol Layer from an Architecture Perspective

The new function or module or protocol is located within the SDAP layer (above the existing functions, or below the existing functions, or between the existing functions), or within the PDCP layer (above the existing functions, or below the existing functions, or between the existing functions), or within the RLC layer (above the existing functions, or below the existing functions, or between the existing functions), or within the MAC layer (above the existing functions, or below the existing functions, or between the existing functions).

The new function or module or protocol may be referred to as: an MDAC layer, an AAC layer, an AMT layer, an AMC layer, or an MDAP layer. However, other names may also be used.

The mapping of the QoS flow is illustrated hereinafter with the new protocol layer being located within the SDAP layer as an example.
A: with respect to the associated PDU sets.
1) In the case that the associated PDU sets, such as the I-frame and the P-frame, or in the case that different PDUs in a PDU set, or different PDU sets, are transmitted to an RAN over different QoS flows, at least one of the following is included:
a) acquiring an association relationship between the QoS flows by the RAN. The associated QoS flows are determined based on identifiers of the QoS flows and/or PDU/frame types corresponding to the QoS flows (such as whether the PDU/frame types corresponding to the QoS flows are the I-frame or the P-frame), i.e., by acquiring the associated PDU sets and/or the PDU/frame types corresponding to the QoS flows (such as whether the PDU/frame types corresponding to the QoS flows are the I-frame or the P-frame);
b) determining the information by indicating the association and/or PDU/frame types corresponding to the QoS flows (such as whether the PDU/frame types corresponding to the QoS flows are the I-frame or the P-frame) based on QoS parameters of the QoS flows, e.g., new QoS parameters; or
c) determining the information by determining the association and/or PDU/frame types corresponding to the QoS flows (such as whether the PDU/frame types corresponding to the QoS flows are the I-frame or the P-frame) based on packet information carried in PDU sets in the QoS flows.

In some embodiments, with respect to at least one of a, b, or c, in the case that a plurality of PDU sets in the associated PDU sets are determined, the plurality of PDU sets are determined based on serial numbers (SNs), for example, that the associated I-frame and the associated P-frame are of the same SN number, or consecutive SN numbers (e.g., in the packet of the I-frame or the P-frame, the packet header indicates at least two of start numbers of the SN numbers, the number of the SN numbers, or end numbers of the SN numbers for the associated SN numbers).
2) In the case that the associated PDU sets, such as the I-frame and the P-frame, or different PDU sets, are transmitted to an RAN over the same QoS flow, at least one of the following is included:
a) acquiring an association relationship between the QoS flows by the RAN in some embodiments of the present disclosure. The packets of the PDU sets are determined to be transmitted over only one QoS flow; or
b) in the case that a plurality of associated PDU sets in the associated PDU sets are determined, determining the plurality of PDU sets based on serial numbers (SNs), for example, the associated I-frame and the associated P-frame are of the same SN number, or consecutive SN numbers (e.g., in the packet of the I-frame or the P-frame, the packet header indicates at least two of start numbers of the SN numbers, the number of the SN numbers, or end numbers of the SN numbers for the associated SN numbers).
B: with respect to one PDU set.
1) In the case that different PDUs in the PDU set are transmitted to an RAN over different QoS flows, the followings are included:
a) acquiring an association relationship between the QoS flows by the RAN. The associated QoS flows are determined based on identifiers of the QoS flows, i.e., from which QoS flows the PDUs of the PDU set are acquired is determined;
b) determining the information by indicating the association based on QoS parameters of the QoS flows, e.g., new QoS parameters; or
c) determining the information by determining the association based on packet information carried in the PDU set in the QoS flows.

In some embodiments, with respect to at least one of a, b, or c, in the case that the association in each PDU set is determined, the association in each PDU set is determined based on serial numbers (SNs), for example, that the associated I-frame is of the same SN number, or consecutive SN numbers (e.g., in the PDUs of the I-frame, the packet headers indicate at least two of start numbers of the SN numbers, the number of the SN numbers, or end numbers of the SN numbers for the associated SN numbers).
2) In the case that different PDUs in the PDU set, such as one or more PDUs of the I-frame, or one or more PDUs of the P-frame, are transmitted to an RAN over the same QoS flow, at least one of the following is included:
a) acquiring an association relationship between the QoS flows by the RAN in some embodiments of the present disclosure. The packets of the PDU sets are determined to be transmitted over only one QoS flow; or
b) in the case that one or more PDUs in the PDU set are determined, determining the one or more PDUs in the PDU set based on serial numbers (SNs), for example, one or more PDUs of the I-frame are of the same SN number, or consecutive SN numbers (e.g., in the packet of the I-frame, the packet header indicates at least two of start numbers of the SN numbers, the number of the SN numbers, or end numbers of the SN numbers for the associated SN numbers).

### Example 3: An Implementation Flow is as Follows (Applicable to UL and/or DL)

1. The base station configures a relevant configuration of a first function, and the new function is configured in one of PDCP-config, RLC-config, SDAP-config, or DRB-config.
a) The first function or protocol may be referred to as: an MDAC layer, an AAC layer, an AMT layer, an AMC layer, an adaptive layer, or an MDAP layer. However, other names may also be used.
2. The UE configures the function based on the relevant configuration of the first function and performs a relevant operation of the first function.
a) In some embodiments, in the case that the UE receives configuration information of the first function, the first function is used and/or configured at a corresponding protocol layer.
b) In some embodiments, in the case that the UE receives activation indication information from the network, the first function is used and/or configured at a corresponding protocol layer in response to activation of the first function.
c) In some embodiments, in the case that the UE receives deactivation indication information from the network, the first function is not used and/or de-configured at a corresponding protocol layer in response to deactivation of the first function.

In the embodiment, the transceiving entity is UE-RAN, but the transceiving entity may also be UE-CN (such as UPF). The function of the transceiving entity is at least one of the functions in the embodiment.

Beneficial effects are as follows. A mode for supporting a new function in the existing protocol layer is provided to support integrated packet handling, such that network transmission/decoding requirements of the integrated packet handling are met.

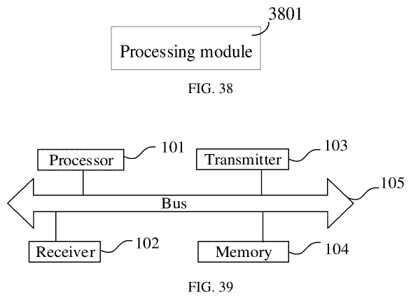

FIG. 38 illustrates an apparatus for processing data according to some embodiments of the present disclosure. The apparatus includes:
a processing module 3801, configured to perform an integration process or a differentiation process based on first data.

In some embodiments, the first data is a PDU set.

In some embodiments, the PDU set includes: a first PDU set including at least two PDUs having a first relationship; and/or at least one second PDU set and at least one third PDU set having a first relationship.

The first relationship includes at least one of: an association relationship, a dependency/dependence relationship, or a priority relationship.

In some embodiments, the integration process or the differentiation process includes at least one of:
identifying at least two different pieces of data in the first data;
identifying different pieces of the first data;
rearranging a transmission order of the at least two different pieces of data in the first data;
rearranging a transmission order of the different pieces of the first data;
reordering the at least two different pieces of data in the first data from at least one input channel;
reordering the different pieces of the first data from at least one input channel;
adding SNs to the at least two different pieces of data in the first data;
adding SNs to the different pieces of the first data;
adding or removing packet headers of the at least two different pieces of data in the first data;
adding or removing packet headers of the different pieces of the first data;
routing the at least two different pieces of data in the first data to at least two output channels;
routing the different pieces of the first data to at least two output channels;
deleting or feeding back deletion of at least one of the at least two different pieces of data in the first data;
deleting or feeding back deletion of at least one of the different pieces of the first data;
retransmitting or feeding back retransmission of at least one of the at least two different pieces of data in the first data;
retransmitting or feeding back retransmission of at least one of the different pieces of the first data;
feeding back a transmission state of the first data or transmission states of the at least two different pieces of data in the first data;
feeding back transmission states of the different pieces of the first data; or
generating a data packet for the first data and transmitting the data packet to a lower layer.

In some embodiments, the integration process or the differentiation process includes at least one of:
identifying at least two PDUs in the first PDU set;
identifying the at least one second PDU set and the at least one third PDU set;
rearranging a transmission order of the at least two PDUs in the first PDU set;
rearranging a transmission order of the at least one second PDU set and the at least one third PDU set;
reordering the at least two PDUs in the first PDU set from at least one input channel;
reordering the at least one second PDU set and the at least one third PDU set from at least one input channel;
adding SNs to the at least two PDUs in the first PDU set;
adding SNs to the at least one second PDU set and the at least one third PDU set;
adding or removing packet headers of the at least two PDUs in the first PDU set;
adding or removing packet headers of the at least one second PDU set and the at least one third PDU set;
routing the at least two PDUs in the first PDU set to at least two output channels;
routing the at least one second PDU set and the at least one third PDU set to at least two output channels;
deleting or feeding back deletion of at least one of the at least two PDUs in the first PDU set;
deleting or feeding back deletion of at least one of the at least one second PDU set and the at least one third PDU set;
retransmitting or feeding back retransmission of at least one of the at least two PDUs in the first PDU set;
retransmitting or feeding back retransmission of at least one of the at least one second PDU set and the at least one third PDU set;
feeding back a transmission state of the first PDU set, or feeding back a transmission state of at least one PDU in the first PDU set;
feeding back transmission states of the at least one second PDU set and the at least one third PDU set, or feeding back a transmission state of at least one of the at least one second PDU set or the at least one third PDU set; or
generating a data packet for the PDU set and transmitting the data packet to a lower layer.

In some embodiments, the input channel includes any one of:
a QoS flow; a DRB; an RLC channel; an LCH; an SDAP entity; a PDCP entity; an RLC entity; or a MAC entity.

In some embodiments, the output channel includes any one of:
a QoS flow; a DRB; an RLC channel; an LCH; an SDAP entity; a PDCP entity; an RLC entity; or a MAC entity.

In some embodiments, the processing module 3801 is further configured to route the at least two PDUs in the first PDU set to the at least two output channels based on first routing information, wherein the first routing information includes any one of configuration information, pre-configuration information, or indication information.

In some embodiments, the first routing information is configured by a base station over RRC signaling.

In some embodiments, the first routing information is identification information. In some embodiments, the first routing information identifies a corresponding relationship between the at least two PDUs in the first PDU set and the at least two output channels.

In some embodiments, the processing module 3801 is further configured to route the at least one second PDU set and the at least one third PDU set to the at least two output channels based on second routing information, wherein the second routing information includes any one of configuration information, pre-configuration information, or indication information.

In some embodiments, the second routing information is configured by a base station over RRC signaling.

In some embodiments, the second routing information is identification information. In some embodiments, the second routing information identifies a corresponding relationship between the at least one second PDU set and the at least one third PDU set and the at least two output channels.

In some embodiments, in the case that the apparatus for processing data includes a first communication device serving as a transmitter, the integration process or the differentiation process includes at least one of:
identifying at least two PDUs in the first PDU set;
identifying the at least one second PDU set and the at least one third PDU set;
rearranging a transmission order of the at least two PDUs in the first PDU set;
rearranging a transmission order of the at least one second PDU set and the at least one third PDU set;
reordering the at least two PDUs in the first PDU set from at least one input channel of a higher layer;
reordering the at least one second PDU set and the at least one third PDU set from at least one input channel of a higher layer;
adding SNs to the at least two PDUs in the first PDU set;
adding SNs to the at least one second PDU set and the at least one third PDU set;
adding packet headers of the at least two PDUs in the first PDU set;
adding packet headers of the at least one second PDU set and the at least one third PDU set;
routing the at least two PDUs in the first PDU set to at least two output channels of a lower layer;
routing the at least one second PDU set and the at least one third PDU set to at least two output channels of a lower layer;
deleting at least one of the at least two PDUs in the first PDU set;
deleting at least one of the at least one second PDU set and the at least one third PDU set;
retransmitting at least one of the at least two PDUs in the first PDU set;
retransmitting at least one of the at least one second PDU set and the at least one third PDU set; or
generating a data packet for the PDU set and transmitting the data packet to a lower layer.

In some embodiments, in the case that the input channels of the at least two PDUs in the first PDU set are not differentiated, the integration process or the differentiation process includes at least one of:
identifying at least two PDUs in the first PDU set;
rearranging a transmission order of the at least two PDUs in the first PDU set;
reordering the at least two PDUs in the first PDU set from at least one input channel of a higher layer;
adding SNs to the at least two PDUs in the first PDU set;
adding packet headers of the at least two PDUs in the first PDU set;
routing the at least two PDUs in the first PDU set to at least two output channels of a lower layer;
deleting at least one of the at least two PDUs in the first PDU set; or
retransmitting at least one of the at least two PDUs in the first PDU set.

In some embodiments, in the case that the input channels of the at least two PDUs in the first PDU set are differentiated, with respect to a situation where the at least two PDUs in the first PDU set come from different input channels, the integration process or the differentiation process includes at least one of:
identifying at least two PDUs in the first PDU set;
rearranging a transmission order of the at least two PDUs in the first PDU set;
reordering the at least two PDUs in the first PDU set from different input channels of a higher layer;
adding SNs to the at least two PDUs in the first PDU set;
adding packet headers of the at least two PDUs in the first PDU set;
routing the at least two PDUs in the first PDU set to at least two output channels of a lower layer;
deleting at least one of the at least two PDUs in the first PDU set; or
retransmitting at least one of the at least two PDUs in the first PDU set.

In some embodiments, in the case that the input channels of the at least two PDUs in the first PDU set are differentiated, with respect to a situation where the at least two PDUs in the first PDU set come from the same input channel, the integration process or the differentiation process includes at least one of:
identifying at least two PDUs in the first PDU set;
rearranging a transmission order of the at least two PDUs in the first PDU set;
reordering the at least two PDUs in the first PDU set from the same input channel of a higher layer;
routing the at least two PDUs in the first PDU set to at least two output channels of a lower layer;
deleting at least one of the at least two PDUs in the first PDU set; or
retransmitting at least one of the at least two PDUs in the first PDU set.

In some embodiments, in the case that the input channels of the at least one second PDU set and the at least one third PDU set are not differentiated, the integration process or the differentiation process includes:
identifying the at least one second PDU set and the at least one third PDU set;
rearranging a transmission order of the at least one second PDU set and the at least one third PDU set;
reordering the at least one second PDU set and the at least one third PDU set from at least one input channel of a higher layer;
adding SNs to the at least one second PDU set and the at least one third PDU set;
adding packet headers of the at least one second PDU set and the at least one third PDU set;
routing the at least one second PDU set and the at least one third PDU set to at least two output channels of a lower layer;
deleting at least one of the at least one second PDU set and the at least one third PDU set; and
retransmitting at least one of the at least one second PDU set and the at least one third PDU set.

In some embodiments, in the case that the input channels of the at least one second PDU set and the at least one third PDU set are differentiated, with respect to a situation where the at least one second PDU set and the at least one third PDU set come from different input channels, the integration process or the differentiation process includes:
identifying the at least one second PDU set and the at least one third PDU set;
rearranging a transmission order of the at least one second PDU set and the at least one third PDU set;
reordering the at least one second PDU set and the at least one third PDU set from different input channels of a higher layer;
adding SNs to the at least one second PDU set and the at least one third PDU set;
adding packet headers of the at least one second PDU set and the at least one third PDU set;
routing the at least one second PDU set and the at least one third PDU set to at least two output channels of a lower layer;
deleting at least one of the at least one second PDU set and the at least one third PDU set; and
retransmitting at least one of the at least one second PDU set and the at least one third PDU set.

In some embodiments, in the case that the input channels of the at least one second PDU set and the at least one third PDU set are differentiated, with respect to a situation where the at least one second PDU set and the at least one third PDU set come from the same input channel, the integration process or the differentiation process includes:
identifying the at least one second PDU set and the at least one third PDU set;
rearranging a transmission order of the at least one second PDU set and the at least one third PDU set;
reordering the at least one second PDU set and the at least one third PDU set from the same input channel of a higher layer;
routing the at least one second PDU set and the at least one third PDU set to at least two output channels of a lower layer;
deleting at least one of the at least one second PDU set and the at least one third PDU set; and
retransmitting at least one of the at least one second PDU set and the at least one third PDU set.

In some embodiments, the apparatus for processing data includes a second communication device serving as a receiver, and the integration process or the differentiation process includes:
identifying at least two PDUs in the first PDU set;
identifying the at least one second PDU set and the at least one third PDU set;
rearranging a transmission order of the at least two PDUs in the first PDU set;
rearranging a transmission order of the at least one second PDU set and the at least one third PDU set;
reordering the at least two PDUs in the first PDU set from at least one input channel of a lower layer;
reordering the at least one second PDU set and the at least one third PDU set from at least one input channel of a lower layer;
removing packet headers of the at least two PDUs in the first PDU set;
removing packet headers of the at least one second PDU set and the at least one third PDU set;
routing the at least two PDUs in the first PDU set to at least two output channels of a higher layer;
routing the at least one second PDU set and the at least one third PDU set to at least two output channels of a higher layer;
deleting or feeding back deletion of at least one of the at least two PDUs in the first PDU set;
deleting or feeding back deletion of at least one of the at least one second PDU set and the at least one third PDU set;
feeding back retransmission of at least one of the at least two PDUs in the first PDU set;
feeding back retransmission of at least one of the at least one second PDU set and the at least one third PDU set;
feeding back a transmission state of the first PDU set, or feeding back a transmission state of at least one PDU in the first PDU set; and
feeding back transmission states of the at least one second PDU set and the at least one third PDU set, or feeding back a transmission state of at least one of the at least one second PDU set or the at least one third PDU set.

In some embodiments, in the case that the input channels of the at least two PDUs in the first PDU set are not differentiated, the integration process or the differentiation process includes at least one of:
identifying at least two PDUs in the first PDU set;
rearranging a transmission order of the at least two PDUs in the first PDU set;
reordering the at least two PDUs in the first PDU set from at least one input channel of a lower layer;
removing packet headers of the at least two PDUs in the first PDU set;
routing the at least two PDUs in the first PDU set to at least two output channels of a higher layer;
deleting or feeding back deletion of at least one of the at least two PDUs in the first PDU set;
feeding back retransmission of at least one of the at least two PDUs in the first PDU set; or
feeding back a transmission state of the first PDU set, or feeding back a transmission state of at least one PDU in the first PDU set.

In some embodiments, in the case that the input channels of the at least two PDUs in the PDU set are differentiated, with respect to a situation where the at least two PDUs in the PDU set come from different input channels, the integration process or the differentiation process includes at least one of:
identifying at least two PDUs in the first PDU set;
rearranging a transmission order of the at least two PDUs in the first PDU set;
reordering the at least two PDUs in the first PDU set from different input channels of a lower layer;
removing packet headers of the at least two PDUs in the first PDU set;
routing the at least two PDUs in the first PDU set to at least two output channels of a higher layer;
deleting or feeding back deletion of at least one of the at least two PDUs in the first PDU set;
feeding back retransmission of at least one of the at least two PDUs in the first PDU set; or
feeding back a transmission state of the first PDU set, or feeding back a transmission state of at least one PDU in the first PDU set.

In some embodiments, in the case that the input channels of the at least two PDUs in the PDU set are differentiated, with respect to a situation where the at least two PDUs in the PDU set come from the same input channel, the integration process or the differentiation process includes at least one of:
identifying at least two PDUs in the first PDU set;
rearranging a transmission order of the at least two PDUs in the first PDU set;
reordering the at least two PDUs in the first PDU set from the same input channel of a lower layer;
routing the at least two PDUs in the first PDU set to at least two output channels of a higher layer;
deleting or feeding back deletion of at least one of the at least two PDUs in the first PDU set;
feeding back retransmission of at least one of the at least two PDUs in the first PDU set; or
feeding back a transmission state of the first PDU set, or feeding back a transmission state of at least one PDU in the first PDU set.

In some embodiments, in the case that the input channels of the at least one second PDU set and the at least one third PDU set are not differentiated, the integration process or the differentiation process includes:
identifying the at least one second PDU set and the at least one third PDU set;
rearranging a transmission order of the at least one second PDU set and the at least one third PDU set;
reordering the at least one second PDU set and the at least one third PDU set from at least one input channel of a lower layer;
removing packet headers of the at least one second PDU set and the at least one third PDU set;
routing the at least one second PDU set and the at least one third PDU set to at least two output channels of a higher layer;
deleting or feeding back deletion of at least one of the at least one second PDU set and the at least one third PDU set;
feeding back retransmission of at least one of the at least one second PDU set and the at least one third PDU set; and
feeding back transmission states of the at least one second PDU set and the at least one third PDU set, or feeding back a transmission state of at least one of the at least one second PDU set or the at least one third PDU set.

In some embodiments, in the case that the input channels of the at least one second PDU set and the at least one third PDU set are differentiated, with respect to a situation where the at least one second PDU set and the at least one third PDU set come from different input channels, the integration process or the differentiation process includes:
identifying the at least one second PDU set and the at least one third PDU set;
rearranging a transmission order of the at least one second PDU set and the at least one third PDU set;
reordering the at least one second PDU set and the at least one third PDU set from different input channels of a lower layer;
removing packet headers of the at least one second PDU set and the at least one third PDU set;
routing the at least one second PDU set and the at least one third PDU set to at least two output channels of a higher layer;
deleting or feeding back deletion of at least one of the at least one second PDU set and the at least one third PDU set;
feeding back retransmission of at least one of the at least one second PDU set and the at least one third PDU set; and
feeding back transmission states of the at least one second PDU set and the at least one third PDU set, or feeding back a transmission state of at least one of the at least one second PDU set or the at least one third PDU set.

In some embodiments, in the case that the input channels of the at least one second PDU set and the at least one third PDU set are differentiated, with respect to a situation where the at least one second PDU set and the at least one third PDU set come from the same input channel, the integration process or the differentiation process includes:
identifying the at least one second PDU set and the at least one third PDU set;
rearranging a transmission order of the at least one second PDU set and the at least one third PDU set;
reordering the at least one second PDU set and the at least one third PDU set from the same input channel of a lower layer;
routing the at least one second PDU set and the at least one third PDU set to at least two output channels of a higher layer;
deleting or feeding back deletion of at least one of the at least one second PDU set and the at least one third PDU set;
feeding back retransmission of at least one of the at least one second PDU set and the at least one third PDU set; and
feeding back transmission states of the at least one second PDU set and the at least one third PDU set, or feeding back a transmission state of at least one of the at least one second PDU set or the at least one third PDU set.

In some embodiments, the processing module 3801 is further configured to route the at least two different PDUs in the first PDU set to at least two different output channels.

In some embodiments, the processing module 3801 is further configured to route the at least one second PDU set and the at least one third PDU set to at least two different output channels, wherein the second PDU set and the third PDU set are different PDU sets.

In some embodiments, the processing module 3801 is further configured to determine, based on first information, at least one of:
the at least two different pieces of data in the first data having the first relationship;
whether to perform the integration process or the differentiation process; or
data for the integration process or the differentiation process.

The first relationship includes at least one of: an association relationship, a dependency/dependence relationship, or a priority relationship.

In some embodiments, the first information includes at least one of: first indication information, an input channel, packet header information, a dedicated indication, or first packet indication information.

In some embodiments, the first indication information is configured to instruct the first communication device serving as the transmitter or the second communication device serving as the receiver to perform the integration process or the differentiation process.

In some embodiments, the first communication device serving as the transmitter includes any one of a terminal, an access network element, or a core network element.

In some embodiments, the second communication device serving as the receiver includes any one of a terminal, an access network element, or a core network element.

In some embodiments, the first indication information is from an access network element or a core network element.

In some embodiments, the packet header information is configured to determine at least one of:
a type of first target data;
an ID of the first target data;
a priority of the first target data;
a determination of presence of data having the first relationship with the first target data;
data having the first relationship with the first target data; or
data for the integration process or the differentiation process with the first target data.

The first target data is any one of the at least two different pieces of data in the first data.

In some embodiments, the dedicated indication is configured to determine at least one of:
data having the first relationship with first target data; or
data for the integration process or the differentiation process with the first target data.

The first target data is any one of the at least two different pieces of data in the first data.

In some embodiments, the first packet indication information is configured to determine at least one of:
data having the first relationship with first target data; or
data for the integration process or the differentiation process with the first target data.

The first target data is any one of the at least two different pieces of data in the first data.

In some embodiments, the processing module 3801 is further configured to determine, based on the first information, at least one of:
the at least two PDUs in the first PDU set having the first relationship;
whether to perform the integration process or the differentiation process; or
the at least two PDUs in the first PDU set for the integration process or the differentiation process.

In some embodiments, the processing module 3801 is further configured to determine, based on different input channels, at least one of: the at least two PDUs in the first PDU set having the first relationship; whether to perform the integration process or the differentiation process; or the at least two PDUs in the first PDU set for the integration process or the differentiation process, in the case that the at least two PDUs in the first PDU set are transmitted over the different input channels.

In some embodiments, the different input channels include different QoS flows; and the processing module 3801 is further configured to determine, based on first target information, at least one of: the at least two PDUs in the first PDU set having the first relationship; whether to perform the integration process or the differentiation process; or the at least two PDUs in the first PDU set for the integration process or the differentiation process.

The first target information includes at least one of:
An association relationship between the different QoS flows;
PDU information of the at least two PDUs in the first PDU set in the different QoS flows; or
same or consecutive SNs of the at least two PDUs in the first PDU set.

In some embodiments, the different input channels include different protocol layers. The processing module 3801 is further configured to determine, based on second target information, at least one of: the at least two PDUs in the first PDU set having the first relationship; whether to perform the integration process or the differentiation process; or the at least two PDUs in the first PDU set for the integration process or the differentiation process.

The second target information includes at least one of:
an association relationship between the different protocol layers;
PDU information of the at least two PDUs in the first PDU set in the different protocol layers; or
same or consecutive SNs of the at least two PDUs in the first PDU set.

In some embodiments, the processing module 3801 is further configured to determine, based on the same input channel, at least one of: the at least two PDUs in the first PDU set having the first relationship; whether to perform the integration process or the differentiation process; or the at least two PDUs in the first PDU set for the integration process or the differentiation process, in the case that the at least two PDUs in the first PDU set are transmitted over the same input channel.

In some embodiments, the same input channel includes a first QoS flow; and the processing module 3801 is further configured to determine, based on third target information, at least one of: the at least two PDUs in the first PDU set having the first relationship; whether to perform the integration process or the differentiation process; or the at least two PDUs in the first PDU set for the integration process or the differentiation process.

The third target information includes at least one of:
an association relationship between the first QoS flow and at least one second QoS flow;
same or consecutive SNs of the at least two PDUs in the first PDU set;
the at least two PDUs in the first PDU set being present between two END identifiers; or
the at least two PDUs in the first PDU set being present between two START identifiers.

In some embodiments, the same input channel includes a first protocol layer. The processing module 3801 is further configured to determine, based on fourth target information, at least one of: the at least two PDUs in the first PDU set having the first relationship; whether to perform the integration process or the differentiation process; or the at least two PDUs in the first PDU set for the integration process or the differentiation process.

The fourth target information includes at least one of:
a mapping relationship between at least one second protocol layer and the first protocol layer;
same or consecutive SNs of the at least two PDUs in the first PDU set;
the at least two PDUs in the first PDU set being present between two END identifiers; or
the at least two PDUs in the first PDU set being present between two START identifiers.

In some embodiments, the processing module 3801 is further configured to determine, based on second information, at least one of: the different pieces of the first data having the first relationship; whether to perform the integration process or the differentiation process; or the different pieces of the first data for the integration process or the differentiation process.

The first relationship includes at least one of: an association relationship, a dependency/dependence relationship, or a priority relationship.

In some embodiments, the second information includes at least one of: second indication information, an input channel, packet header information, a dedicated indication, or second packet indication information.

In some embodiments, the second indication information is configured to instruct the first communication device serving as the transmitter or the second communication device serving as the receiver to perform the integration process or the differentiation process.

In some embodiments, the first communication device includes any one of a terminal, an access network element, or a core network element.

In some embodiments, the second communication device includes any one of a terminal, an access network element, or a core network element.

In some embodiments, the second indication information is from an access network element or a core network element.

In some embodiments, the packet header information is configured to determine at least one of:
a type of second target data;
an ID of the second target data;
a priority of the second target data;
a determination of presence of data having the first relationship with the second target data;
data having the first relationship with the second target data; or
data for the integration process or the differentiation process with the second target data.

The second target data is any one of the different pieces of the first data.

In some embodiments, the dedicated indication is configured to determine at least one of:
data having the first relationship with second target data; or
data for the integration process or the differentiation process with the second target data.

The second target data is any one of the different pieces of the first data.

In some embodiments, the second packet indication information is configured to determine at least one of:
data having the first relationship with second target data; or
data for the integration process or the differentiation process with the second target data.

The second target data is any one of the different pieces of the first data.

In some embodiments, the processing module 3801 is further configured to determine, based on the second information, at least one of: the at least one second PDU set and the at least one third PDU set having the first relationship; whether to perform the integration process or the differentiation process; or the at least one second PDU set and the at least one third PDU set for the integration process or the differentiation process.

In some embodiments, the processing module 3801 is further configured to determine, based on different input channels, at least one of: the at least one second PDU set and the at least one third PDU set having the first relationship; whether to perform the integration process or the differentiation process; or the at least one second PDU set and the at least one third PDU set for the integration process or the differentiation process, in the case that the at least one second PDU set and the at least one third PDU set are transmitted over the different input channels.

In some embodiments, the different input channels include different QoS flows. The processing module 3801 is further configured to determine, based on fifth target information, at least one of: the at least one second PDU set and the at least one third PDU set having the first relationship; whether to perform the integration process or the differentiation process; or the at least one second PDU set and the at least one third PDU set for the integration process or the differentiation process.

The fifth target information includes at least one of:
an association relationship between the different QoS flows;
PDU information of the second PDU set and the third PDU set in the different QoS flows; or
same or consecutive SNs of the second PDU set and the third PDU set.

In some embodiments, the different input channels include different protocol layers. The processing module 3801 is further configured to determine, based on sixth target information, at least one of: the at least one second PDU set and the at least one third PDU set having the first relationship; whether to perform the integration process or the differentiation process; or the at least one second PDU set and the at least one third PDU set for the integration process or the differentiation process.

The sixth target information includes at least one of:
an association relationship between the different protocol layers;
PDU information of the second PDU set and the third PDU set in the different protocol layers; or
same or consecutive SNs of the second PDU set and the third PDU set.

In some embodiments, the processing module 3801 is further configured to determine, based on the same input channel, at least one of: the at least one second PDU set and the at least one third PDU set having the first relationship; whether to perform the integration process or the differentiation process; or the at least one second PDU set and the at least one third PDU set for the integration process or the differentiation process, in the case that the second PDU set and the third PDU set are transmitted over the same input channel.

In some embodiments, the same input channel includes a third QoS flow; and the processing module 3801 is further configured to determine, based on seventh target information, at least one of: the at least one second PDU set and the at least one third PDU set having the first relationship; whether to perform the integration process or the differentiation process; or the at least one second PDU set and the at least one third PDU set for the integration process or the differentiation process.

The seventh target information includes at least one of:
an association relationship between the third QoS flow and at least one fourth QoS flow;
same or consecutive SNs of the at least one second PDU set and the at least one third PDU set;
the at least one second PDU set and the at least one third PDU set being present between two END identifiers; or
the at least one second PDU set and the at least one third PDU set being present between two START identifiers.

In some embodiments, the same input channel includes a third protocol layer. The processing module 3801 is further configured to determine, based on eighth target information, at least one of: the at least one second PDU set and the at least one third PDU set having the first relationship; whether to perform the integration process or the differentiation process; or the at least one second PDU set and the at least one third PDU set for the integration process or the differentiation process.

The eighth target information includes at least one of:
a mapping relationship between at least one fourth protocol layer and the third protocol layer;
same or consecutive SNs of the second PDU set and the third PDU set;
the second PDU set and the third PDU set being present between two END identifiers; or
the second PDU set and the third PDU set being present between two START identifiers.

In some embodiments, the processing module 3801 is further configured to introduce a target protocol layer into an AS, wherein the target protocol layer supports the integration process or the differentiation process based on the first data.

In some embodiments, the target protocol layer is located above an SDAP layer; or the target protocol layer is located between the SDAP layer and a PDCP layer; or the target protocol layer is located between the PDCP layer and an RLC layer; or the target protocol layer is located below the RLC layer.

In some embodiments, the processing module 3801 is further configured to configure a relevant configuration of the target protocol layer.

In some embodiments, the relevant configuration of the target protocol layer includes at least one of:
a configuration based on each UE; a configuration based on each QoS flow; a configuration based on each PDU session; a configuration based on each MAC layer; a configuration based on each DRB; a configuration based on each LCH; or a configuration based on each PDCP layer.

In some embodiments, the processing module 3801 is further configured to configure the target protocol layer based on the relevant configuration of the target protocol layer, and/or perform a relevant operation of the target protocol layer.

In some embodiments, the processing module 3801 is further configured to use the target protocol layer and/or a function of the target protocol layer in response to receiving configuration information of the target protocol layer; and
configure the target protocol layer and/or a function of the target protocol layer in response to receiving configuration information of the target protocol layer.

In some embodiments, the processing module 3801 is further configured to use the target protocol layer and/or a function of the target protocol layer in response to receiving activation indication information from a network device and the target protocol layer being activated.

In some embodiments, the processing module 3801 is further configured to configure the target protocol layer and/or a function of the target protocol layer in response to receiving activation indication information from a network device and the target protocol layer being activated.

In some embodiments, the processing module 3801 is further configured to resume the target protocol layer and/or a function of the target protocol layer in response to receiving activation indication information from a network device and the target protocol layer being activated.

In some embodiments, the processing module 3801 is further configured to not use the target protocol layer and/or a function of the target protocol layer in response to receiving deactivation indication information from a network device and the target protocol layer being deactivated.

In some embodiments, the processing module 3801 is further configured to de-configure the target protocol layer and/or a function of the target protocol layer in response to receiving deactivation indication information from a network device and the target protocol layer being deactivated.

In some embodiments, the processing module 3801 is further configured to suspend the target protocol layer and/or a function of the target protocol layer in response to receiving deactivation indication information from a network device and the target protocol layer being deactivated.

In some embodiments, the processing module 3801 is further configured to add a target function in an AS protocol layer, wherein the target function supports the integration process or the differentiation process based on the first data.

In some embodiments, the AS protocol layer is an SDAP layer; or the AS protocol layer is a PDCP layer; or the AS protocol layer is an RLC layer; or the AS protocol layer is a MAC layer.

In some embodiments, the processing module 3801 is further configured to configure a relevant configuration of the target function.

In some embodiments, the relevant configuration of the target function is configured in at least one of:
a PDCP configuration; an RLC configuration; an SDAP configuration; a DRB configuration; or a MAC configuration.

In some embodiments, the processing module 3801 is further configured to, based on the relevant configuration of the target function, configure the target function, and/or perform a relevant operation of the target function.

In some embodiments, the processing module 3801 is further configured to activate the target function at the AS protocol layer in response to receiving configuration information of the target function; use the target function at the AS protocol layer in response to receiving configuration information of the target function; and configure the target function at the AS protocol layer in response to receiving configuration information of the target function.

In some embodiments, the processing module 3801 is further configured to activate the target function at the AS protocol layer in response to receiving activation indication information from a network device and the target function being activated. In some embodiments, the processing module 3801 is further configured to use the target function at the AS protocol layer in response to receiving activation indication information from a network device and the target function being activated. In some embodiments, the processing module 3801 is further configured to configure the target function at the AS protocol layer in response to receiving activation indication information from a network device and the target function being activated.

In some embodiments, the processing module 3801 is further configured to deactivate the target function at the AS protocol layer in response to receiving deactivation indication information from a network device and the target function being deactivated. In some embodiments, the processing module 3801 is further configured to not use the target function at the AS protocol layer in response to receiving deactivation indication information from a network device and the target function being deactivated. In some embodiments, the processing module 3801 is further configured to de-configure the target function at the AS protocol layer in response to receiving deactivation indication information from a network device and the target function being deactivated.

In summary, the integration process or the differentiation process is performed based on the PDU set, such that the data processing efficiency is improved. For example, the integration process or the differentiation process is performed on the PDU set representing the I-frame and the PDU set representing the P-frame (wherein the compression decoding of the P-frame depends on the I-frame), such that the data processing efficiency is improved, and the PDU set representing the I-frame and the PDU set representing the P-frame are prevented from being processed independently.

FIG. 39 illustrates a schematic structural diagram of a communication device (a terminal device or an access network element or a core network element) according to some embodiments of the present disclosure. The communication device includes: a processor 101, a receiver 102, a transmitter 103, a memory 104, and a bus 105.

The processor 101 includes one or more processing cores, and the processor 101 performs various functional applications and information processing by running software programs and modules. The receiver 102 and the transmitter 103 are implemented as a communication assembly, wherein the communication assembly may be a communication chip. The memory 104 is connected to the processor 101 over the bus 105. The memory 104 is configured to store at least one instruction, and the processor 101 is configured to execute the at least one instruction to perform the processes in the above method embodiments.

In addition, the memory 104 may be implemented by any type or combination of a volatile storage device or a non-volatile storage device, wherein the volatile storage device or the non-volatile storage device includes, but not limited to: a magnetic disk, an optical disk, an electrically-erasable programmable read-only memory (EEPROM), an erasable programmable read-only memory (EPROM), a static random access memory (SRAM), a read-only memory (ROM), a magnetic memory, a flash memory, and a programmable read-only memory (PROM).

In some embodiments, a chip is further provided. The chip includes one or more programmable logic circuits and/or one or more program instructions. The chip, when running the one or more programmable logic circuits and/or the one or more program instructions, is caused to perform the method for processing data as described above.

In some embodiments, a non-transitory computer-readable storage medium is further provided. The non-transitory computer-readable storage medium stores at least one instruction, at least one program, a code set, or an instruction set therein. The at least one instruction, the at least one program, the code set, or the instruction set, when loaded and executed by a processor, causes the processor to perform the method for processing data as performed by the communication device as defined in the above method embodiments.

In some embodiments, a computer program product is further provided. The computer program product includes one or more computer instructions stored in a non-transitory computer-readable storage medium. The one or more computer instructions, when read by a processor of a computer device from the non-transitory computer-readable storage medium and executed by the processor, cause the computer device to perform the method for processing data as defined in the above aspect.

It will be appreciated by those of ordinary skill in the art that all or a part of the processes for performing the above embodiments are completed by hardware, or are completed by instructing relevant hardware by a program stored in a non-transitory computer-readable storage medium. The storage medium mentioned above is a read-only memory, a magnetic disk, a compact disk, or the like.

Described above are merely optional embodiments of the present disclosure and are not intended to limit the present disclosure. Any modifications, equivalent substitutions, improvements, and the like, made within the spirit and principle of the present disclosure should fall within protection scope of the present disclosure.

1. A method for processing data, comprising:
performing an integration process or a differentiation process based on first data.

2. The method according to claim 1, wherein the first data is a protocol data unit (PDU) set.

3. The method according to claim 2, wherein the PDU set comprises at least one of:
a first PDU set comprising at least two PDUs having a first relationship; or
at least one second PDU set and at least one third PDU set having a first relationship,
wherein the first relationship comprises at least one of: an association relationship, a dependency/dependence relationship, a priority relationship, an integration process relationship, or a differentiation process relationship.

4. The method according to claim 1, wherein the integration process or the differentiation process comprises at least one of:
identifying at least two different pieces of data in the first data;
identifying different pieces of the first data;
rearranging a transmission order of at least two different pieces of data in the first data;
rearranging a transmission order of different pieces of the first data;
reordering at least two different pieces of data in the first data from at least one input channel;
reordering different pieces of the first data from at least one input channel;
adding serial numbers (SNs) to at least two different pieces of data in the first data;
adding SNs to different pieces of the first data;
adding or removing packet headers of at least two different pieces of data in the first data;
adding or removing packet headers of different pieces of the first data;
routing at least two different pieces of data in the first data to at least two output channels;
routing different pieces of the first data to at least two output channels;
deleting or feeding back deletion of at least one of at least two different pieces of data in the first data;
deleting or feeding back deletion of at least one of different pieces of the first data;
retransmitting or feeding back retransmission of at least one of at least two different pieces of data in the first data;
retransmitting or feeding back retransmission of at least one of different pieces of the first data;
feeding back a transmission state of the first data or transmission states of at least two different pieces of data in the first data;
feeding back transmission states of different pieces of the first data; or
generating a data packet for the first data and transmitting the data packet to a lower layer.

5. The method according to claim 4, wherein the integration process or the differentiation process comprises at least one of:
identifying at least two PDUs in the first PDU set;
identifying the at least one second PDU set and the at least one third PDU set;
rearranging a transmission order of at least two PDUs in the first PDU set;
rearranging a transmission order of the at least one second PDU set and the at least one third PDU set;
reordering at least two PDUs in the first PDU set from at least one input channel;
reordering the at least one second PDU set and the at least one third PDU set from at least one input channel;
adding SNs to at least two PDUs in the first PDU set;
adding SNs to the at least one second PDU set and the at least one third PDU set;
adding or removing packet headers of at least two PDUs in the first PDU set;
adding or removing packet headers of the at least one second PDU set and the at least one third PDU set;
routing at least two PDUs in the first PDU set to at least two output channels;
routing the at least one second PDU set and the at least one third PDU set to at least two output channels;
deleting or feeding back deletion of at least one of at least two PDUs in the first PDU set;
deleting or feeding back deletion of at least one of the at least one second PDU set or the at least one third PDU set;
retransmitting or feeding back transmission of at least one of at least two PDUs in the first PDU set;
retransmitting or feeding back retransmission of at least one of the at least one second PDU set and the at least one third PDU set;
feeding back a transmission state of the first PDU set, or feeding back a transmission state of at least one PDU in the first PDU set;
feeding back transmission states of the at least one second PDU set and the at least one third PDU set, or feeding back a transmission state of at least one of the at least one second PDU set or the at least one third PDU set; or
generating a data packet for the PDU set and transmitting the data packet to a lower layer.

6. The method according to claim 1, further comprising:
determining, based on first information, at least one of:
at least two different pieces of data in the first data having a first relationship, wherein the first relationship comprises at least one of an association relationship, a dependency/dependence relationship, or a priority relationship,
whether to perform the integration process or the differentiation process, or
data for the integration process or the differentiation process.

7. The method according to claim 6, wherein the first information comprises at least one of first indication information, an input channel, packet header information, a dedicated indication, or first packet indication information.

8. The method according to claim 6, wherein determining, based on the first information, at least one of the at least two different pieces of data in the first data having the first relationship, whether to perform the integration process or the differentiation process, or the at least two different pieces of data in the first data for the integration process or the differentiation process comprises:
determining, based on the first information, at least one of:
at least two PDUs in a first PDU set having the first relationship,
whether to perform the integration process or the differentiation process, or
at least two PDUs in the first PDU set for the integration process or the differentiation process.

9. The method according to claim 8, wherein determining, based on the first information, at least one of: the at least two PDUs in the first PDU set having the first relationship; whether to perform the integration process or the differentiation process, or the at least two PDUs in the first PDU set for the integration process or the differentiation process comprises:
determining, based on different input channels, at least one of:
the at least two PDUs in the first PDU set having the first relationship,
whether to perform the integration process or the differentiation process, or
the at least two PDUs in the first PDU set for the integration process or the differentiation process, in a case that the at least two PDUs in the first PDU set are transmitted over the different input channels.

10. A communication device, comprising: a processor; a transceiver connected to the processor; and a memory, configured to store one or more executable instructions of the processor; wherein the processor, when loading and executing the one or more executable instructions, is caused to perform:
performing an integration process or a differentiation process based on first data.

11. The communication device according to claim 10, wherein the first data is a protocol data unit (PDU) set.

12. The communication device according to claim 11, wherein the PDU set comprises at least one of:
a first PDU set comprising at least two PDUs having a first relationship; or
at least one second PDU set and at least one third PDU set having a first relationship,
wherein the first relationship comprises at least one of: an association relationship, a dependency/dependence relationship, a priority relationship, an integration process relationship, or a differentiation process relationship.

13. The communication device according to claim 10, wherein the processor, when loading and executing the one or more executable instructions, is further caused to perform:
determining, based on second information, at least one of:
different pieces of the first data having a first relationship, whether to perform the integration process or the differentiation process, or different pieces of the first data for the integration process or the differentiation process, wherein the first relationship comprises at least one of an association relationship, a dependency/dependence relationship, or a priority relationship.

14. The communication device according to claim 13, wherein the processor, when loading and executing the one or more executable instructions, is caused to perform:
determining, based on the second information, at least one of at least one second PDU set and at least one third PDU set having the first relationship, whether to perform the integration process or the differentiation process, or the at least one second PDU set and the at least one third PDU set for the integration process or the differentiation process.

15. The communication device according to claim 14, wherein the processor, when loading and executing the one or more executable instructions, is caused to perform:
determining, based on different input channels, at least one of the at least one second PDU set and the at least one third PDU set having the first relationship, whether to perform the integration process or the differentiation process, or the at least one second PDU set and the at least one third PDU set for the integration process or the differentiation process, in a case that the at least one second PDU set and the at least one third PDU set are transmitted over the different input channels.

16. The communication device according to claim 10, wherein the processor, when loading and executing the one or more executable instructions, is caused to perform:
introducing a target protocol layer into an access stratum (AS), wherein the target protocol layer supports the integration process or the differentiation process based on the first data.

17. The communication device according to claim 16, wherein
the target protocol layer is located above a Service Sata Adaptation Protocol (SDAP) layer; or
the target protocol layer is located between an SDAP layer and a Packet Data Convergence Protocol (PDCP) layer; or
the target protocol layer is located between a PDCP layer and a radio link control (RLC) layer; or
the target protocol layer is located below an RLC layer.

18. The communication device according to claim 10, wherein the processor, when loading and executing the one or more executable instructions, is caused to perform:
adding a target function in an access stratum (AS) protocol layer, wherein the target function supports the integration process or the differentiation process based on the first data.

19. The communication device according to claim 18, wherein
the AS protocol layer is a Service Data Adaptation Protocol (SDAP) layer; or
the AS protocol layer is a Packet Data Convergence Protocol (PDCP) layer; or
the AS protocol layer is a radio link control (RLC) layer; or
the AS protocol layer is a medium access control (MAC) layer.

20. A chip, comprising at least one of: one or more programmable logic circuits or one or more program instructions, wherein the chip, when running the at least one of the one or more programmable logic circuits or the one or more program instructions, is caused to perform:
performing an integration process or a differentiation process based on first data.
